(19) United States
(12) Patent Application Publication
(10) Pub. No.: US 2016/0373740 A1
(43) Pub. Date: Dec. 22, 2016

(54) IMAGE ENCODING DEVICE AND METHOD

(71) Applicant: SONY CORPORATION, Tokyo (JP)

(72) Inventors: TAKEFUMI NAGUMO, KANAGAWA (JP); NOBUO UEKI, TOKYO (JP); TOSHINORI IHARA, TOKYO (JP); SHUO LU, TOKYO (JP); HIRONARI SAKURAI, KANAGAWA (JP); YOSHITAKA MORIGAMI, TOKYO (JP)

(21) Appl. No.: 15/121,380

(22) PCT Filed: Feb. 24, 2015
(86) PCT No.: PCT/JP2015/055137

§ 371 Date: Aug. 24, 2016

(30) Foreign Application Priority Data
Mar. 5, 2014 (JP) 2014-042408

(51) Int. Cl. H04N 19/11; H04N 19/154; H04N 19/593; H04N 19/423; H04N 19/14; H04N 19/176

(52) U.S. Cl. CPC H04N 19/11; H04N 19/14; H04N 19/176; H04N 19/593; H04N 19/423; H04N 19/154

(57) ABSTRACT

The present disclosure relates to an image encoding device and a method that can suppress a decrease in image quality due to encoding. The image encoding device includes: a control unit configured to restrict a mode of generation of a predicted image, based on prediction of image quality of reference image data to be referred to when generating the predicted image; a prediction unit configured to generate the predicted image according to a mode not restricted by the control unit; and an encoding unit configured to encode image data using the predicted image generated by the prediction unit. The present disclosure can be applied to an image processing device or an image encoding device, for example.

### TECHNICAL FIELD

The present disclosure relates to an image encoding device and a method, and especially relates to an image encoding device and a method that can suppress a decrease in image quality due to encoding.

### BACKGROUND ART

When achieving image encoding by hardware, a frame buffer for storing reference frames is often mounted as an external dynamic random access memory (DRAM) chip separated from a large scale integration (LSI) for encoding. Such a frame buffer needs to store a plurality of reference frames and needs to be accessed at high speed in processing such as motion estimation (ME) and motion compensation (MC), the frame buffer needs to have a sufficiently high data storage capacity and a sufficiently high band to input/output data.

However, due to a recent increase in the capacity of 4K televisions and image data, the data amount handled by image encoders tends to increase. Therefore, a high capacity and a high band are required for the external DRAM chip, which is one of causes of an increase in product cost.

Therefore, methods of compressing and storing the image data have been considered (for example, see Non-Patent Documents 1 and 2).

### CITATION LIST

### Non-Patent Documents

Non-Patent Document 1: Madhukar Budagavi and Minhua Zhou, “VIDEO CODING USING COMPRESSED REFERENCE FRAMES”

Non-Patent Document 2: Xuena Bao, Dajiang Zhou, and Satoshi Goto, “A Lossless Frame Recompression Scheme for Reducing DRAM Power in Video Encoding”

### SUMMARY OF THE INVENTION

### Problems to be Solved by the Invention

However, the method described in Non-Patent Document 1 compresses the reference data using fixed length compression, and thus distortion due to compression may appear in the encoded image as deterioration while data can be easily input/output to/from the frame buffer.

Further, the method described in Non-Patent Document 2 applies lossless compression, and thus a method of accessing the reference memory may become complicated. In addition, the lossless compression typically has a lower compression rate than non-lossless compression, and a reduction effect of the DRAM capacity and the memory access band may become small.

The present disclosure has been made in view of the foregoing, and can suppress a decrease in image quality due to encoding.

### Solutions to Problems

One aspect of the present technology is an image encoding device including: a control unit configured to restrict a mode of generation of a predicted image, based on prediction of image quality of reference image data to be referred to when generating the predicted image; a prediction unit configured to generate the predicted image according to a mode not restricted by the control unit; and an encoding unit configured to encode image data using the predicted image generated by the prediction unit.

The control unit can restrict an inter prediction mode according to complexity of a current block that is an object to be processed.

The control unit can restrict a direction of intra prediction according to complexity of a peripheral block of a current block that is an object to be processed.

The control unit can restrict a direction of intra prediction according to a shape of a block of encoding of when a peripheral block of a current block that is an object to be processed is stored in a frame memory.

The control unit can restrict the intra prediction from a direction of a side of the current block, the side being configured from a plurality of blocks.

The control unit can restrict a direction of intra angular prediction according to complexity of a peripheral block of a current block that is an object to be processed.

The control unit can restrict a direction of intra prediction according to setting of encoding of when a peripheral block of a current block that is an object to be processed is stored in a frame memory.

The control unit can restrict a direction of intra prediction according to complexity of a peripheral block of a current block that is an object to be processed, and an encoding type of the peripheral block.

The control unit may not restrict the direction of intra prediction regardless of the complexity of the peripheral block when the encoding type is the intra prediction.

The control unit can restrict the direction of intra prediction regardless of the complexity of the peripheral block when the encoding type is inter prediction.

The control unit can restrict a direction of intra prediction according to setting of encoding of when a peripheral block of a current block that is an object to be processed is stored in a frame memory, and an encoding type of the peripheral block.

The control unit may not restrict the direction of intra prediction regardless of complexity of the peripheral block when the encoding type is intra prediction.

The control unit can restrict a value of constrained_intra_pred_flag according to setting of encoding of when a peripheral block of a current block that is an object to be processed is stored in a frame memory.

The control unit can restrict a value of strong_intra_smoothing_enabled_flag according to setting of encoding of when a peripheral block of a current block that is an object to be processed is stored in a frame memory.

The control unit can restrict a direction of intra prediction according to whether performing encoding when an image decoding device stores a decoded block in a frame memory.

The control unit can restrict the direction of intra prediction when the image decoding device performs the encoding.

The control unit can restrict the direction of intra prediction when the image decoding device performs the encoding, and a peripheral block of a current block that is an object to be processed is inter prediction.

The control unit can restrict a value of constrained_intra_pred_flag when the image decoding device performs the encoding.

The control unit can restrict a value of strong_intra_smoothing_enabled_flag when the image decoding device performs the encoding.

Further, one aspect of the present technology is a control method including: restricting a mode of generation of a predicted image, based on prediction of image quality of reference image data to be referred to when generating the predicted image; generating the predicted image in a mode that is not restricted; and encoding image data using the generated predicted image.

In one aspect of the present technology, a mode of generation of a predicted image is restricted, a predicted image is generated in a mode that is not restricted, and image data is encoded using the generated predicted image, based on prediction of image quality of reference image data that is referred to when a predicted image is generated.

### Effects of the Invention

According to the present disclosure, image data can be encoded. Especially, a decrease in image quality due to encoding can be suppressed.

### BRIEF DESCRIPTION OF DRAWINGS

FIG. 1 is a diagram for describing a configuration example of a coding unit.

FIG. 2 is a diagram for describing an example of propagation of deterioration.

FIG. 3 is a diagram for describing an example of deterioration of image quality.

FIG. 4 is a block diagram illustrating a principal configuration example of an image encoding device.

FIG. 5 is a diagram illustrating an example of a state of scalable encoding.

FIG. 6 is a diagram for describing an example of a positional relationship between a current block and peripheral blocks.

FIG. 7 is a block diagram illustrating a principal configuration example of a deterioration prediction unit and a prediction restriction unit.

FIG. 8 is a diagram for describing an example of a state of prediction restriction.

FIG. 9 is a flowchart for describing an example of a flow of encoding processing.

FIG. 10 is a flowchart for describing an example of a flow of prediction restriction control processing.

FIG. 11 is a diagram for describing an example of a positional relationship between a current block and peripheral blocks.

FIG. 12 is a block diagram illustrating a principal configuration example of a deterioration prediction unit and a prediction restriction unit.

FIG. 13 is a diagram for describing an example of a state of prediction restriction.

FIG. 14 is a flowchart for describing an example of a flow of prediction restriction control processing.

FIG. 15 is a diagram for describing an example of a positional relationship between a current block and peripheral blocks.

FIG. 16 is a diagram for describing an example of intra angular prediction.

FIG. 17 is a diagram for describing an example of a state of prediction restriction.

FIG. 18 is a block diagram illustrating a principal configuration example of an image encoding device.

FIG. 19 is a diagram for describing an example of a state of prediction restriction.

FIG. 20 is a flowchart for describing an example of prediction restriction control processing.

FIG. 21 is a block diagram illustrating a principal configuration example of an image encoding device.

FIG. 22 is a block diagram illustrating a principal configuration example of a deterioration prediction unit and a prediction restriction unit.

FIG. 23 is a diagram for describing an example of a state of prediction restriction.

FIG. 24 is a flowchart for describing an example of a flow of prediction restriction control processing.

FIG. 25 is a block diagram illustrating a principal configuration example of a deterioration prediction unit and a prediction restriction unit.

FIG. 26 is a diagram for describing an example of a state of prediction restriction.

FIG. 27 is a flowchart for describing an example of a flow of prediction restriction control processing.

FIG. 28 is a block diagram illustrating a principal configuration example of an image encoding device.

FIG. 29 is a diagram for describing an example of a state of prediction restriction.

FIG. 30 is a flowchart for describing an example of a flow of prediction restriction control processing.

FIG. 31 is a diagram for describing smoothing processing.

FIG. 32 is a block diagram illustrating a principal configuration example of an image encoding device.

FIG. 33 is a diagram for describing an example of a state of prediction restriction.

FIG. 34 is a flowchart for describing an example of a flow of prediction restriction control processing.

FIG. 35 is a block diagram illustrating a principal configuration example of an image processing system.

FIG. 36 is a block diagram illustrating a principal configuration example of an image decoding device.

FIG. 37 is a block diagram illustrating another configuration example of an image decoding device.

FIG. 38 is a block diagram illustrating a principal configuration example of an image encoding device.

FIG. 39 is a diagram for describing an example of a state of prediction restriction.

FIG. 40 is a diagram for describing an example of a state of prediction restriction.

FIG. 41 is a diagram for describing an example of a state of prediction restriction.

FIG. 42 is a diagram for describing an example of a state of prediction restriction.

FIG. 43 is a flowchart for describing an example of a flow of prediction restriction control processing.

FIG. 44 is a diagram illustrating an example of a multi-view image encoding method.

FIG. 45 is a diagram illustrating a principal configuration example of a multi-view image encoding device to which the present technology is applied.

FIG. 46 is a diagram illustrating a principal configuration example of a multi-view image decoding device to which the present technology is applied.

FIG. 47 is a diagram illustrating an example of a hierarchical image encoding method.

FIG. 48 is a diagram illustrating a principal configuration example of a hierarchical image encoding device to which the present technology is applied.

FIG. 49 is a diagram illustrating a principal configuration example of a hierarchical image decoding device to which the present technology is applied.

FIG. 50 is a block diagram illustrating a principal configuration example of a computer.

FIG. 51 is a block diagram illustrating an example of a schematic configuration of a television device.

FIG. 52 is a block diagram illustrating an example of a schematic configuration of a mobile phone.

FIG. 53 is a block diagram illustrating an example of a schematic configuration of a recording/reproducing device.

FIG. 54 is a block diagram illustrating an example of a schematic configuration of a capturing device.

FIG. 55 is a block diagram illustrating an example of a schematic configuration of a video set.

FIG. 56 is a block diagram illustrating an example of a schematic configuration of a video processor.

FIG. 57 is a block diagram illustrating another example of a schematic configuration of a video processor.

### MODE FOR CARRYING OUT THE INVENTION

Hereinafter, modes (hereinafter referred to as embodiments) for carrying out the present disclosure will be described. Note that the description will be given in the following order.

1. First Embodiment (image encoding device)
2. Second Embodiment (image encoding device)
3. Third Embodiment (image encoding device)

### 4. Fourth Embodiment (Image Processing System)

5. Fifth embodiment (multi-view image encoding device/multi-view image decoding device)
6. Sixth embodiment (hierarchical image encoding device/hierarchical image decoding device)
7. Seventh Embodiment (computer)
8. Eighth Embodiment (application examples)
9. Ninth Embodiment (set/unit/module processor)

### 1. FIRST EMBODIMENT

### Flow of Standardization of Image Encoding

In recent years, devices have become popular that digitally handle image information, and compress and encode an image by employing an encoding method that compresses the image through motion compensation and orthogonal transform such as discrete cosine transform using redundancy unique to the image information for the purpose of highly efficiently transmitting and accumulating the information. This encoding method includes, for example, moving picture experts group (MPEG).

Especially, MPEG2 (ISO/IEC 13818-2) is defined as a versatile image encoding method, and is a standard covering both an interlaced scanning image and a sequential scanning image, a standard-resolution image, and a high-definition image. For example, currently MPEG2 is widely used in various ranges of applications for professional use and consumer use. By the use of the MPEG2 compression method, in the case of the interlaced scanning image with a standard resolution having 720×480 pixels, a code amount (bit rate) of 4 to 8 Mbps can be allocated. Further, by the use of the MPEG2 compression method, in the case of the interlaced scanning image with a high resolution having 1920×1088 pixels, a code amount (bit rate) of 18 to 22 Mbps can be allocated. This realizes a high compression rate and excellent image quality.

MPEG2 is mainly intended for high-definition image encoding suitable for broadcasting but does not support a lower code amount (bit rate) than MPEG1, i.e., an encoding method with a higher compression rate. Needs for such an encoding method will be more likely to increase with spread of portable terminals, and the MPEG4 encoding method has been standardized. In regard to the image encoding method, a specification was approved in December 1998 as an international standard with the name of ISO/IEC 14496-2.

Further, in recent years, a standard called H.26L (international telecommunication union telecommunication standardization sector (ITU-T) Q6/16 video coding expert group (VCEG)) has been in progress for the purpose of encoding images for teleconference. It is known that H.26L achieves higher encoding efficiency though requiring a larger amount of calculation in encoding and decoding than the conventional encoding methods such as MPEG2 and MPEG4. Further, as one of activities of MPEG4, a standardization that achieves higher encoding efficiency based on this H.26L is performed as joint model of enhanced-compression video coding in which the function that is not supported in H.26L has been introduced.

As for the schedule of the standardization, an international standard was set forth with a name of H.264 and MPEG-4 part 10 (advanced video coding, hereinafter AVC) in March 2003.

In addition, as an extension of H.264/AVC, a standardization of fidelity range extension (FRExt) including encoding tools necessary for work, such as RGB, 4:2:2, and 4:4:4, and a quantization matrix and 8×8 DCT defined in MPEG-2 was completed in February 2005. Accordingly, the encoding method capable of expressing even film noises included in films based on H.264/AVC is achieved and used in wide applications including Blu-ray disc (trademark).

In recent years, however, there is an increasing need for encoding with a higher compression rate, such as compression of an image with approximately 4000×2000 pixels that corresponds to four times that of a high-vision image, or distribution of a high-vision image in an environment with a limited transmission capacity such as on the Internet. Therefore, further examinations about improvement of the encoding efficiency in VCEG under ITU-T have been in progress.

In view of this, for the purpose of improving the encoding efficiency over AVC, standardization of the encoding method called high efficiency video coding (HEVC) has been in progress by joint collaboration team—video coding (JCTVC) as a joint standardization group of the ITU-T and international organization for standardization/international electrotechnical commission (ISO/IEC). As for the HEVC specification, a committee draft that is a drafted specification was issued in January 2013.

### <Encoding Method>

Hereinafter, the present technology will be exemplarily described based on a case in which the present technology is applied to image encoding/decoding in a high efficiency video coding (HEVC) method.

### <Coding Unit>

In the advanced video coding (AVC) method, a hierarchical structure of macroblocks and submacroblocks is defined. However, the macroblocks of 16 pixels×16 pixels are not optimum for a picture frame as high as ultra-high definition (UHD: 4000 pixels×2000 pixels) to be encoded by a next-generation encoding method.

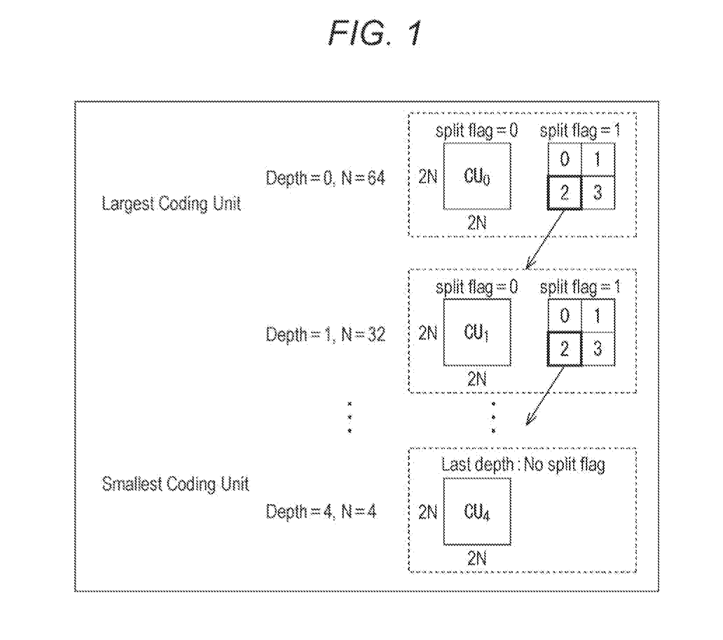

In contrast, in the HEVC method, a coding unit (CU) is defined as illustrated in FIG. 1.

CU is also referred to as coding tree block (CTB) and is a partial region of an image in the unit of picture that plays a role similar to the macroblock in the AVC method. While the latter is fixed to the size of 16×16 pixels, the size of the former is not fixed and will be specified in image compression information in each sequence.

For example, in a sequence parameter set (SPS) included in encoded data to be output, the maximum size of CU (largest coding unit (LCU)) and the minimum size of CU (smallest coding unit (SCU)) are defined.

In each LCU, by setting split flag=1 in a range of a size that does not fall below the size of SCU, the unit can be divided into smaller CUs. In the example of FIG. 1, the size of LCU is 128 and the maximum hierarchical depth is 5. When the split flag has a value of “1”, the CU with a size of 2N×2N is divided into CUs with a size of N×N in a one-lower layer.

Further, the CU is divided into prediction units (PUs), each of which is a region serving as the unit of processing in the intra prediction or inter prediction (a partial region of an image in the unit of picture), and is divided into transform units (TUs), each of which is a region serving as the unit of processing in orthogonal transform (a partial region of an image in the unit of picture). At present, in the HEVC method, 16×16 and 32×32 orthogonal transforms can be used, in addition to the 4×4 and 8×8 orthogonal transforms.

In a case of such an encoding method where CU is defined and various types of processing is performed in the unit of CU, like the HEVC method, the macroblock in the AVC method corresponds to the LCU and the block (subblock) can be considered to correspond to the CU. Further, a motion compensation block in the AVC method can be considered to correspond to the PU. However, since CU has the hierarchical structure, the LCU in the highest hierarchy has a size that is generally set larger than the macroblock in the AVC method and has 128×128 pixels, for example.

Therefore, hereinafter, the LCU includes the macroblocks in the AVC method and the CU includes the block (subblock) in the AVC method. That is, the term “block” used in the description below refers to any partial region in the picture and the size, shape, and characteristic, etc. are not limited. Therefore, “block” includes any region (unit of processing) such as TU, PU, SCU, CU, LCU, subblock, macroblock, or a slice. Needless to say, other partial regions (unit of processing) than the above are also included. If there is a necessity to limit the size or the unit of processing, the description will be appropriately given.

In the present specification, coding tree unit (CTU) is the unit including a parameter of when processing is performed with the coding tree block (CTB) of the largest coding unit (LCU) and an LCU base (level) thereof. Further, coding unit (CU) that configures CTU is the unit including a parameter of when processing is performed with a coding block (CB) and a CU base (level) thereof.

### <Deterioration of Image Quality Due to Encoding>

By the way, when achieving image encoding by hardware, a frame buffer for storing reference frames is often mounted as an external dynamic random access memory (DRAM) chip separated from a large scale integration (LSI) for encoding. Such a frame buffer needs to store a plurality of reference frames and needs to be accessed at highspeed in processing such as motion estimation (ME) and motion compensation (MC), the frame buffer needs to have a sufficiently high data storage capacity and a sufficiently high band to input/output data.

However, due to a recent increase in the capacity of 4K televisions and image data, the data amount handled by image encoders tends to increase. Therefore, a high capacity and a high band are required for the external DRAM chip, which is one of causes of an increase in product cost.

Therefore, methods of compressing and storing the image data have been considered, as described in Non-Patent Documents 1 and 2, for example.

In Non-Patent Document 1, an encoding method called MMSQ is described. The algorithm of MMSQ calculates the maximum value and the minimum value for each block size (for example, 4×4) determined in advance. Following that, a quantization scale Q is determined according to a dynamic range obtained from the maximum and minimum values and bit lengths of pixels after compression, which are determined in advance. Rounding of the pixels is performed with the quantization scale Q, and a value after rounding is output as a compression stream. Further, the maximum and minimum values are necessary at the time of decoding, and thus are compressed and output. Accordingly, the image data is compressed to 4×4 pixels with fixed length data of 2*N+16*L bits, where the bit length of each pixel before compression is N, and the bit length after compression is L.

In this example, the reference data is compressed using the fixed length compression. Therefore, while the data can be easily input/output to/from the frame buffer, distortion due to compression may appear in the encoded image as deterioration.

Further, in Non-Patent Document 2, the DRAM band and the DRAM capacity can be reduced without deterioration of image quality of the reconstructed image by applying the lossless encoding by the frame memory. However, in the case of the lossless encoding, the bit length after encoding is different. Therefore, to refer to a reference image, the position on the memory needs to be recorded for each unit of access, and calculation of the address at the time of input/output of the data is necessary.

Therefore, there is a problem that the method of accessing the reference memory becomes complicated. Further, the lossless compression typically has a lower compression rate than non-lossless compression, and the reduction effect of the DRAM capacity and the memory access band may become small.

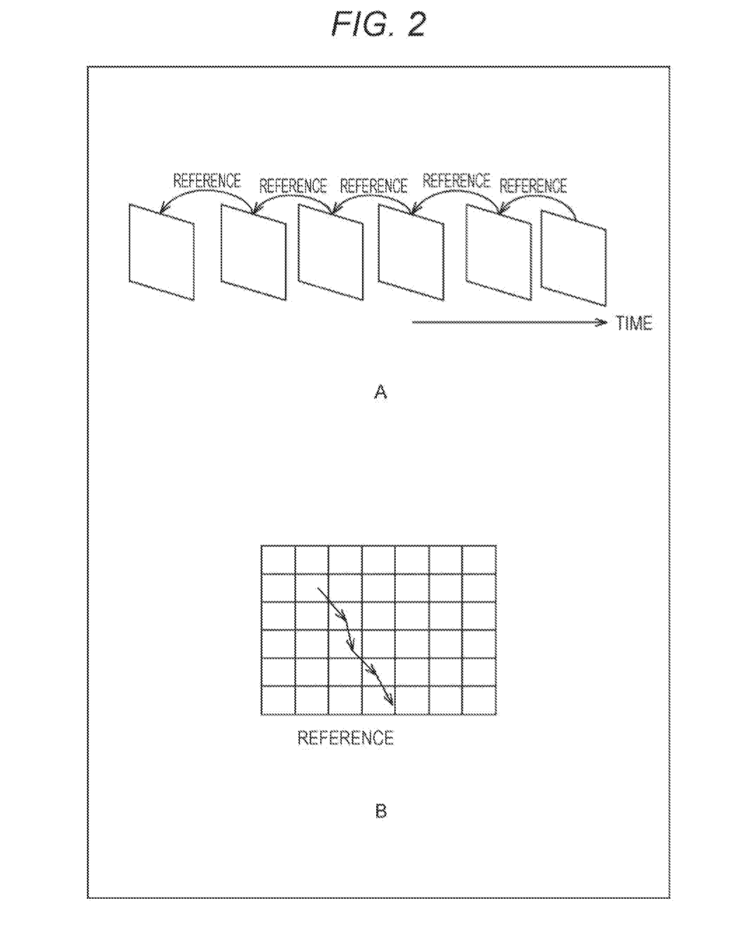

Further, for example, in an encoding mode using past reference frames for prediction, by repeating operations such as compression, recording to the frame memory, decoding, and reference, the deterioration of image quality caused by encoding/decoding when data is stored to the frame memory may be propagated and increase, as illustrated in the example in A in FIG. 2.

Further, in a case of spatial prediction mainly used in intra frames and the like, upper and left pixels of a block are used as the reference data. Therefore, similarly to a temporal direction, the operations of compression, recording to the frame buffer, decoding, and reference are repeated, and the deterioration of image quality caused by encoding/decoding when data is stored to the frame memory may be propagated and increase, as illustrated in the example in B in FIG. 2 similarly to the temporal direction.

### <Suppression of Propagation of Deterioration of Image Quality>

Therefore, in the present technology, the prediction mode is appropriately restricted to suppress such propagation of deterioration of image quality and suppress an increase in the deterioration of image quality. For example, the prediction mode is restricted based on prediction of image quality of reference image data to be referred to when a predicted image is generated.

Typically, the non-lossless compression has a characteristic that encoding deterioration differs according to difficulty in compression of an image in the unit of compression. Especially, when the blocks are compressed with a uniform encoding length, the difference is remarkable.

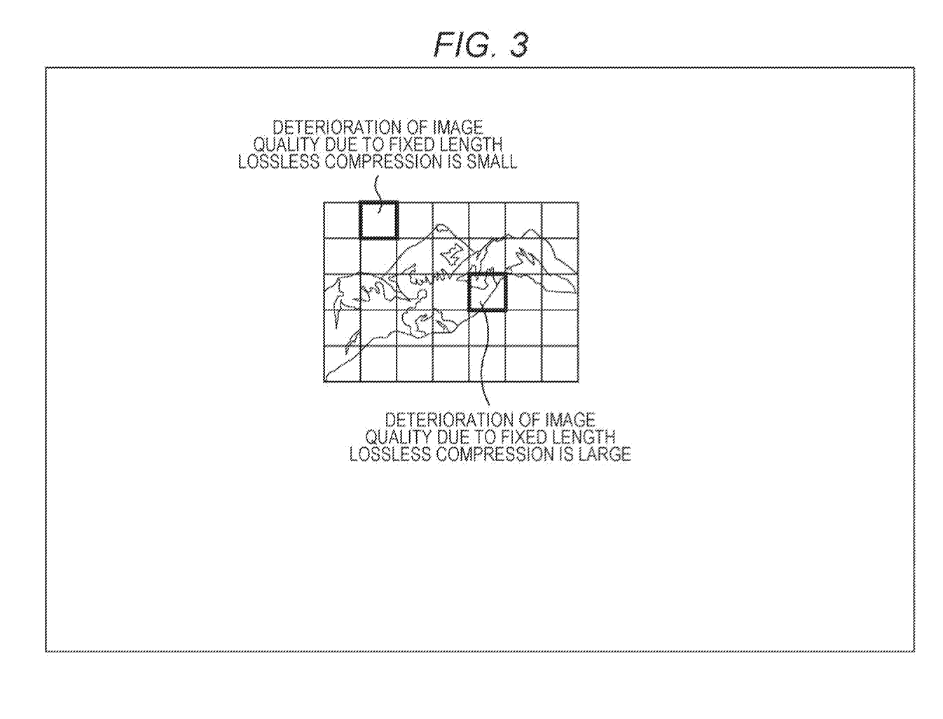

For example, as illustrated in FIG. 3, when an image is divided into blocks, image compression is typically easy in a flat region like the air, and thus the encoding deterioration is very small and is not a big problem from a subjective point of view. On the other hand, in a region of an edge or complicated texture, the image compression is difficult, and thus large encoding deterioration may occur.

Therefore, the degrees of deterioration of image quality of respective regions are predicted using the characteristic of the fixed length non-lossless compression, and the prediction mode is switched according to the prediction. To be specific, when large deterioration of image quality is expected, the prediction mode to refer to the image is restricted. In doing so, propagation of the deterioration of image quality can be suppressed, and a decrease in image quality due to encoding can be suppressed. Note that, here, “restrict” means that the prediction mode is not employed as an optimum prediction mode (an image in the prediction mode is not employed as the predicted image to be used for encoding). If the prediction mode is not employed as the optimum prediction mode, how and which stage the prediction mode is excluded may be determined. Therefore, hereinafter, this “restrict” includes all of expressions that are equivalent to causing the prediction mode not to be the optimumprediction mode, such as “prohibit”, “exclude”, “not employ”, and “exclude from candidates”. In other words, “not restrict” means that the aforementioned acts (prohibition, exclusion, and the like) are not performed (that is, the prediction mode is included in the candidates of the prediction mode, as usual, and the prediction mode may be selected as the optimum prediction mode by a normal selection operation). Note that, here, “prediction mode” indicates a prediction method of some sort. For example, the prediction mode may be a mode of a broad sense such as inter frame prediction or a skip mode, or may be a mode of a narrow sense such as a prediction direction of the intra prediction. Further, “restriction of the prediction mode” may include restriction of a part of the prediction mode.

### <Image Encoding Device>

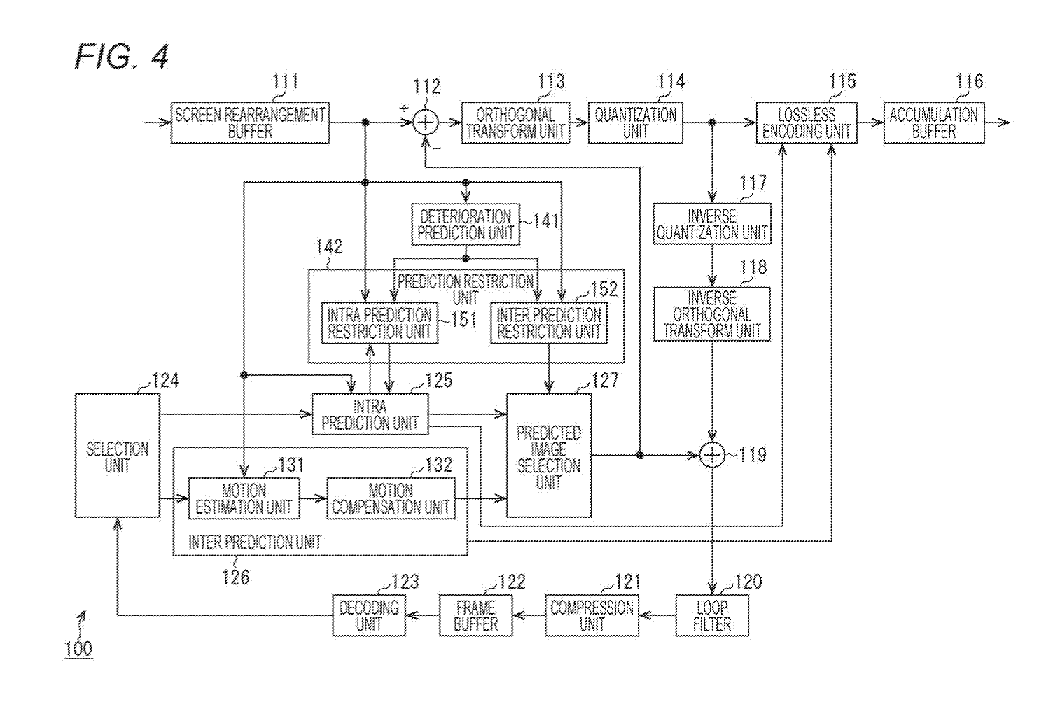

FIG. 4 is a block diagram illustrating an example of a configuration of an image encoding device that is one aspect of an image processing device to which the present technology is applied. As illustrated in FIG. 4, an image encoding device 100 encodes image data of a moving image using prediction processing in the HEVC method or prediction processing in a method equivalent to the HEVC method.

As illustrated in FIG. 4, the image encoding device 100 includes a screen rearrangement buffer 111, a calculation unit 112, an orthogonal transform unit 113, a quantization unit 114, a lossless encoding unit 115, an accumulation buffer 116, an inverse quantization unit 117, and an inverse orthogonal transform unit 118. Further, the image encoding device 100 includes a calculation unit 119, a loop filter 120, a compression unit 121, a frame memory 122, a decoding unit 123, a selection unit 124, an intra prediction unit 125, an inter prediction unit 126, and a predicted image selection unit 127.

The screen rearrangement buffer 111 stores images of respective frames of input image data in order of display, rearranges the stored images of the frames in the order of display into order of frames for encoding according to group of picture (GOP), and supplies the images in the rearranged order of frames to the calculation unit 112. Further, the screen rearrangement buffer 111 also supplies the images in the rearranged order of frames to the intra prediction unit 125 and the inter prediction unit 126.

The calculation unit 112 subtracts a predicted image supplied from the intra prediction unit 125 or the inter prediction unit 126 through the predicted image selection unit 127 from the image read from the screen rearrangement buffer 111, and outputs differential information (residual data) to the orthogonal transform unit 113. For example, in the case of the image for which the intra encoding is performed, the calculation unit 112 subtracts the predicted image supplied from the intra prediction unit 125 from the image read from the screen rearrangement buffer 111. On the other hand, in the case of the image for which the inter encoding is performed, the calculation unit 112 subtracts the predicted image supplied from the inter prediction unit 126 from the image read from the screen rearrangement buffer 111.

The orthogonal transform unit 113 applies orthogonal transform such as discrete cosine transform or Karhunen-Loeve transform to the residual data supplied from the calculation unit 112. The orthogonal transform unit 113 supplies a transform coefficient obtained through the orthogonal transform to the quantization unit 114.

The quantization unit 114 quantizes the transform coefficient supplied from the orthogonal transform unit 113. The quantization unit 114 supplies the quantized transform coefficient to the lossless encoding unit 115.

The lossless encoding unit 115 encodes the transform coefficient, which has been quantized in the quantization unit 114, in an arbitrary encoding method. Further, the lossless encoding unit 115 acquires information that indicates a mode of the intra prediction and the like from the intra prediction unit 125, and acquires information that indicates a mode of the inter prediction, differential motion vector information, and the like from the inter prediction unit 126.

The lossless encoding unit 115 encodes these various types of information by an arbitrary encoding method, and has (multiplexes) the encoded information as a part of header information of encoded data (also referred to as encoded stream). The lossless encoding unit 115 supplies the encoded data obtained through the encoding to the accumulation buffer 116 and accumulates the data therein.

Examples of the encoding method of the lossless encoding unit 115 include variable-length encoding and arithmetic encoding. As the variable-length encoding, for example, context-adaptive variable length coding (CAVLC) defined in H.264/AVC is given. As the arithmetic encoding, for example, context-adaptive binary arithmetic coding (CABAC) is given.

The accumulation buffer 116 temporarily holds the encoded data supplied from the lossless encoding unit 115. The accumulation buffer 116 outputs the held encoded data to an outside of the image encoding device 100 at predetermined timing. That is, the accumulation buffer 116 also serves as a transmission unit that transmits the encoded data.

The transform coefficient quantized in the quantization unit 114 is also supplied to the inverse quantization unit 117. The inverse quantization unit 117 inversely-quantizes the quantized transform coefficient by a method corresponding to the quantization by the quantization unit 114. The inverse quantization unit 117 supplies the obtained transform coefficient to the inverse orthogonal transform unit 118.

The inverse orthogonal transform unit 118 inversely orthogonally transform the transform coefficient supplied from the inverse quantization unit 117 by a method corresponding to the orthogonal transform process by the orthogonal transform unit 113. The inverse orthogonal transform unit 118 supplies the output obtained through the inverse orthogonal transform (restored residual data) to the calculation unit 119.

The calculation unit 119 adds the predicted image supplied from the intra prediction unit 125 or the inter prediction unit 126 through the predicted image selection unit 127 to the restored residual data supplied from the inverse orthogonal transform unit 118, thereby to obtain a locally reconstructed image (hereinafter, referred to as reconstructed image). The reconstructed image is supplied to the loop filter 120.

The loop filter 120 includes a deblocking filter, an adaptive loop filter, or the like, and appropriately filters the reconstructed image supplied from the calculation unit 119. For example, the loop filter 120 removes block distortion of the reconstructed image by performing deblocking filter processing for the reconstructed image. Further, for example, the loop filter 120 improves the image quality by performing loop filter processing for a result of the deblocking filter processing (the reconstructed image from which the block distortion has been removed) using a Wiener Filter.

The loop filter 120 may further conduct arbitrary filter processing for the reconstructed image. The loop filter 120 can supply information such as a filter coefficient used in the filter processing to the lossless encoding unit 115 as necessary to encode the information.

The loop filter 120 supplies the filter processing result (hereinafter, referred to as decoded image) to the compression unit 121.

The compression unit 121 encodes the decoded image supplied from the loop filter 120 by a predetermined encoding method, supplies the image to the frame buffer 122 after compressing (reducing) the information amount, and stores the image therein. The frame buffer 122 stores the decoded image supplied through the compression unit 121. The decoding unit 123 reads the encoded data of the image data used as the reference image from the frame buffer 122 and decodes the encoded data at predetermined timing. The decoding unit 123 supplies the read and decoded image data to the selection unit 124. The selection unit 124 supplies the image data (reference image) supplied from the decoding unit 123 to the intra prediction unit 125 or the inter prediction unit 126.

The encoding/decoding methods are arbitrary, and the compression unit 121 and the decoding unit 123 may encode/decode the decoded image in a fixed length non-lossless method, for example. Typically, the encoding/decoding in the fixed length non-lossless method can be achieved by an easy processing, and thus is suitable as processing performed when writing to the frame buffer 122 is performed like this example. In addition, the encoded data of a fixed length can be obtained, and thus management of the data when stored in the frame buffer 122 becomes easier and is desirable.

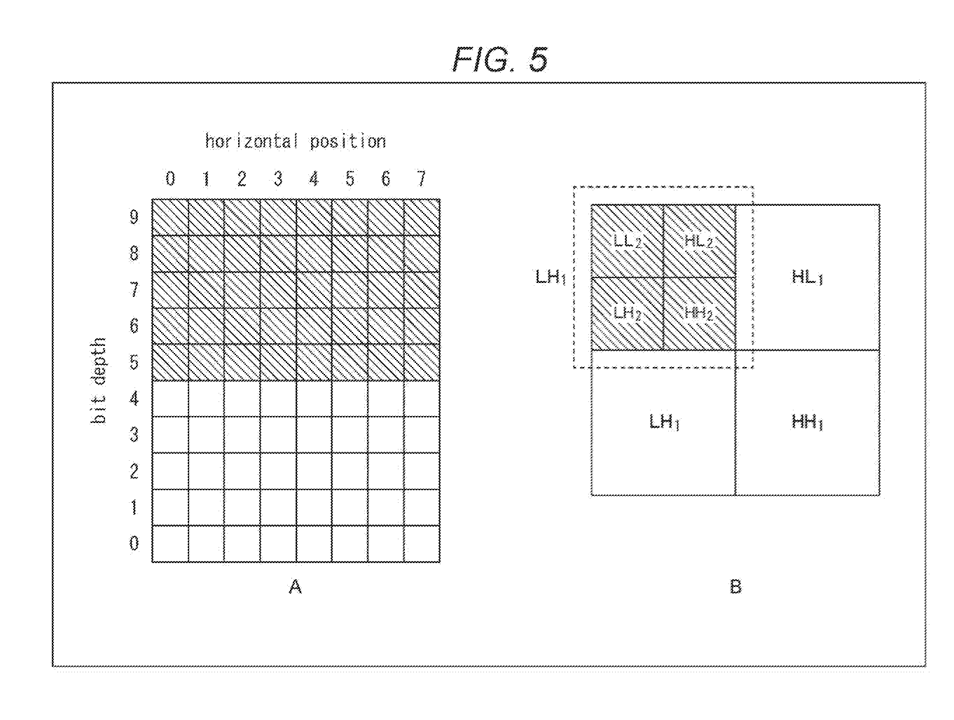

The parameter of such compression is arbitrary. For example, compression may be performed about bit depth as illustrated in the example in A in FIG. 5, or compression may be performed about resolution as illustrated in the example in B in FIG. 5. Alternatively, compression may be performed about frequency components, or may be performed about a parameter other than the aforementioned examples. For example, in the case of the example of A in FIG. 5, the compression unit 121 extracts high-order bits (a predetermined number of bits) of pixel data of the image data (the shaded portion in FIG. 5), and encodes the extracted bits. Further, for example, in the case of the example in B in FIG. 5, the compression unit 121 extracts a low-frequency component (MA) (the shaded portion in FIG. 5) of the image data by wavelet transform or the like, and encodes the extracted component. In doing so, the data amount of the image data (encoded data) to be stored in the frame buffer 122 can be decreased, and the uses amount of the memory capacity can be saved and the used amount of the memory access band can be decreased.

The intra prediction unit 125 performs intra prediction to generate a predicted image using a pixel value in a current picture that is a reconstructed image supplied from the decoding unit 123 through the selection unit 124 as the reference image. The intra prediction unit 125 performs the intra prediction in a plurality of intra prediction modes prepared in advance.

The intra prediction unit 125 generates the predicted images in all of candidate intra prediction modes, evaluates cost function values of the respective predicted images using an input image supplied from the screen rearrangement buffer 111, and selects an optimum mode. When the intra prediction unit 125 selects the optimum intra prediction mode, the intra prediction unit 125 supplies the predicted image generated in the optimum mode to the predicted image selection unit 127.

Further, as described above, the intra prediction unit 125 appropriately supplies intra prediction mode information that indicates the employed intra prediction mode and the like to the lossless encoding unit 115, and encodes the information therein.

The inter prediction unit 126 performs inter prediction processing using the input image supplied from the screen rearrangement buffer 111 and the reference image supplied from the decoding unit 123 through the selection unit 124. To be specific, the inter prediction unit 126 includes a motion estimation unit 131 and a motion compensation unit 132. The motion estimation unit 131 supplies a motion vector detected trough motion prediction to the motion compensation unit 132. The motion compensation unit 132 performs motion compensation processing according to the supplied motion vector to generate a predicted image (inter predicted image information).

The inter prediction unit 126 generates the predicted images in all of candidate inter prediction modes. The inter prediction unit 126 evaluates cost function values of the respective predicted images using the input image supplied from the screen rearrangement buffer 111 and information of the generated differential motion vector and the like, and selects the optimum mode. When the inter prediction unit 126 selects the optimum inter prediction mode, the inter prediction unit 126 supplies the predicted image generated in the optimum mode to the predicted image selection unit 127.

When decoding the information that indicates the employed inter prediction mode and the encoded data, the inter prediction unit 126 supplies information necessary for performing processing in the inter prediction mode to the lossless encoding unit 115 and causes the lossless encoding unit 115 to encode the information. Examples of the necessary information include the information of the generated differential motion vector, and a flag that indicates an index of a prediction motion vector as prediction motion vector information.

The predicted image selection unit 127 selects a supply source of the predicted image to be supplied to the calculation unit 112 and the calculation unit 119. For example, in the case of intra encoding, the predicted image selection unit 127 selects the intra prediction unit 125 as the supply source of the predicted image, and supplies the predicted image supplied from the intra prediction unit 125 to the calculation unit 112 and the calculation unit 119. Further, for example, in the case of inter encoding, the predicted image selection unit 127 selects the inter prediction unit 126 as the supply source of the predicted image, and supplies the predicted image supplied from the inter prediction unit 126 to the calculation unit 112 and the calculation unit 119.

The image encoding device 100 includes a deterioration prediction unit 141 and a prediction restriction unit 142. The deterioration prediction unit 141 refers to original image information supplied from the screen rearrangement buffer 111, and predicts deterioration (deterioration of image quality due to compression of the compression unit 121) at the time of accumulation of the frame buffer 122. The deterioration prediction unit 141 supplies a predicted value thereof to the prediction restriction unit 142.

The prediction restriction unit 142 restricts a prediction direction of the inter prediction or the intra prediction, based on the predicted value supplied from the deterioration prediction unit 141, that is, based on control of the deterioration prediction unit 141. As illustrated in FIG. 4, the prediction restriction unit 142 includes an intra prediction restriction unit 151 and an inter prediction restriction unit 152.

The intra prediction restriction unit 151 controls the intra prediction unit 125 and restricts the prediction direction of the intra prediction. That is, the intra prediction restriction unit 151 controls the intra prediction unit 125 by generating the flag that restricts the prediction direction of the intra prediction and supplying the flag to the intra prediction unit 125.

The inter prediction restriction unit 152 controls the predicted image selection unit 127, and restricts the inter prediction. That is, the inter prediction restriction unit 152 controls the predicted image selection unit 127 by generating the flag that restricts the inter prediction and supplying the flag to the predicted image selection unit 127.

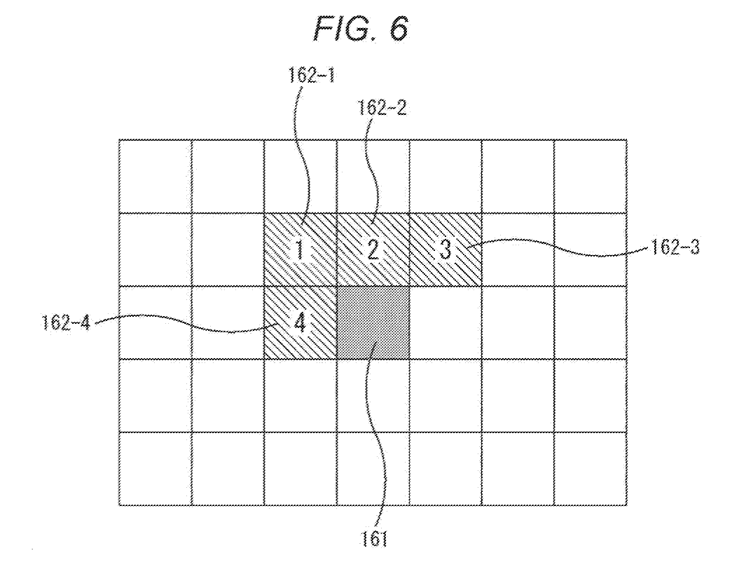

For example, in the inter prediction, as illustrated in FIG. 6, the motion vector of a current block 161 that is an object to be processed is generated. Further, in the intra prediction, as illustrated in FIG. 6, peripheral blocks (peripheral blocks 162-1 to 162-4 in the example of FIG. 6) of the current block 161 are referred to. Hereinafter, the peripheral blocks 162-1 to 162-4 are simply referred to as peripheral block 162 where it is not necessary to distinguish the peripheral blocks.

The deterioration prediction unit 141 predicts the deterioration of image quality about the current block 161 and the peripheral block 162. The intra prediction restriction unit 151 restricts the prediction direction of the intra prediction, based on the predicted values of the deterioration of image quality of the respective peripheral blocks 162. For example, when the predicted value of the deterioration of image quality of a part of the peripheral blocks 162 is larger than a predetermined reference, the intra prediction restriction unit 151 restricts reference from the peripheral block (that is, the prediction direction from the side of the peripheral block). Further, the inter prediction restriction unit 152 restricts the inter prediction, based on the predicted value of the deterioration of image quality of the current block 161. For example, when the predicted value of the deterioration of image quality of the current block 161 is larger than a predetermined reference, the inter prediction restriction unit 152 restricts reference from a temporal direction, that is, the inter prediction mode. Note that restriction based on the predicted value of the deterioration of image quality of a block (collocated block) at the same position as the current block 161 of the reference frame is more accurate. However, if prediction accuracy of the inter prediction is high, the correlation between the collocated block and the current block 161 should be high, and the predicted value of the current block 161 should not have a large difference from the predicted value of the collocated block. In addition, processing of obtaining the predicted value of the current block 161 is easier than processing of obtaining the predicted value of another frame. Therefore, here, the predicted value of the deterioration of image quality of the current block 161 is obtained instead of the collocated block, and restriction of the inter prediction is performed based on the predicted value.

### <Deterioration Prediction Unit and Prediction Restriction Unit>

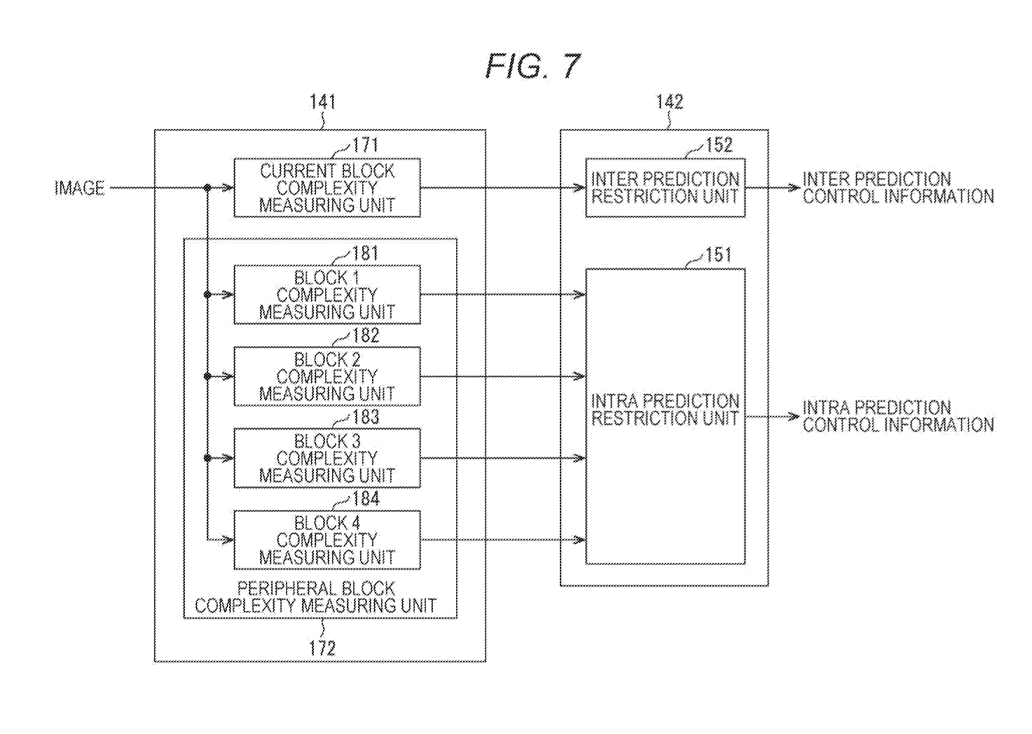

For example, the deterioration prediction unit 141 and the prediction restriction unit 142 may have the configuration illustrated in FIG. 7. In the case of the example of FIG. 7, the deterioration prediction unit 141 includes a current block complexity measuring unit 171 and a peripheral block complexity measuring unit 172.

The current block complexity measuring unit 171 measures complexity of the image of the current block 161. A method of measuring the complexity is arbitrary. For example, a variance value, a difference between the maximum luminance value and the minimum luminance value, a value of total variation, and the like of the current block may be calculated and used as a deterioration predicted value. Further, the fixed length non-lossless compression may be actually applied to the original image, and the deterioration of image quality caused at the compression may be measured. The current block complexity measuring unit 171 measures the complexity of the image of the current block 161, and supplies a measurement result thereof to the inter prediction restriction unit 152.

The inter prediction restriction unit 152 determines whether restricting the inter prediction according to the complexity of the image, and supplies a control flag (inter prediction control information) of a value according to the determination to the predicted image selection unit 127.

The peripheral block complexity measuring unit 172 includes a block 1 complexity measuring unit 181, a block 2 complexity measuring unit 182, a block 3 complexity measuring unit 183, and a block 4 complexity measuring unit 184. The block 1 complexity measuring unit 181 to the block 4 complexity measuring unit 184 respectively measure the complexity of the images of the peripheral blocks 162-1 to the peripheral block 162-4, and supply measurement results thereof to the intra prediction restriction unit 151.

The intra prediction restriction unit 151 determines whether restricting the prediction direction of the intra prediction according to the complexity of the images, and supplies a control flag (intra prediction control information) of a value according to the determination to the intra prediction unit 125.

### <Prediction Restriction Control>

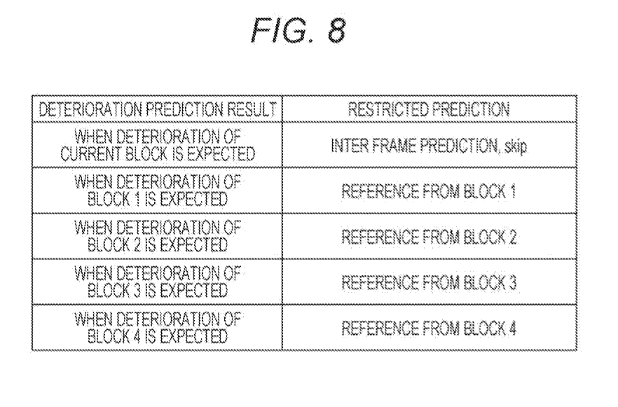

The intra prediction restriction unit 151 and the inter prediction restriction unit 152 perform prediction restriction, as illustrated in FIG. 8, for example. That is, when the complexity of the current block 161 (current block) is high and the deterioration is expected, inter frame prediction and a skip mode are restricted (excluded from the candidates). When the complexity of the peripheral block 162 is high and the deterioration is expected, reference from the peripheral block is restricted (excluded from the candidates).

The prediction restriction unit 142 can restrict (exclude) the reference of the block (prediction using the block) having severe deterioration by performing the prediction restriction as described above, and can suppress propagation of the deterioration of image quality due to encoding by the compression unit 121. That is, the image encoding device 100 can suppress a decrease in the image quality due to this encoding.

### <Flow of Encoding Processing>

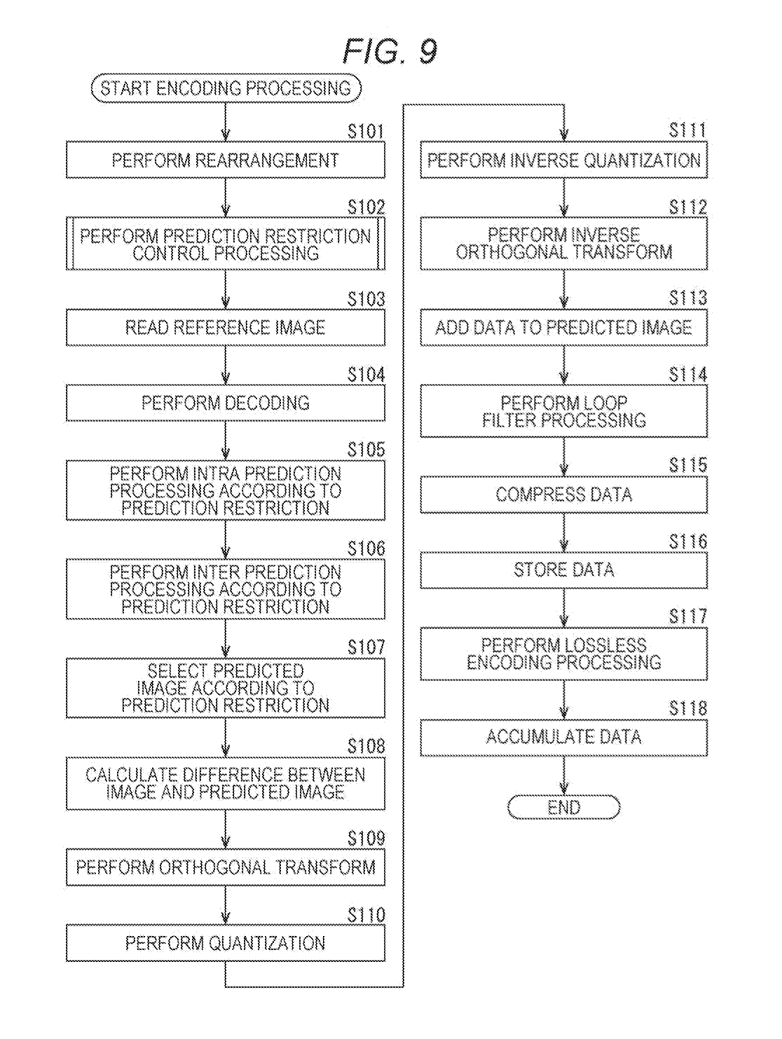

Next, an example of a flow of processing executed by the image encoding device 100 will be described. First, an example of a flow of encoding processing will be described with reference to the flowchart of FIG. 9.

Upon the start of the encoding processing, in step S101, the screen rearrangement buffer 111 stores the images of the frames (pictures) of an input moving image in the order of display, and rearranges the images from the order of display of the pictures to the order of encoding.

In step S102, the deterioration prediction unit 141 and the prediction restriction unit 142 perform prediction restriction control processing.

In step S103, the decoding unit 123 reads the encoded data of the reference image from the frame buffer 122. In step S104, the decoding unit 123 decodes the encoded data to obtain the reference image data.

In step S105, the intra prediction unit 125 performs intra prediction processing according to prediction restriction in step S102. Further, in step S106, the inter prediction unit 126 performs inter prediction processing according to the prediction restriction in step S102.

In step S107, the predicted image selection unit 127 selects either one of the predicted image generated by the intra prediction processing in step S105 and the predicted image generated by the inter prediction processing in step S106, based on a cost function value and the like, according to the prediction restriction in step S102.

In step S108, the calculation unit 112 calculates a difference between the input image in the rearranged frame order in the processing in step S101, and the predicted image selected in the processing in step S107. That is, the calculation unit 112 generates residual data between the input image and the predicted image. A data amount of the residual data obtained in this way is decreased compared with the original image data. Therefore, the data amount can be compressed compared with a case where the image is encoded as it is.

In step S109, the orthogonal transform unit 113 orthogonally transforms the residual data generated in the processing in step S108.

In step S110, the quantization unit 114 quantizes the orthogonal transform coefficient obtained in the processing in step S109.

In step S111, the inverse quantization unit 117 inversely quantizes the coefficient (also referred to as quantization coefficient) generated and quantized in the processing in step S110 with a characteristic corresponding to the characteristic of the quantization.

In step S112, the inverse orthogonal transform unit 118 inversely orthogonally transforms the orthogonal transform coefficient obtained in the processing in step S111.

In step S113, the calculation unit 119 generates the image data of the reconstructed image by adding the predicted image selected in the processing in step S107 to the residual data restored in the processing in step S112.

In step S114, the loop filter 120 performs the loop filter processing for the image data of the reconstructed image generated in the processing in step S113. Accordingly, block distortion and the like of the reconstructed image are removed.

In step S115, the compression unit 121 encodes and compresses the locally decoded image obtained in the processing in step S114. In step S116, the frame memory 11 stores the encoded data obtained in the processing in step S115.

In step S117, the lossless encoding unit 115 encodes the quantized coefficient obtained in the processing in step S110. That is, the lossless encoding such as the variable-length encoding and the arithmetic encoding is performed for the data corresponding to the residual data.

Further, at this time, the lossless encoding unit 115 encodes the information related to the prediction mode of the predicted image selected in the processing in step S107, and adds the encoded information to the encoded data obtained by encoding the differential image. That is, the lossless encoding unit 115 encodes the optimum intra prediction mode information supplied from the intra prediction unit 125 or the information according to the optimum inter prediction mode supplied from the inter prediction unit 126, and adds the encoded information to the encoded data.

In step S118, the accumulation buffer 116 accumulates the encoded data and the like obtained in the processing in step S117. The encoded data and the like accumulated in the accumulation buffer 116 are appropriately read as a bit stream, and is transmitted to the decoding side through a transmission line or a recording medium.

When the processing in step S118 is terminated, the encoding processing is terminated.

### <Flow of Prediction Restriction Control Processing>

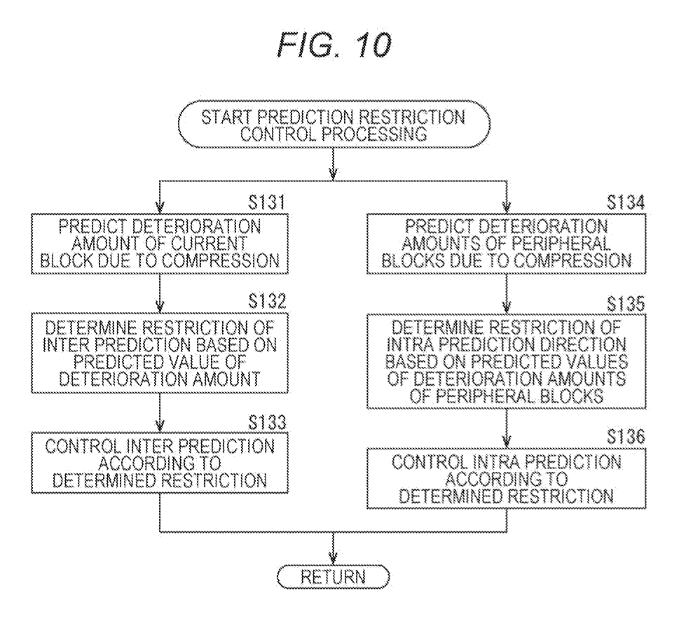

Next, an example of a flow of prediction restriction control processing executed in step S102 of FIG. 9 will be described with reference to the flowchart of FIG. 10. Upon the start of the prediction restriction control processing, in step S131, the deterioration prediction unit 141 predicts the deterioration amount due to the compression of the current block 161. In step S132, the inter prediction restriction unit 152 determines restriction of the inter prediction, based on the predicted value of the deterioration amount obtained in step S131. In step S133, the inter prediction restriction unit 152 controls the inter prediction according to the restriction determined in step S132 by supplying the control flag (inter prediction control information) to the predicted image selection unit 127.

For example, when restricting the inter prediction, in step S107, the predicted image selection unit 127 selects the intra expectation unit 125, and supplies the predicted image supplied from the intra prediction unit 125 to the calculation unit 112 and the calculation unit 119 (does not select the inter prediction unit 126). Note that, in this case, the processing of step S106 may be omitted.

In contrast, when not restricting the inter prediction, in step S107, the predicted image selection unit 127 selects the predicted image, based on the cost function value and the like, similarly to the usual case.

The processing in steps S134 to S136 is executed in parallel to the processing in steps S131 to S133. That is, in step S134, the deterioration prediction unit 141 predicts the deterioration amount due to the compression of the peripheral block 162. In step S135, the intra prediction restriction unit 151 determines restriction of the intra prediction direction, based on the predicted values of the deterioration amounts of the respective peripheral blocks. In step S136, the intra prediction restriction unit 151 controls the intra prediction according to the restriction determined in step S135 by supplying the control flag (intra prediction control information) to the intra prediction unit 125.

For example, when restricting the prediction direction of the intra prediction, in step S105, the intra prediction unit 125 performs intra prediction in the prediction direction other than the restricted prediction direction (omits the intra prediction in the restricted prediction direction).

When the processing in steps S133 and S136 is terminated, the prediction restriction control processing is terminated.

By executing the processing as described above, the image encoding device 100 can suppress a decrease in image quality due to encoding.

### <Non-Square Compression Block>

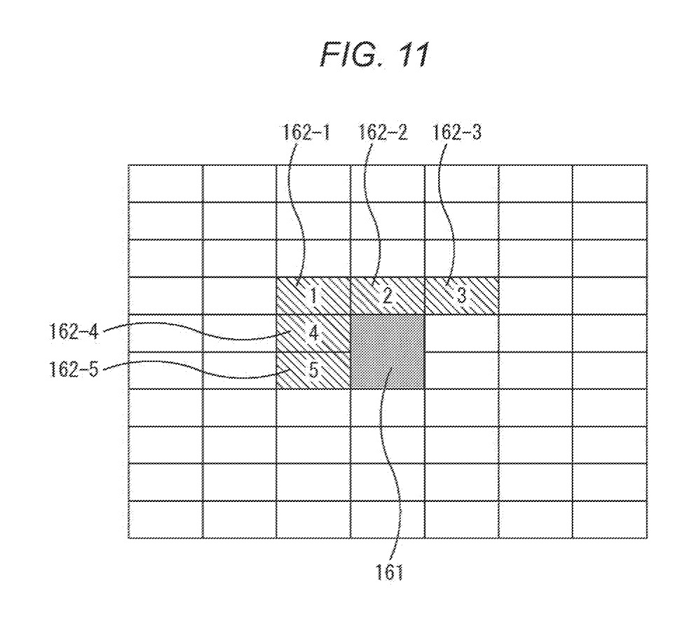

For example, as illustrated in FIG. 11, when a compression block that is the unit of compression processing by the compression unit 121 is a non-square (rectangle), a plurality of the compression blocks is in contact with the current block in a direction in which the short sides of the compression blocks are in contact. There is no guarantee against the deterioration amounts being unified among the compression blocks. Therefore, by referring to the image from this direction, deterioration of image quality may be caused.

Therefore, in such a case, the intra prediction from the non-square compression block with the short side being in contact with the current block may be restricted, regardless of the deterioration amounts of the respective compression blocks.

For example, in the case of the example of FIG. 11, in the intra prediction, the reference from the peripheral blocks 162-1, 162-4, and 162-5 may be restricted, regardless of the predicted values of the deterioration amounts of the peripheral blocks.

### <Deterioration Prediction Unit and Prediction Restriction Unit>

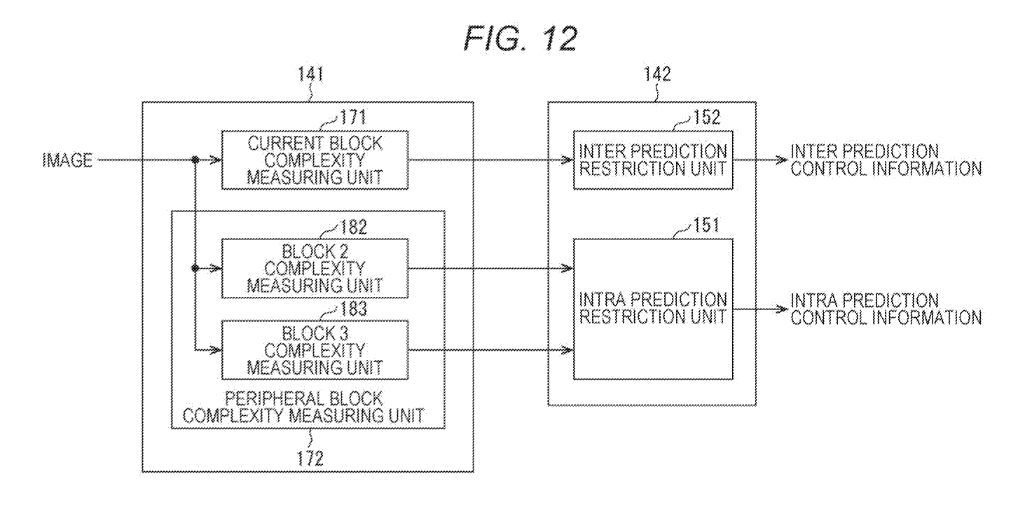

In that case, the principal configurations of the deterioration prediction unit 141 and the prediction restriction unit 142 are as illustrated in the example of FIG. 12. That is, there is no need to predict the deterioration amount about the peripheral blocks 162-1, 162-4, and 162-5, and thus the block 1 complexity measuring unit 181 and the block 4 complexity measuring unit 184 are omitted, compared with the case of FIG. 7. Apparently, the processing unit that measures the complexity of the peripheral block 162-5 is not provided.

### <Prediction Restriction Control>

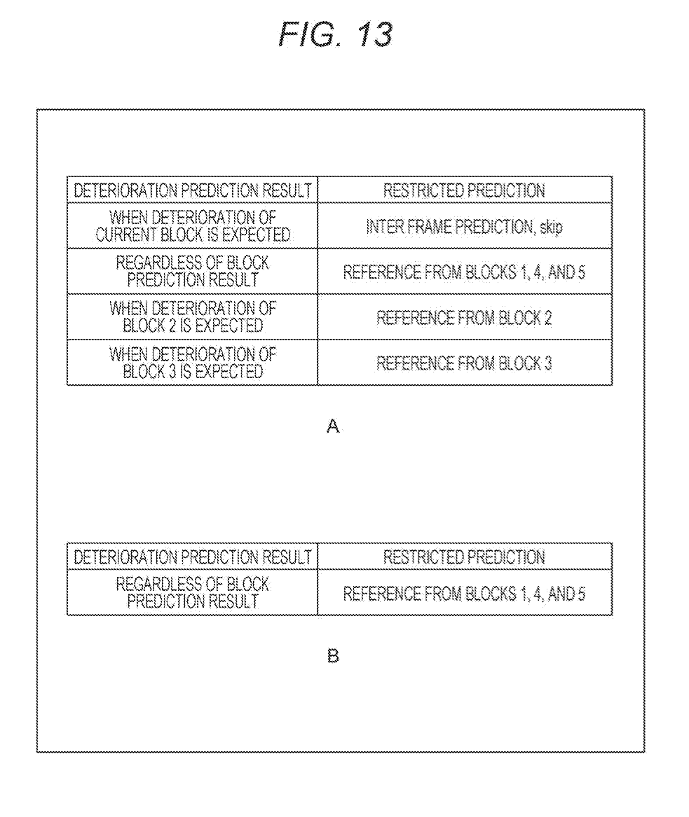

In this case, the intra prediction restriction unit 151 and the inter prediction restriction unit 152 perform prediction restriction, as illustrated in A in FIG. 13, for example. That is, restriction of the inter prediction is performed, similarly to the case of FIG. 8. Further, as for the intra prediction, reference of the peripheral blocks 162-2 and 162-3 (including the vicinity) with long sides being in contact with the current block is restricted according to the deterioration amount, similarly to the case of FIG. 8. As described above, reference of the peripheral blocks 162-1, 162-4, and 162-5 is restricted, regardless of the deterioration amounts.

The prediction restriction unit 142 can restrict (does not employ) the reference from the blocks with a high possibility of occurrence of deterioration (prediction using the blocks), by performing the prediction restriction as described above, and can suppress the propagation of the deterioration of image quality due to encoding by the compression unit 121. That is, the image encoding device 100 can suppress a decrease in the image quality due to this encoding.

Note that the intra prediction restriction unit 151 and the inter prediction restriction unit 152 may perform the prediction restriction, as illustrated in B in FIG. 13. That is, the reference only from the peripheral blocks 162-1, 162-4, and 162-5 is restricted, and the inter prediction and the reference from the peripheral blocks 162-2 and 162-3 may not be restricted. In doing so, the control becomes easier.

### <Flow of Prediction Restriction Control Processing>

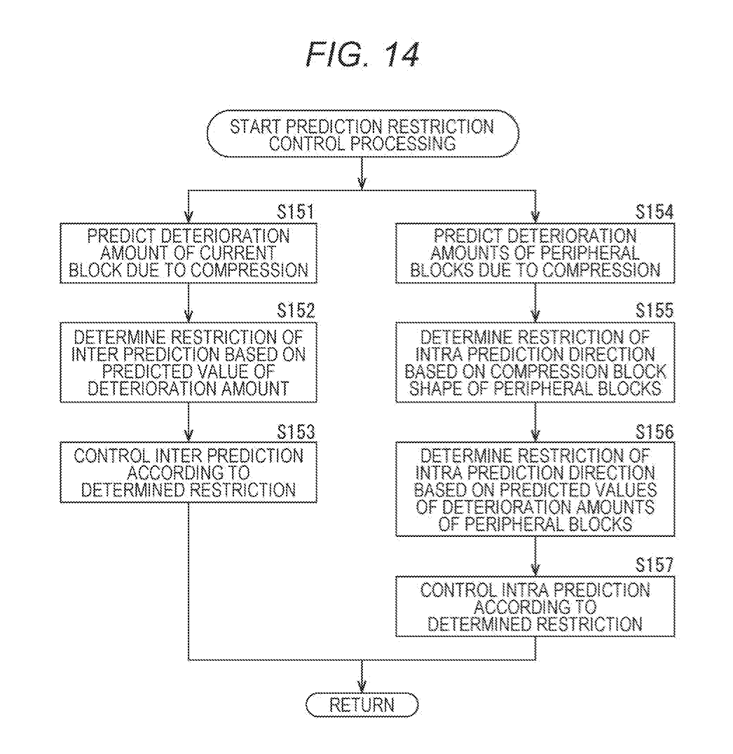

Next, an example of a flow of prediction restriction control processing will be described with reference to the flowchart of FIG. 14. In this case, the processing in steps S151 to S153 is similarly executed to the processing in steps S131 to S133. Further, the processing in step S154 is also similarly executed to step S134.

In step S155, the intra prediction restriction unit 151 determines restriction of the intra prediction direction, based on the compression block shape of the peripheral block. Then, in step S156, the intra prediction restriction unit 151 determines restriction of the intra prediction direction about the peripheral blocks that have not been restricted in the processing in step S155, based on the predicted values of the deterioration amounts of the peripheral blocks. In step S157, the intra prediction restriction unit 151 controls the intra prediction according to the restriction determined in steps S155 and S156, by supplying the control flag (intra prediction control information) to the intra prediction unit 125.

When the processing in steps S153 and S157 is terminated, the prediction restriction control processing is terminated.

By executing the processing as described above, the image encoding device 100 can suppress a decrease in image quality due to encoding.

### <Non-Square Compression Block 2>

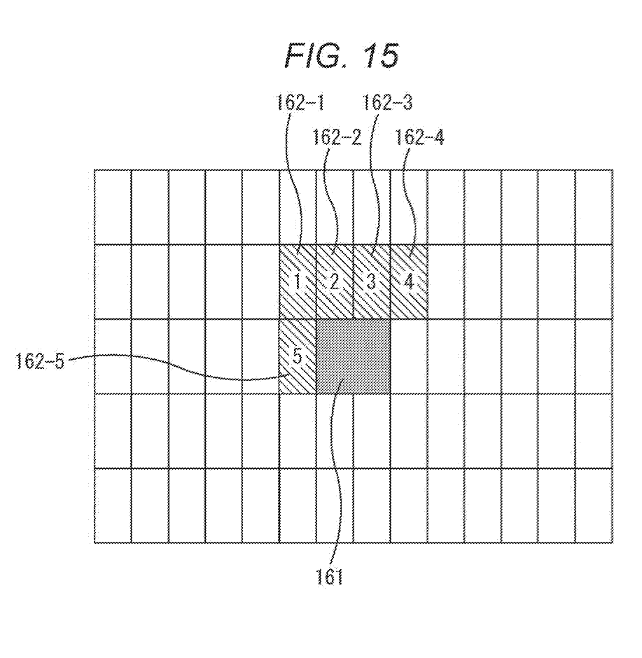

Note that FIG. 11 illustrates the case where the compression block is the horizontally long rectangle. However, a case where the compression block is a vertically long rectangle, as illustrated in the example of FIG. 15, can be similarly controlled. That is, in the case of the example of FIG. 15, the short sides of the non-square peripheral blocks are in contact with the upper direction of the current block, and thus reference from the peripheral blocks 162-1 to 162-4 is restricted, regardless of the deterioration amounts. Note that the above description has been made using the rectangle as an example of the non-square. However, the shape of the compression block is arbitrary. The compression block may be a square. For example, when the compression block is smaller than the current block even if the compression block is the square, there is a possibility that a plurality of the compression blocks is in contact with (a plurality of the compression blocks configures) one side of the current block. In such a case, there is a possibility that the deterioration amounts discord among the compression blocks, similarly to the non-square case. Therefore, the deterioration of image quality may be caused, by referring to the image from the direction of this one side. Therefore, in the case where the compression block is the square, the prediction direction may be restricted, similarly to the non-square case. That is, the intra prediction from the direction of the side of the current block, the side being configured from the plurality of compression blocks, may be restricted. In this case, “from the side” may include not only the “side” configured from the plurality of compression blocks, but also both ends of the side (that is, the corners of the current block). That is, the compression blocks adjacent to the current block in the diagonal direction may also be included in the range of the restriction.

### <Angular Prediction>

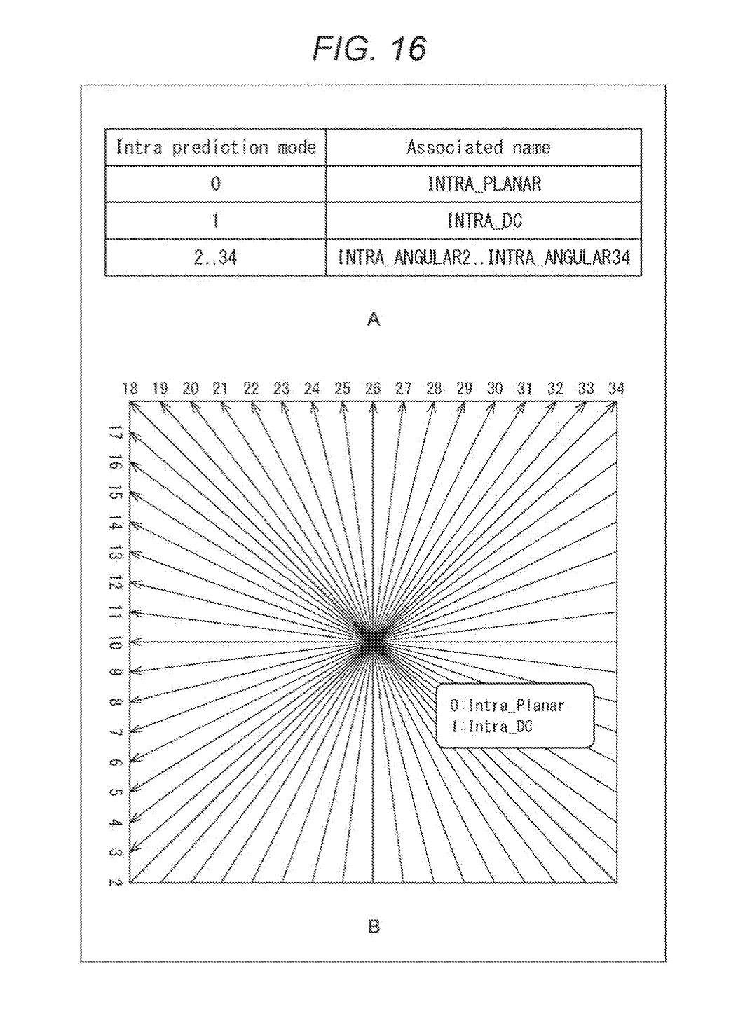

The present technology can be applied to intra angular prediction of the HEVC. In the HEVC, an intra angular prediction mode, as illustrated in FIGS. 16A and 16B, is prepared as one of the intra prediction modes. Restriction of such a prediction mode may be performed. Note that, as illustrated in B in FIG. 16, in the case of the intra angular prediction mode, a large number of prediction directions are prepared. Therefore, the processing amount may increase if the prediction directions are controlled one by one. However, neighbor prediction directions are mutually referred to from neighbors. Therefore, there is a high possibility that the neighbor prediction directions have a similar characteristic about the propagation of deterioration.

Therefore, the plurality of prediction directions may be collectively controlled.

### <Prediction Restriction Control>

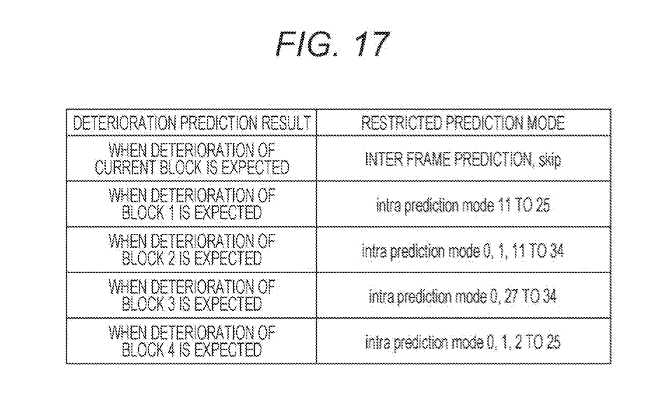

That is, in this case, the intra prediction restriction unit 151 and the inter prediction restriction unit 152 perform prediction restriction, as illustrated in FIG. 17, for example. That is, restriction of the inter prediction is performed, similarly to the case of FIG. 8. As for the intra prediction, the reference from a plurality of the prediction directions is collectively restricted, according to the predicted values of the deterioration amounts of the peripheral blocks 162. In doing so, the control becomes easier.

### <Image Encoding Device>

In the above description, the restriction of the prediction has been performed basically based on the predicted values of the deterioration by the deterioration prediction unit 141. However, an embodiment is not limited thereto, and for example, the prediction restriction unit 142 may restrict prediction based on information input from an outside of the image encoding device 100. For example, the prediction restriction unit 142 may restrict prediction according to predetermined control information input from a user or the like.

This control information is arbitrary, and may be, for example, information that directly specifies the restriction of prediction, or may be another information. For example, the information may be control information that controls the operations of the compression unit 121 and the decoding unit 123. To be specific, for example, the information may be information that controls the compression function to compress the image data to be enabled (ON) or disabled (OFF), when controlling the compression unit 121 and the decoding unit 123 to store the image data to the frame buffer 122.

### <Prediction Restriction Control>

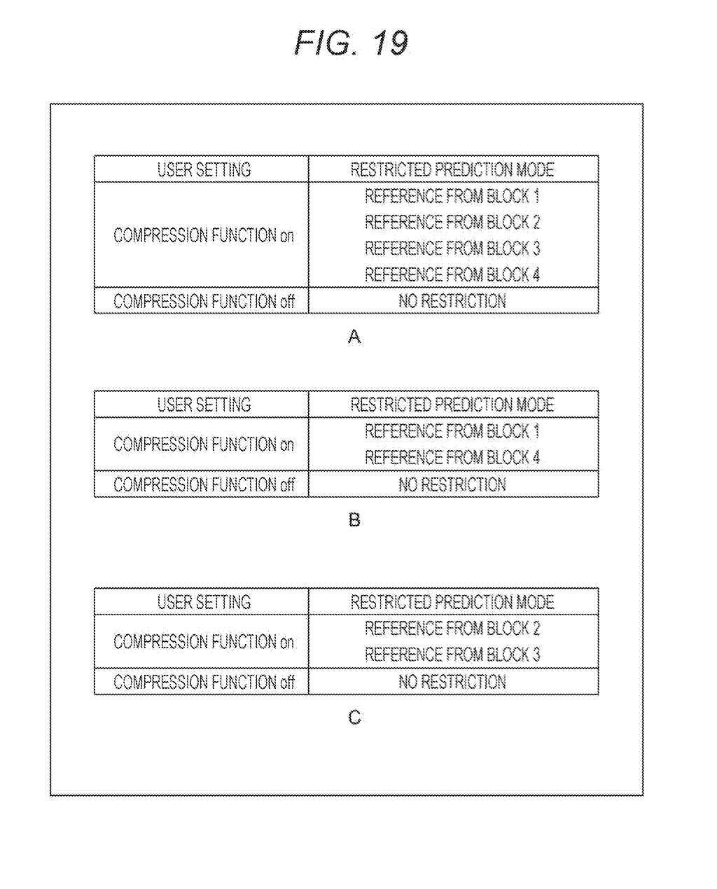

In this case, the intra prediction restriction unit 151 and the inter prediction restriction unit 152 may perform the prediction restriction, as illustrated in FIG. 19, based on the information that controls the compression function to be enabled (ON) or disabled (OFF). For example, when the control information indicates a value that causes the compression function to be ON, as illustrated in the example of A in FIG. 19, reference from the peripheral blocks is restricted. When the control information indicates a value that causes the compression function to be OFF, the prediction mode is not restricted. In doing so, the restriction of the prediction can be omitted in the state where the compression function having a small possibility of the propagation of the deterioration of image quality is in the OFF state.

Note that, when the compression block has a horizontally long size, as illustrated in the example of FIG. 11, the prediction restriction may be performed, as illustrated in the example of B in FIG. 19. Further, when the compression block has a vertically long size, as illustrated in the example of FIG. 15, the prediction restriction may be performed, as illustrated in the example of C in FIG. 19.

### <Flow of Prediction Restriction Control Processing>

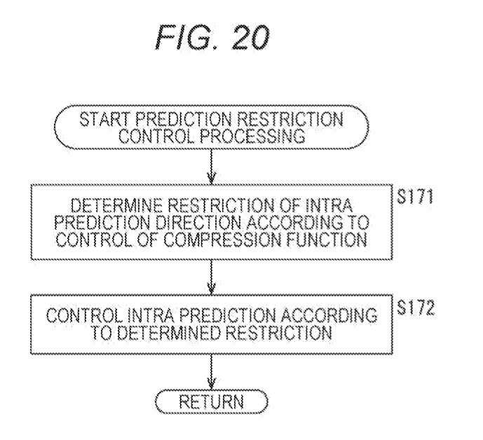

Next, an example of a flow of prediction restriction control processing of this case will be described with reference to the flowchart of FIG. 20.

Upon the start of the expectation restriction control processing, in step S171, the intra prediction restriction unit 151 determines restriction of the intra prediction direction according to the control information that controls the compression function.

In step S172, the intra prediction restriction unit 151 controls the intra prediction according to the restriction determined in step S171.

When the processing in step S172 is terminated, the prediction restriction control processing is terminated.

By executing the processing as described above, the image encoding device 100 can suppress a decrease in image quality due to encoding.

### 2. SECOND EMBODIMENT

### Intra Prediction Buffer

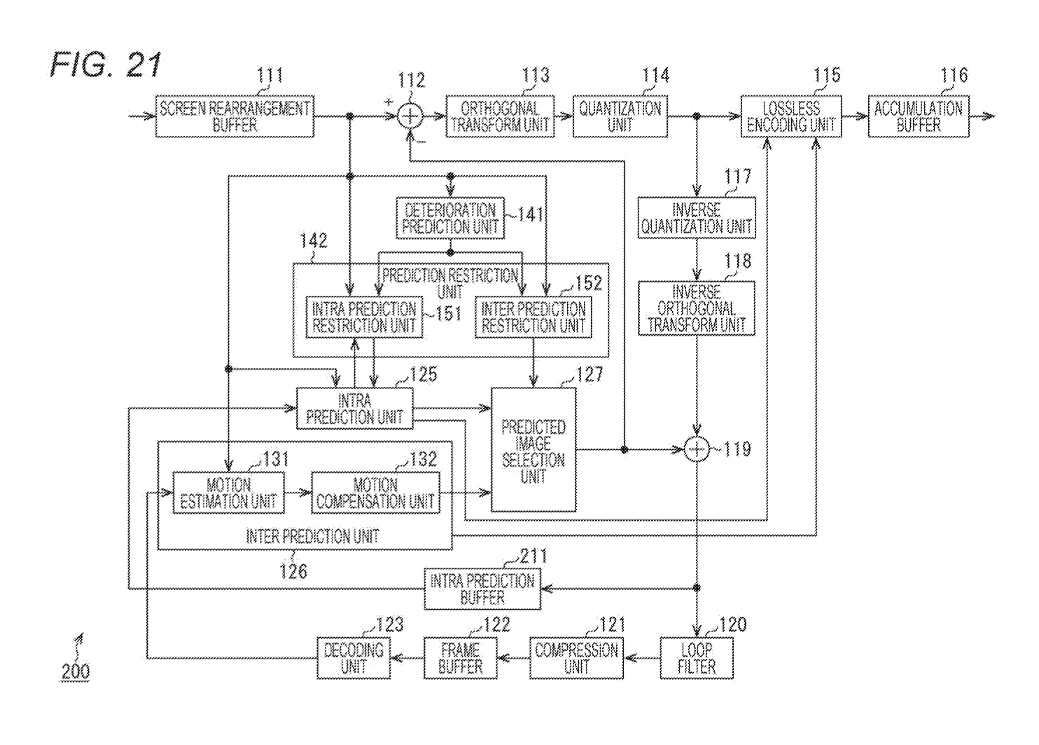

Further, as illustrated in the example of FIG. 21, an intra prediction buffer 211 may be provided, separately from a frame buffer 122, and an image to be referred to in intra prediction may be stored to the intra prediction buffer 211 in a non-compressed manner.

An image encoding device 200 illustrated in FIG. 21 basically has a similar configuration to the image encoding device 100, and performs similar processing. However, the image encoding device 200 includes the intra prediction buffer 211. In the intra prediction buffer 211, the image to be referred to in the intra prediction is stored. The image stored in the intra prediction buffer 211 is not compressed. An image stored in the frame buffer 122 is used only for inter prediction by an inter prediction unit 126.

### <Deterioration Prediction Unit and Prediction Restriction Unit>

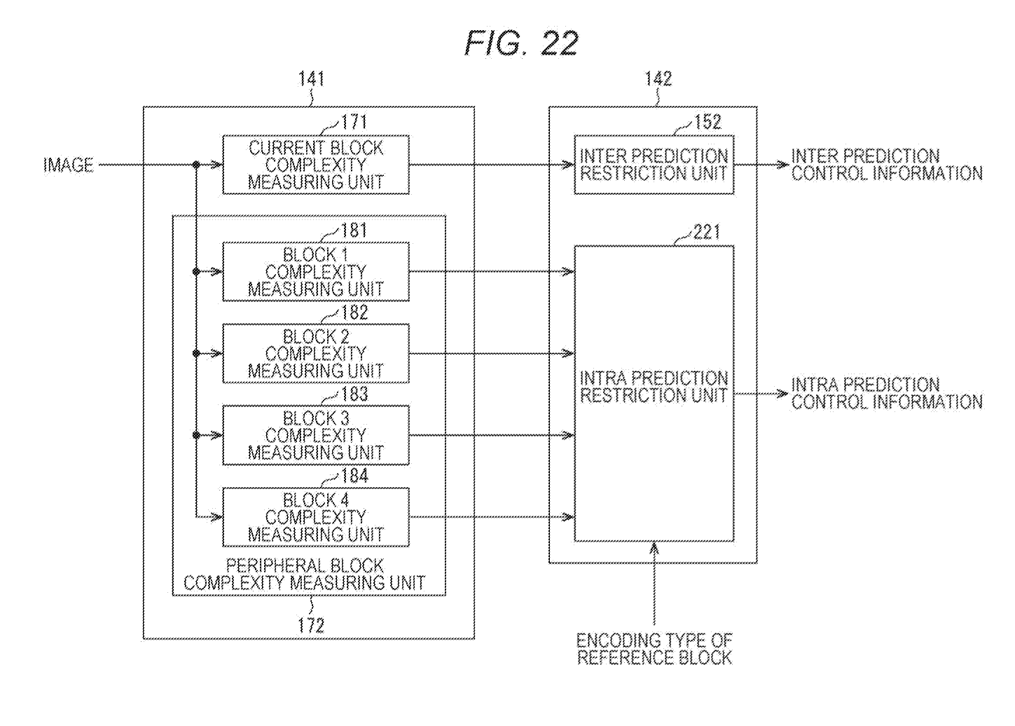

In this case, a deterioration prediction unit 141 and a prediction restriction unit 142 have the configuration illustrated in FIG. 22. That is, basically, these units have a similar configuration to the case of FIG. 7. However, the intra prediction restriction unit 151 further acquires an encoding type of a reference block from an intra prediction unit 125.

### <Prediction Restriction Control>

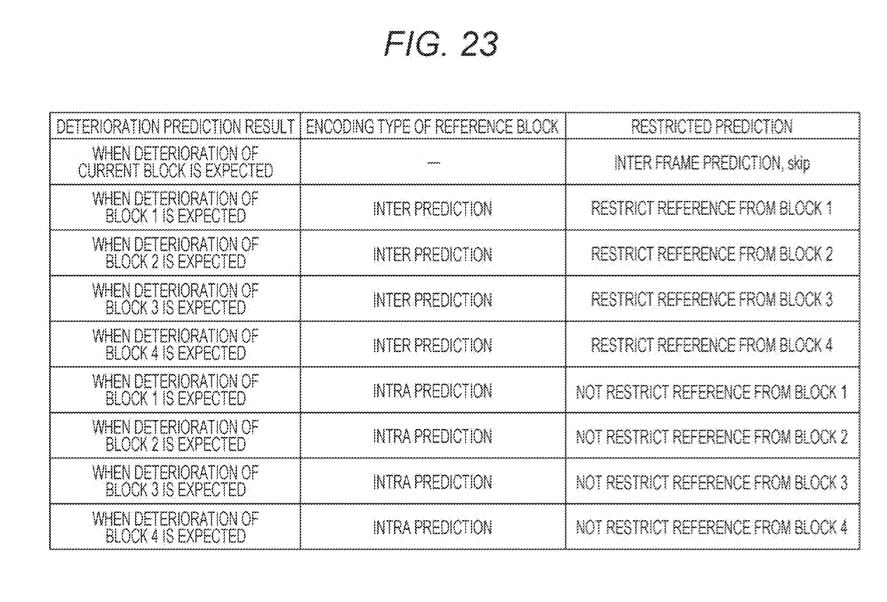

Then, an intra prediction restriction unit 151 and an inter prediction restriction unit 152 perform prediction restriction, as illustrated in FIG. 23, for example. That is, the prediction is restricted based on not only a predicted value of a deterioration amount, but also the encoding type of the reference block, regarding the restriction of the intra prediction (reference from a peripheral block).

For example, when the encoding type of the reference block is the intra prediction, the reference is not restricted regardless of the deterioration amount of the peripheral block. Further, for example, when the encoding type of the reference block is the inter prediction, the reference is restricted according to the deterioration amount of the peripheral block.

That is, the block of the intra prediction is stored in the intra prediction buffer 211 and is not compressed, and thus the reference is not restricted. Therefore, if the reference is unnecessarily restricted, the encoding efficiency may be decreased. With such control, the prediction restriction can be more appropriately controlled, and the unnecessary decrease in the encoding efficiency can be suppressed.

### <Flow of Prediction Restriction Control Processing>

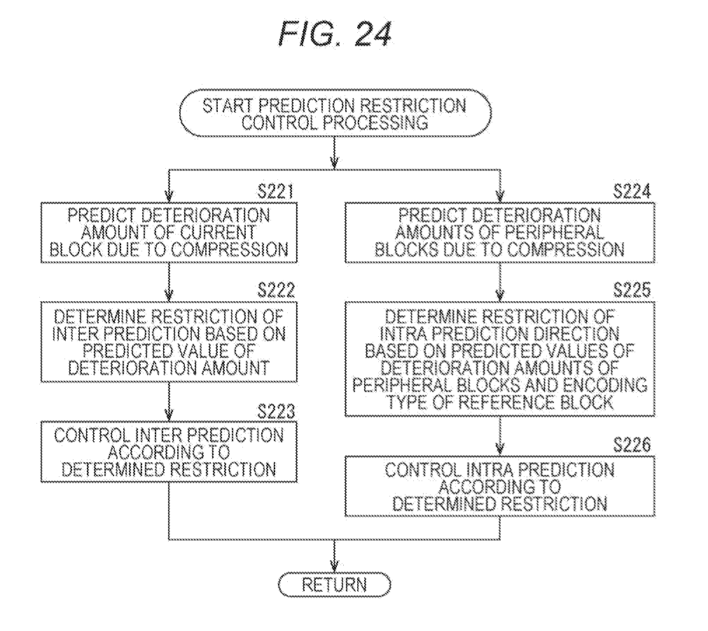

An example of a flow of prediction restriction control processing of this case will be described with reference to the flowchart of FIG. 24. Processing of steps S221 to S223 of this case is similarly executed to the processing of steps S131 to S133 of the case of FIG. 10. Further, processing of steps S224 to S226 of FIG. 24 is similarly executed to the processing of steps S134 to S136 of FIG. 10.

Note that, in step S225, unlike step S135, the intra prediction restriction unit 151 determines restriction of an intra prediction direction, based on predicted values of deterioration amounts of respective peripheral blocks and the encoding type of the reference block.

By executing the processing as described above, the image encoding device 100 can suppress a decrease in image quality due to encoding.

### <Deterioration Prediction Unit and Prediction Restriction Unit>

Note that, at this time, the restriction of the reference of the intra prediction may be controlled based only on the encoding type of the reference block without predicting the deterioration amounts. In that case, the deterioration prediction unit 141 has only a current block complexity measuring unit 171. Only information of the encoding type of the reference block is supplied to the intra prediction restriction unit 151. That is, the intra prediction restriction unit 151 generates and outputs intra prediction control information based on the encoding type of the reference block.

### <Prediction Restriction Control>

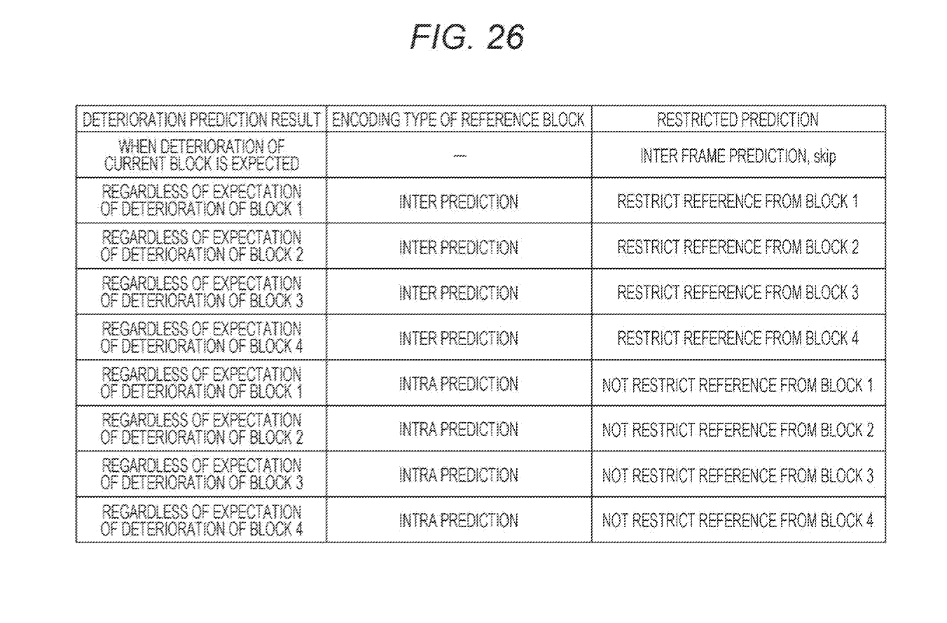

Then, the intra prediction restriction unit 151 and the inter prediction restriction unit 152 perform prediction restriction, as illustrated in FIG. 26, for example. That is, as for the restriction of the intra prediction (reference from the peripheral blocks), the prediction is restricted based on the encoding type of the reference block, regardless of the predicted values of the deterioration amounts.

For example, when the encoding type of the reference block is the intra prediction, the reference is not restricted regardless of the deterioration amounts of the peripheral blocks. Further, for example, when the encoding type of the reference block is the inter prediction, the reference is restricted regardless of the deterioration amounts of the peripheral blocks.

By performing the control in this way, the predict ion restriction can be more easily performed.

### <Flow of Prediction Restriction Control Processing>

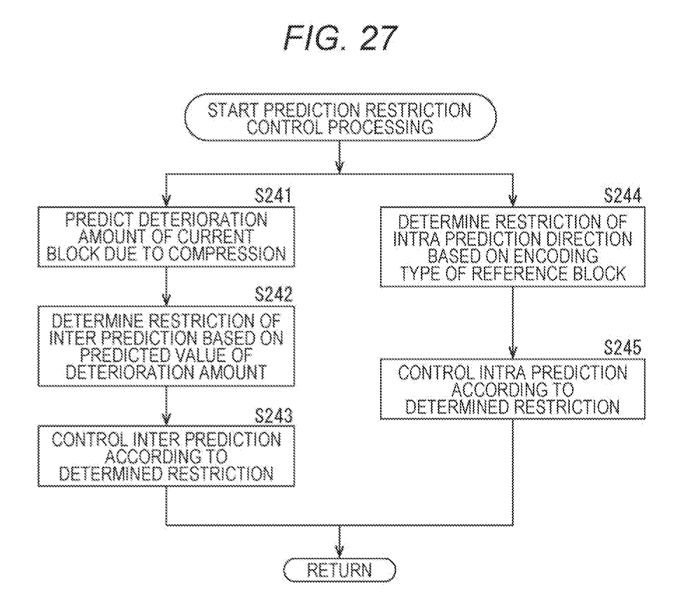

An example of a flow of prediction restriction control processing of this case will be described with reference to the flowchart of FIG. 27. Processing of steps S241 to S243 of this case is similarly executed to the processing of steps S221 to S223 of FIG. 24. Further, in the case of FIG. 27, the processing (prediction of the deterioration amounts of the peripheral blocks) of step S244 of FIG. 24 is omitted. Further, the processing of steps S244 and S245 is executed in parallel to the processing of steps S241 to S243.

Then, in step S244 of FIG. 27, the intra prediction restriction unit 151 determines restriction of the intra prediction direction based on the encoding type of the reference block. In step S245, the intra prediction restriction unit 151 controls the intra prediction according to the determined restriction.

By executing the processing as described above, the image encoding device 100 can suppress a decrease in image quality due to encoding.

### <Image Encoding Device>

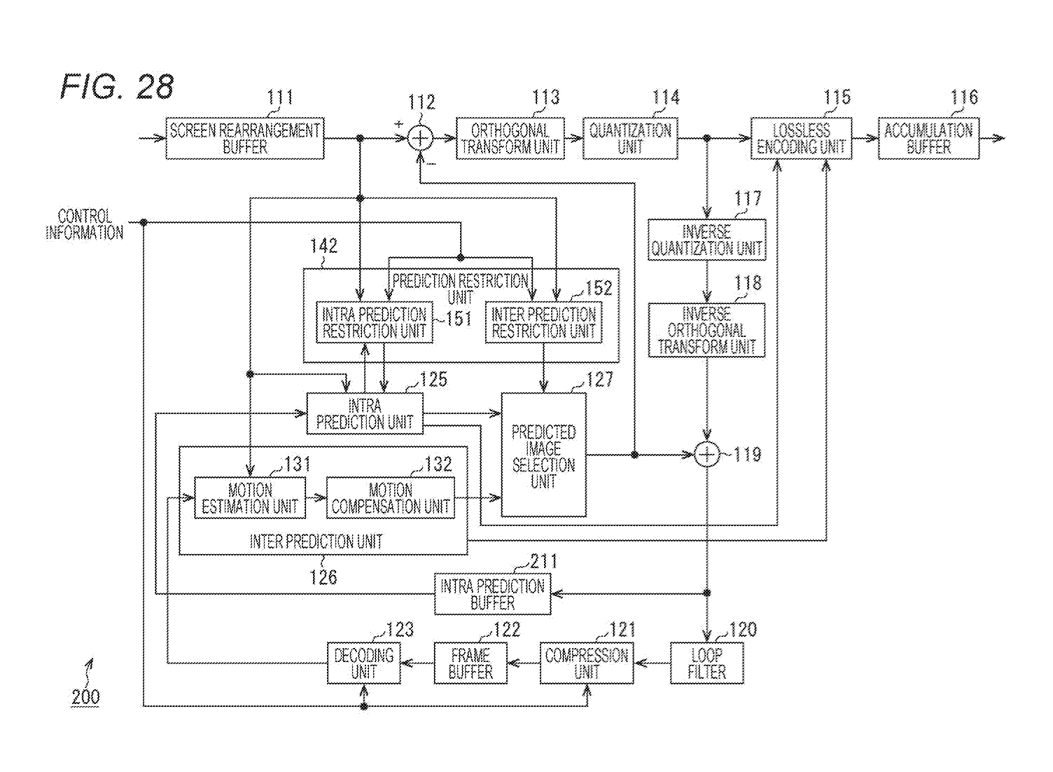

As illustrated in FIG. 28, in the case of the image encoding device 200 of the second embodiment, the prediction restriction unit 142 may restrict prediction based on information input from an outside of the image encoding device 200. For example, the prediction restriction unit 142 may restrict prediction according to predetermined control information input from a user or the like.

This control information is arbitrary, and may be, for example, information that directly specifies the restriction of prediction, or may be another information. For example, the information may be control information that controls the operations of a compression unit 121 and a decoding unit 123. To be specific, for example, the information may be information that controls the compression function to compress the image data to be enabled (ON) or disabled (OFF), when controlling the compression unit 121 and the decoding unit 123 to store the image data to the frame buffer 122.

### <Prediction Restriction Control>

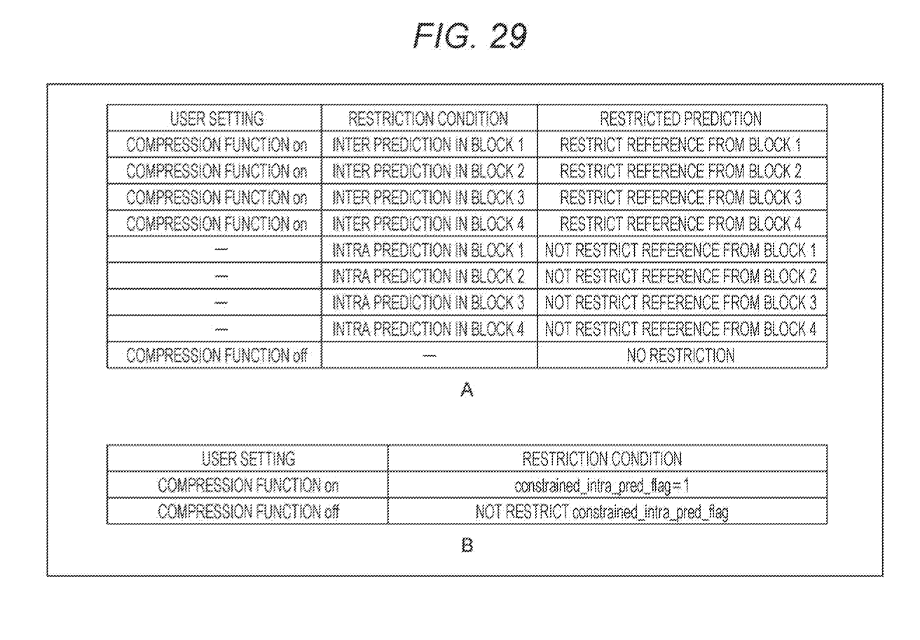

In this case, the intra prediction restriction unit 151 and the inter prediction restriction unit 152 may perform the prediction restriction, as illustrated in FIG. 29, based on the information that controls the compression function to be enabled (ON) or disabled (OFF). Further, for example, as illustrated in the example of A in FIG. 29, reference may not be restricted regardless of a value of the control information, about the peripheral blocks having a prediction mode of the intra prediction. Further, when the control information has a value that causes a compression function to be OFF, the prediction mode may not be restricted. In doing so, the restriction of the prediction can be omitted in the state where the compression function having a small possibility of the propagation of deterioration of image quality is in the OFF state.

When the compression function is enabled (ON), as illustrated in the example of B in FIG. 29, constrained_intra_pred_flag may be restricted (for example, a value of the flag is set to “1”). When the compression function is disabled (OFF), constrained_intra_pred_flag may not be restricted.

### <Flow of Prediction Restriction Control Processing>

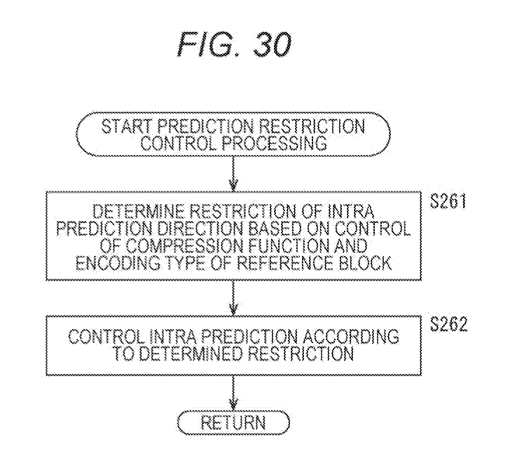

Next, an example of a flow of prediction restriction control processing of this case will be described with reference to the flowchart of FIG. 30.

Upon the start of the expectation restriction control processing, in step S261, the intra prediction restriction unit 151 determines the restriction of the intra prediction direction according to the control information that controls the compression function and the encoding type of the reference block.

In step S262, the intra prediction restriction unit 151 controls the intra prediction according to the restriction determined in step S261.

When the processing of step S262 is terminated, the prediction restriction control processing is terminated.

By executing the processing as described above, the image encoding device 200 can suppress a decrease in image quality due to encoding.

### 3. THIRD EMBODIMENT

### Smoothing Processing

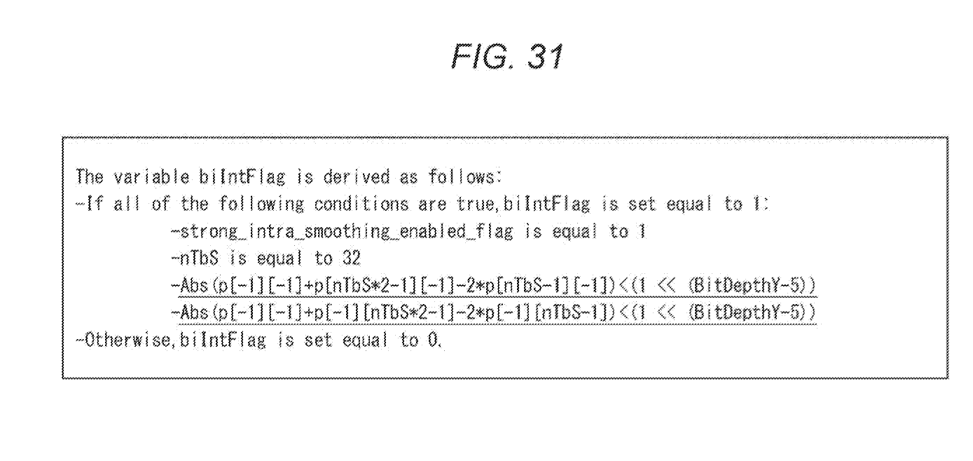

In the specification of HEVC, a smoothing filter is applied at the time of conducting intra prediction, and a more flat predicted image may be generated. Application of the filter is determined in the specification of HEVC, as illustrated in FIG. 31.

As a filtering condition, threshold determination may be conducted with three point pixel values, as illustrated in the red-line portion. This means there is a possibility that a condition determination result of the underlined portion is replaced due to compression distortion, when a pixel value is changed due to compression processing.

When discordance of ON/OFF of filtering of the intra prediction occurs between an encoder to which frame buffer compression is applied and a decoder to which the frame buffer compression is not applied, discordance similarly occurs between predicted images, which finally leads to deterioration of image quality. To avoid this problem, at the time of compression of a frame buffer, strong_intra_smoothing_enabled_flag=0 is set, and control is performed to keep the above condition false on a constant basis.

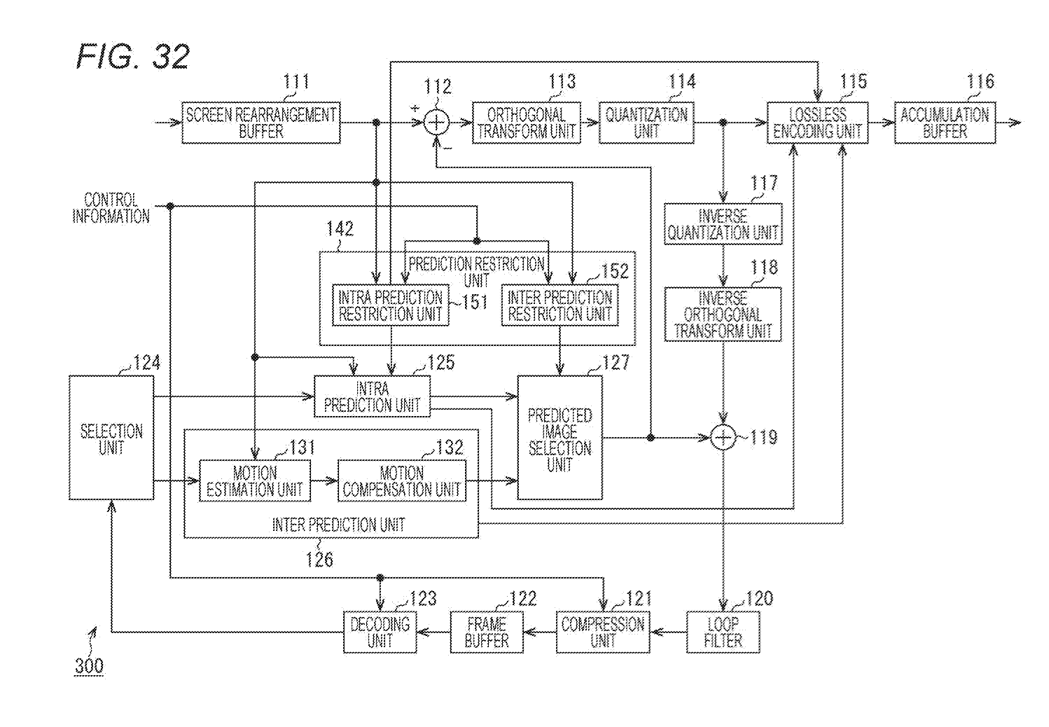

An image encoding device 300 illustrated in FIG. 32 basically has a similar configuration to the image encoding device 100, and performs similar processing. However, the image encoding device 300 performs restriction of strong_intra_smoothing_enabled_flag.

### <Prediction Restriction Control>

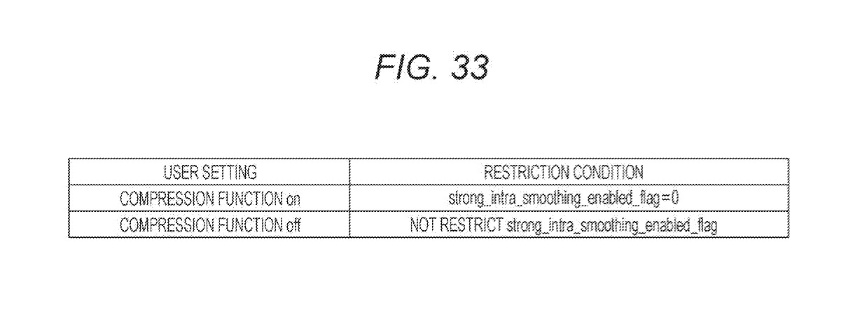

In this case, an intra prediction restriction unit 151 may perform prediction restriction, as illustrated in FIG. 33, based on information that controls the compression function to be enabled (ON) or disabled (OFF). For example, when the compression function is enabled (ON), strong_intra_smoothing_enabled_flag may be restricted to 0, and when the compression function is disabled (OFF), the strong_intra_smoothing_enabled_flag may not be restricted.

### <Flow of Prediction Restriction Control Processing>

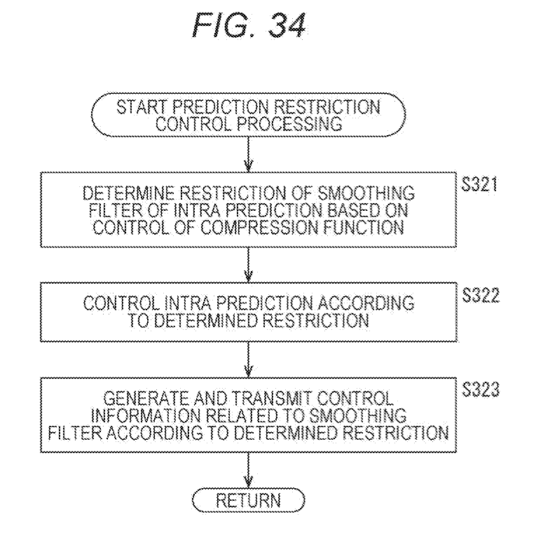

Next, an example of a flow of prediction restriction control processing of this case will be described with reference to the flowchart of FIG. 34.

Upon the start of the expectation restriction control processing, in step S321, the intra prediction restriction unit 151 determines restriction of the smoothing filter of the intra prediction, based on the control information that controls the compression function. In step S322, the intra prediction restriction unit 151 controls the intra prediction according to the restriction determined in step S321. In step S323, the intra prediction restriction unit 151 generates control information regarding the smoothing filter according to the determined restriction, and supplies the control information to the lossless encoding unit 115 to cause the lossless encoding unit 115 to transmit the control information.

When the processing in step S323 is terminated, the prediction restriction control processing is terminated.

By executing the processing as described above, the image encoding device 300 can suppress a decrease in image quality due to encoding.

### 4. FOURTH EMBODIMENT

### Image Processing System

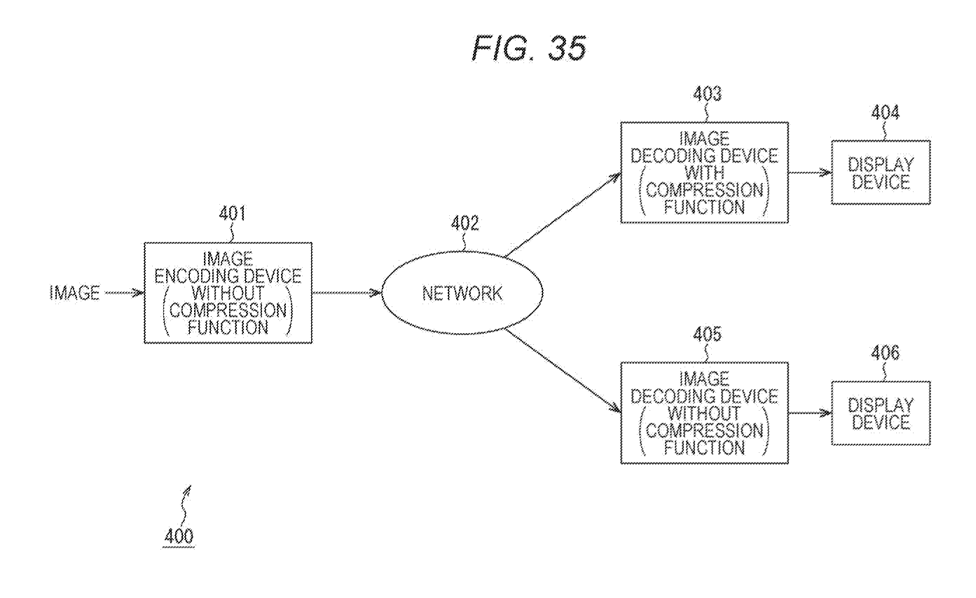

FIG. 35 is a diagram illustrating an example of an image processing system. In FIG. 35, an image processing system 400 includes an image encoding device 401, a network 402, an image decoding device 403, a display device 404, an image decoding device 405, and a display device 406.

An image input to the image encoding device 401 is encoded in the image encoding device 401, and is supplied to the image decoding device 403 and the image decoding device 405 through the network 402 as encoded data. The image decoding device 403 decodes the encoded data, and supplies the decoded image to the display device 404. Further, the image decoding device 405 decodes the encoded data, and displays the decoded image in the display device 406.

In such an image processing system 400, as illustrated in FIG. 35, the image encoding device 401 does not have a compression function of a reference image. In contrast, the image decoding device 403 has a compression function of a reference image although the image decoding device 405 does not have the compression function of a reference image.

### <Image Decoding Device>

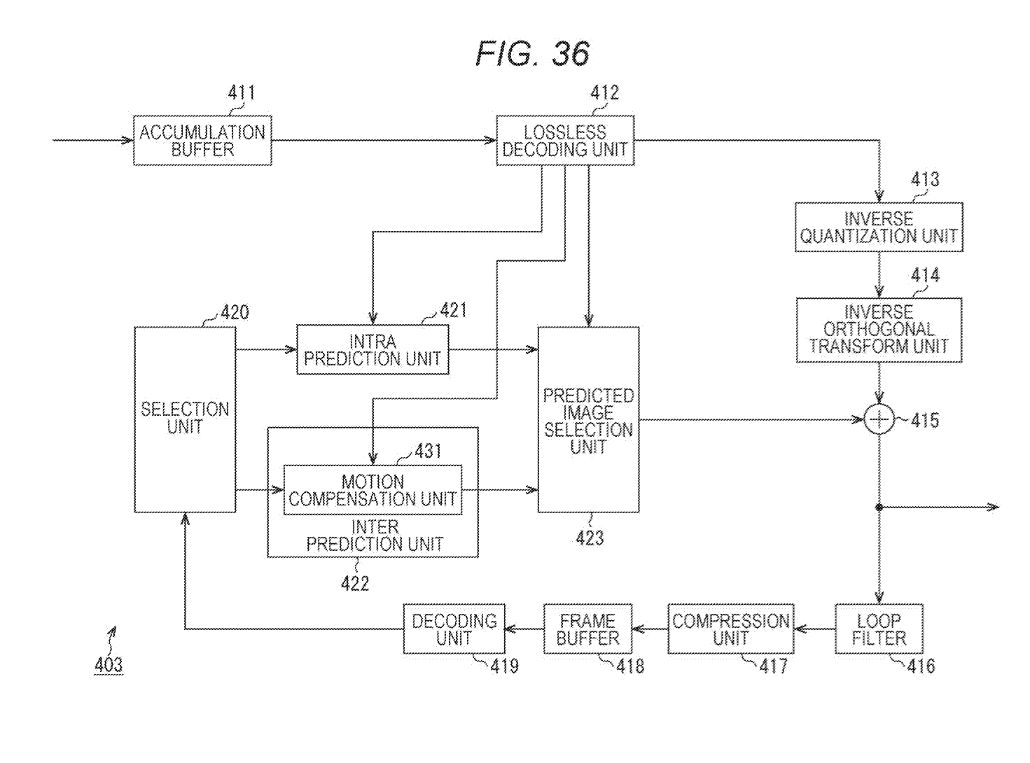

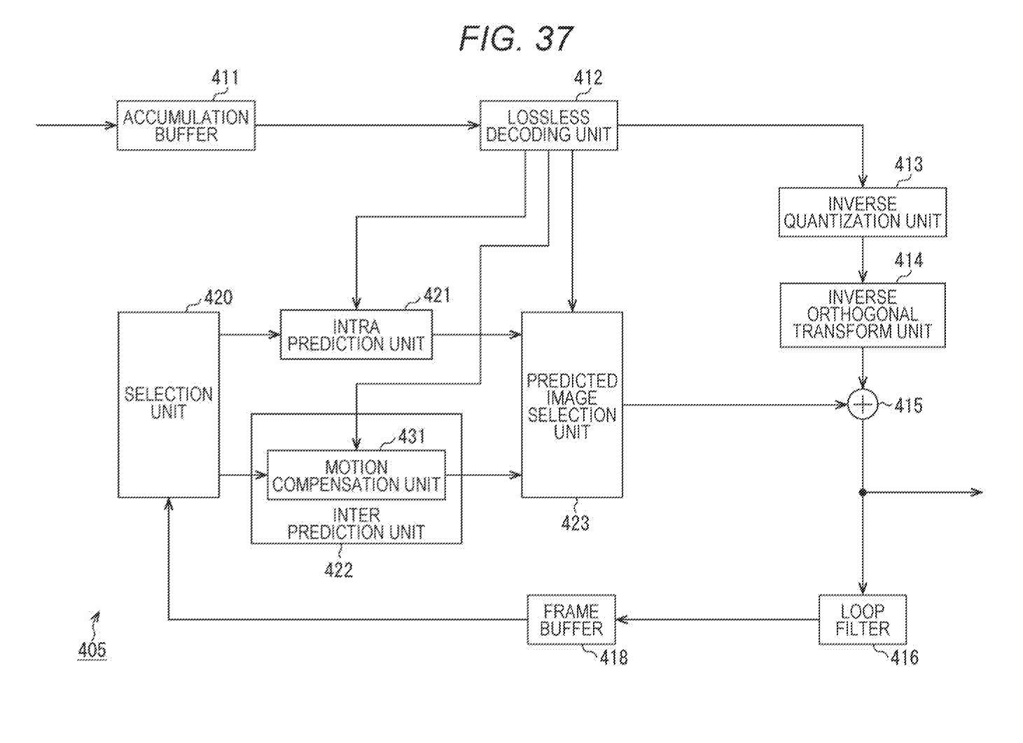

A detailed example of a configuration of the image decoding device 403 is illustrated in FIG. 36. Further, a detailed example of a configuration of the image decoding device 405 is illustrated in FIG. 37. As illustrated in FIG. 36, the image decoding device 403 includes a compression unit 417 that compresses the reference image to be stored to a frame buffer 418 and a decoding unit 419 that decodes encoded data read from the frame buffer 418. In contrast, the image decoding device 405 does not have such a compression unit 417 and a decoding unit 419. Therefore, image data filtered in a loop filter 416 is stored to the frame buffer 418 without being compressed.

### <Image Encoding Device>

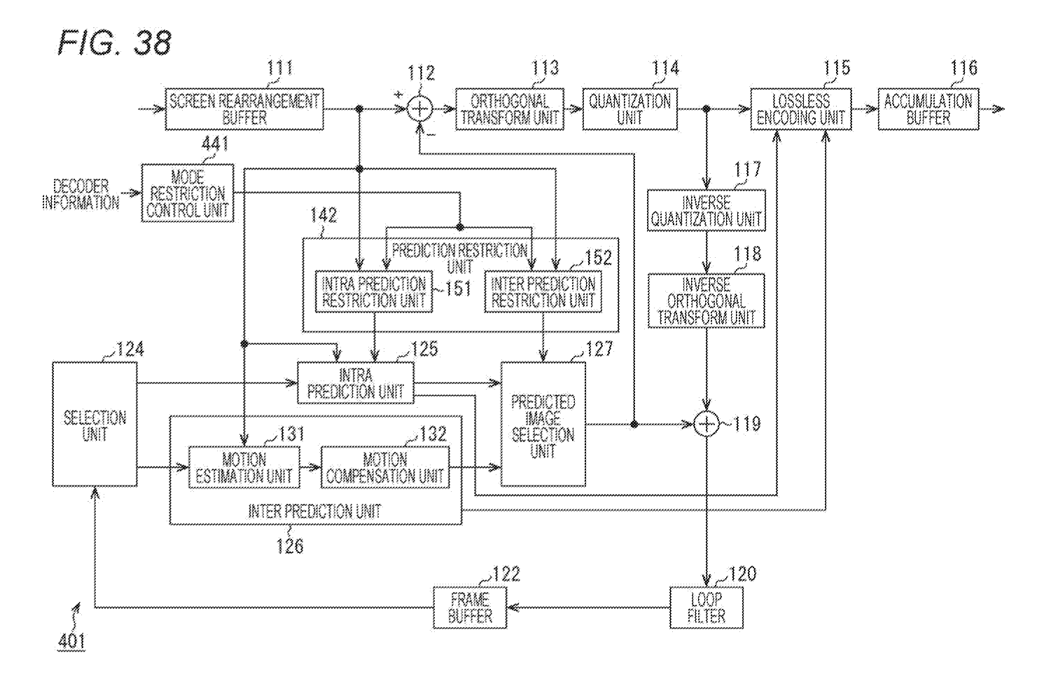

A detailed configuration example of the image encoding device 401 is illustrated in FIG. 38. As illustrated in FIG. 38, the image encoding device 401 does not have a compression unit corresponding to the compression unit 417 and a decoding unit corresponding to the decoding unit 419, similarly to the image decoding device 405. Therefore, the image data filtered in a loop filter 120 is stored to a frame buffer 122 without being compressed.

### <Functional Discordance and Mode Restriction>

Discordance may occur in the reference image due to a difference in the functions between the encoder and the decoder. Then, due to the discordance of the reference image, deterioration of image quality, which is not expected at the encoder side, may occur at the decoder side.

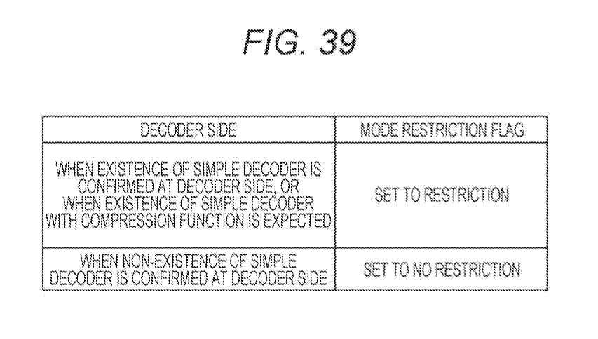

Therefore, the encoder side (image encoding device 401) may switch an operation, as illustrated in FIG. 39, depending on whether a simple decoder having the compression function is included in the decoder (the image decoding device 403 or the image decoding device 405) that decodes a bit stream.

As illustrated in FIG. 38, the image encoding device 401 includes a mode restriction control unit 441. The mode restriction control unit 441 acquires decoder information including information related to the function included in the decoder from an outside of the image encoding device 401. The mode restriction control unit 441 controls the value of the mode restriction flag based on the decoder information.

For example, when existence of a function (simple decoder) to compress the reference image at the decoder side is confirmed or predicted, the mode restriction control unit 441 sets the flag of the mode restriction to true to decrease the discordance of the function between the encoder and the decoder. Further, when non-existence of the function (easy decoder) to compress the reference image at the decoder side is necessarily confirmed, the mode restriction control unit 441 sets the mode restriction flag to false. When the mode restriction control unit 441 sets the value of the mode restriction flag in this way, the mode restriction control unit 441 supplies the mode restriction flag to a prediction restriction unit 142.

Then, the prediction restriction unit 142 may restrict the prediction according to the value of the mode restriction flag. This method can be applied to each of the image encoding devices according to the first to third embodiments.

Note that a method of acquiring the information of the function of the decoder side is arbitrary. For example, the encoder may obtain the information by performing communication with the decoder. Alternatively, the information may be specified by a user of the encoder.

### <Application to Image Encoding Device of First Embodiment>

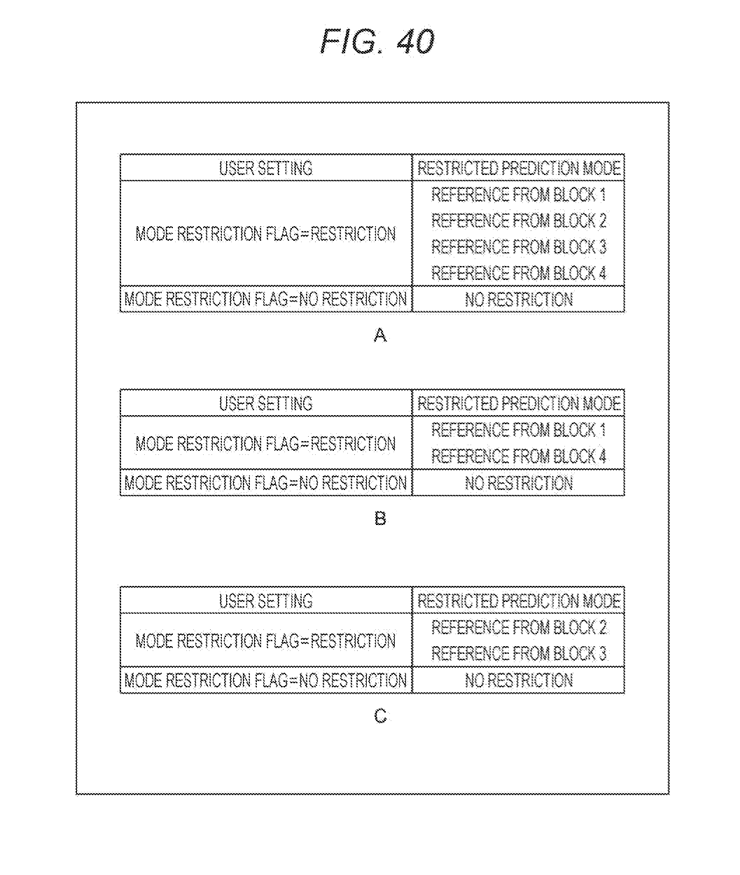

An example of prediction restriction when the present method is applied to the image encoding device according to the first embodiment is illustrated in FIG. 40. For example, as illustrated in the example of A in FIG. 40, when the value of the mode restriction flag is true (with restriction), reference from a peripheral block is restricted. When the value of the mode restriction flag is false (without restriction), the prediction mode is not restricted. In doing so, an increase in the deterioration of image quality due to discordance of the function included in the encoder with that of the decoder can be suppressed. When the possibility of the increase in the deterioration of image quality is low because of accordance of the function, unnecessary restriction of prediction is not performed, and a decrease in encoding efficiency can be suppressed.

Note that, when a compression block has a horizontally long size, as illustrated in the example of FIG. 11, the prediction restriction may be performed, as illustrated in the example of B in FIG. 40. Further, when the compression block has a vertically long size, as illustrated in the example of FIG. 15, the prediction restriction may be performed, as illustrated in the example of C in FIG. 40.

### <Application to Image Encoding Device of Second Embodiment>

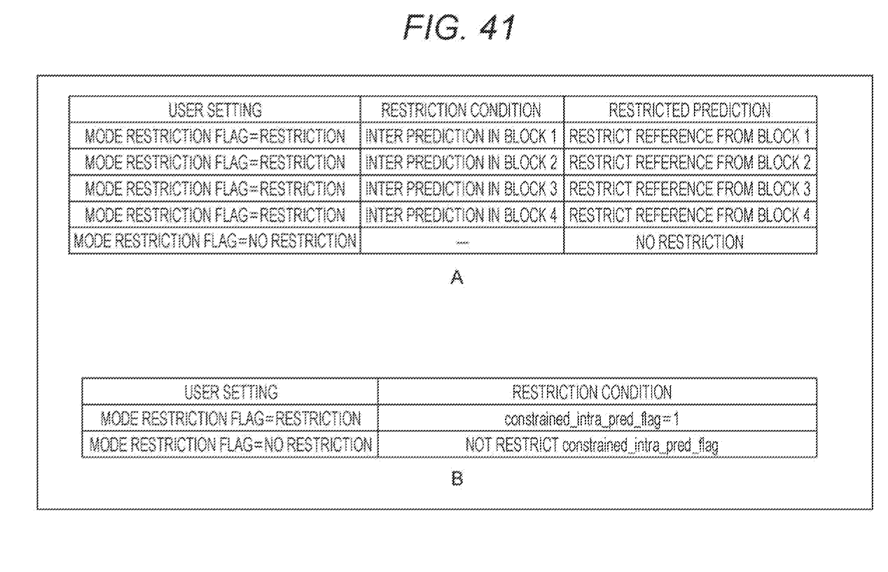

An example of prediction restriction when the present method is applied to the image encoding device according to the second embodiment is illustrated in FIG. 41. For example, as illustrated in the example of Ain FIG. 41, when the value of the mode restriction flag is true (with restriction), reference from a peripheral block having the encoding type of the inter prediction may be restricted. Further, when the value of the mode restriction flag is false (without restriction), the prediction mode may not be restricted. In doing so, an increase in the deterioration of image quality due to discordance of the function included in the encoder with that of the decoder can be suppressed. When the possibility of the increase in the deterioration of image quality is low because of accordance of the function, unnecessary restriction of prediction is not performed, and the decrease in encoding efficiency can be suppressed.

Note that, as illustrated in the example of B in FIG. 41, when the value of the mode restriction flag is true (with restriction), constrained_intra_pred_flag may be restricted (for example, the value may be set to “1”). When the value of the mode restriction flag is false (without restriction), constrained_intra_pred_flag may not be restricted.

### <Application to Image Encoding Device of Third Embodiment>

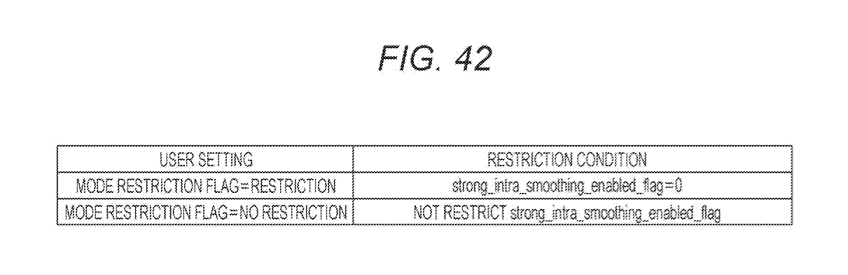

An example of prediction restriction when the present method is applied to the image encoding device according to the third embodiment is illustrated in FIG. 42. For example, when the value of the mode restriction flag is true (with restriction), strong_intra_smoothing_enabled_flag may be restricted to 0, and when the value of the mode restriction flag is false (without restriction), strong_intra_smoothing_enabled_flag may not be restricted.

### <Flow of Prediction Restriction Control Processing>

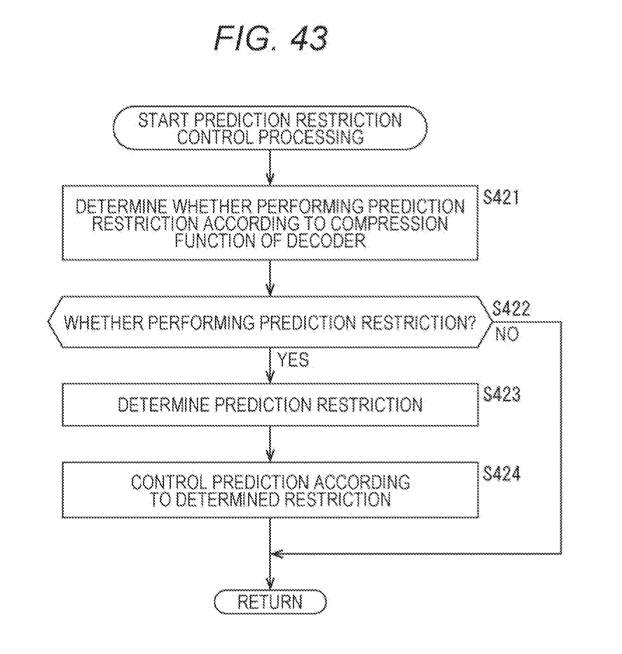

Next, an example of a flow of prediction restriction control processing of this case will be described with reference to the flowchart of FIG. 43.

Upon the start of the expectation restriction control processing, in step S421, an intra prediction restriction unit 151 determines whether performing prediction restriction according to the compression function of the decoder, and sets the value of the mode control flag. In step S422, the prediction restriction unit 142 determines whether performing the prediction restriction, based on the value of the mode restriction flag.

When it is determined that the prediction restriction is performed, the processing proceeds to step S423. In step S423, the prediction restriction unit 142 determines the restriction of the prediction. In step S424, the prediction restriction unit 142 controls the prediction according to the determined restriction. When the processing of step S424 is terminated, the prediction restriction control processing is terminated.

Further, in step S422, it is determined that the prediction restriction is not performed, the processing of steps S423 and S424 is omitted, and the prediction restriction control processing is terminated.

By executing the processing as described above, the image encoding device 401 can suppress a decrease in image quality due to encoding.

The application range of the present technology can be applied to any image encoding devices and image decoding devices that can encode/decode the image data.

Further, the present technology can be applied to the image encoding devices and the image decoding devices used when the image information (bit stream) compressed by orthogonal transform such as discrete cosine transform and motion compensation, like MPEG, H.26x is received through a network medium such as satellite broadcasting, a cable television, the Internet, or a mobile phone. Further, the present technology can be applied to the image encoding devices and image encoding devices used when processing is performed on a storage medium such as an optical disk, a magnetic disk, or a flash memory.

### 5. FIFTH EMBODIMENT

### Application to Multi-View Image Encoding/Multi-View Image Decoding

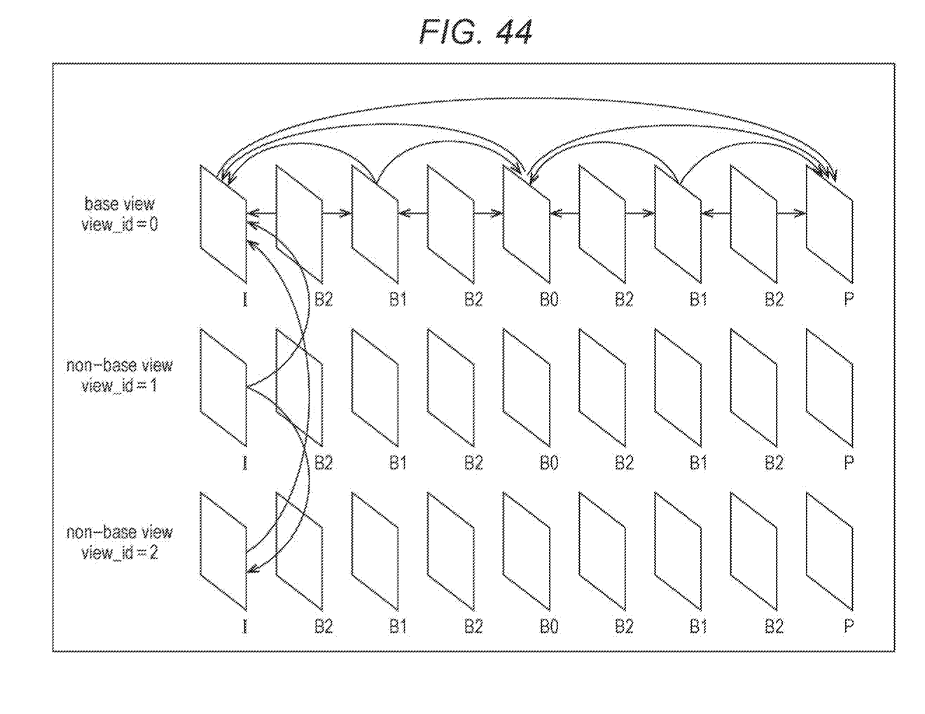

The above-described series of processing can be applied to multi-view image encoding/multi-view image decoding. FIG. 44 illustrates an example of a multi-view image encoding method.

As illustrated in FIG. 44, a multi-view image includes images of a plurality of views. The plurality of views of the multi-view image includes base views to be encoded/decoded using only the images of the own views without using information of other views, and non-base views to be encoded/decoded using information of other views. Encoding/decoding of the non-base views may use information of the base views, or may use information of the other non-base views.

For encoding/decoding a multi-view image like the image in FIG. 44, images of respective views are encoded/decoded. The method described in any of the above embodiments may be applied to the encoding/decoding of the respective views. In doing so, a decrease in the image quality due to encoding can be suppressed in the case of the images of the respective views. That is, a decrease in the image quality due to encoding can be similarly suppressed in the case of the multi-view image.

### <Multi-View Image Encoding Device>

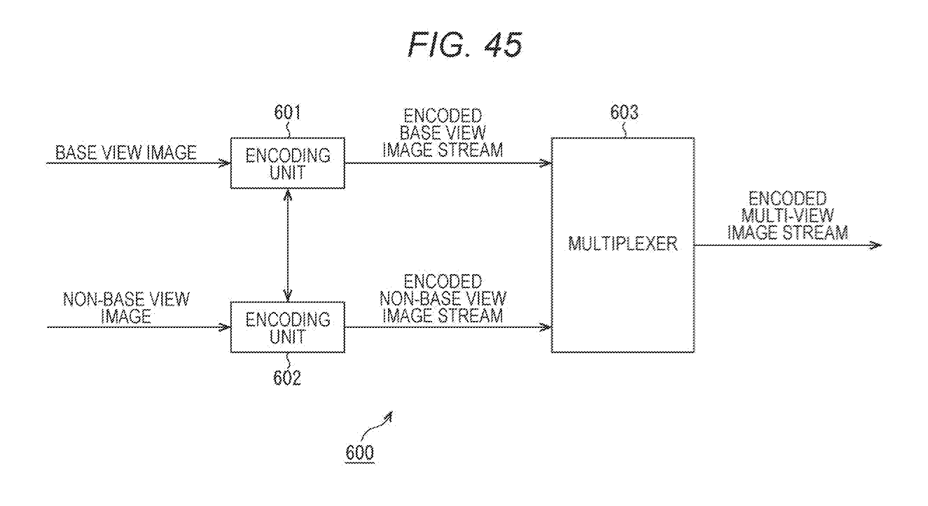

FIG. 45 is a diagram illustrating a multi-view image encoding device that encodes the multi-view image described above. As illustrated in FIG. 45, a multi-view image encoding device 600 includes an encoding unit 601, an encoding unit 602, and a multiplexer 603.

The encoding unit 601 encodes the base view images to generate an encoded base view image stream. The encoding unit 602 encodes the non-base view images to generate an encoded non-base view image stream. The multiplexer 603 multiplexes the encoded base view image stream generated by the encoding unit 601 and the encoded non-base view image stream generated by the encoding unit 602 to generate an encoded multi-view image stream.

The image encoding device (for example, the image encoding device 100, 200, 300, or 401) described in each of the embodiments may just be applied to the encoding unit 601 and the encoding unit 602 of the multi-view image encoding device 600. In doing so, in encoding of the multi-view image, the various methods described in the above embodiments can be applied. That is, the multi-view image encoding device 600 can suppress a decrease in the image quality of a multi-view image due to encoding.

### <Multi-View Image Decoding Device>

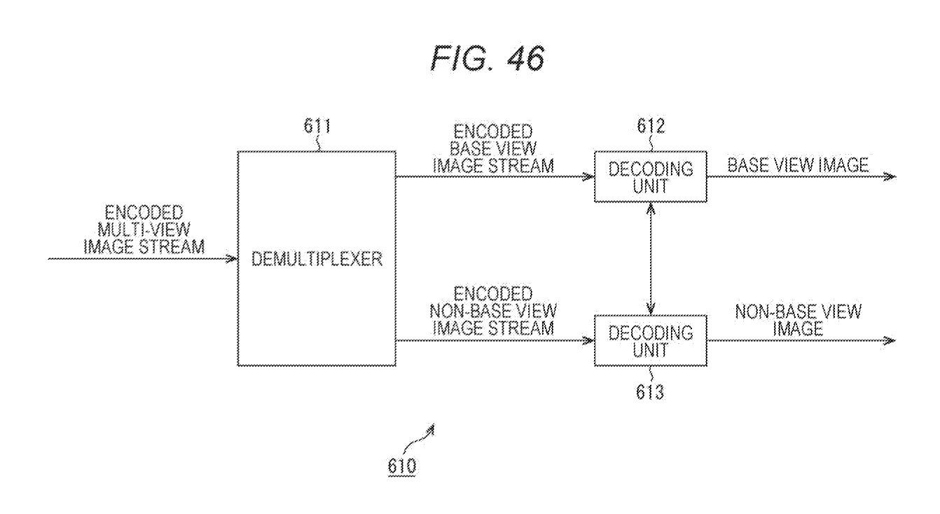

FIG. 46 is a diagram illustrating a multi-view image decoding device that performs the above-described multi-view image decoding. As illustrated in FIG. 46, a multi-view image decoding device 610 includes a demultiplexer 611, a decoding unit 612, and a decoding unit 613.

The demultiplexer 611 demultiplexes the encoded multi-view image stream obtained by multiplexing the encoded base view image stream and the encoded non-base view image stream to extract the encoded base view image stream and the encoded non-base view image stream. The decoding unit 612 decodes the encoded base view image stream extracted by the demultiplexer 611 to obtain the base view images. The decoding unit 613 decodes the encoded non-base view image stream extracted by the demultiplexer 611 to obtain the non-base view images.

For example, the image decoding device corresponding to the above-described image encoding device may just be applied to the decoding unit 612 and the decoding unit 613 of the multi-view image decoding device 610. In doing so, in decoding of the encoded data of the multi-view image, the various methods described in the embodiments can be applied. That is, the multi-view image decoding device 610 can correctly decode the encoded data of the multi-view image encoded by the various methods described in the embodiments. Therefore, the multi-view image decoding device 610 can suppress a decrease in the image quality of the multi-view image due to encoding.

### 6. SIXTH EMBODIMENT

### Application to Hierarchical Image Encoding/Hierarchical Image Decoding

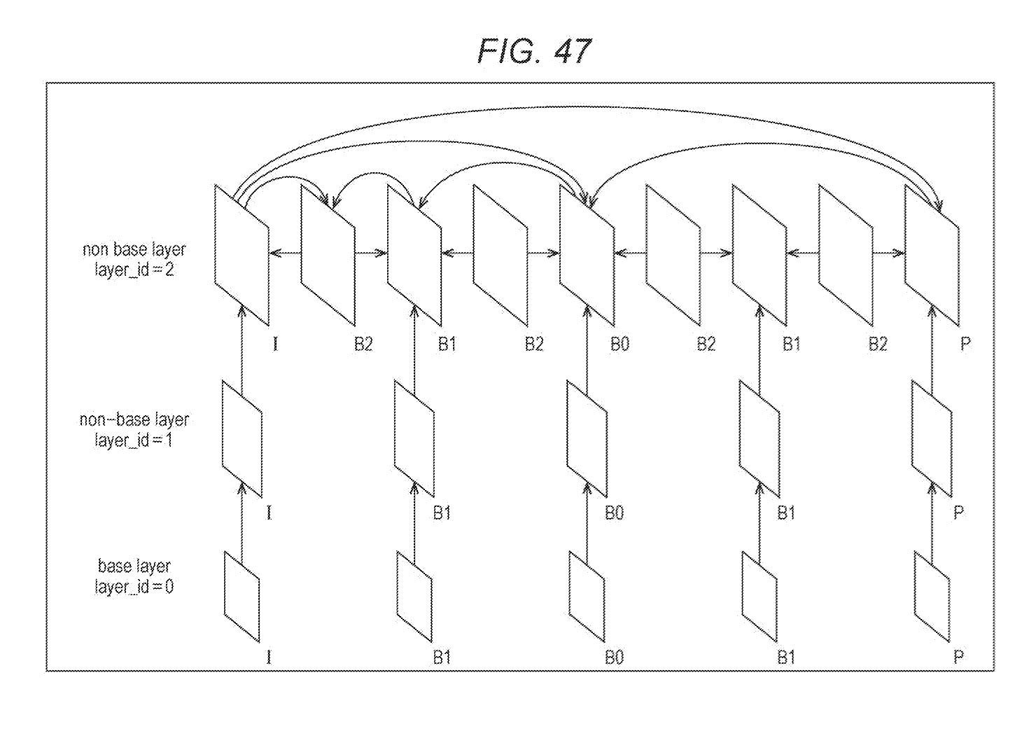

The above-described series of processing can be applied to hierarchical image encoding/hierarchical image decoding (scalable encoding/scalable decoding). FIG. 47 illustrates an example of a hierarchical image encoding method.

Hierarchical image encoding (scalable encoding) divides image data into a plurality of layers (hierarchies) such that a predetermined parameter has a scalability function, and encodes each layer. Hierarchical image decoding is, the hierarchical image encoding (scalable decoding) is decoding corresponding to the hierarchical image encoding.

As illustrated in FIG. 47, in hierarchizing images, one image is divided into a plurality of images (layers) based on a predetermined parameter having a scalability function. That is, the hierarchized image (hierarchical image) contains images of a plurality of hierarchies (layers) having the predetermined parameters, values of which are different from one another. The plurality of layers of the hierarchical image is made of base layers for encoding and decoding using only images of own layers without using images of other layers, and non-base layers (also referred to as enhancement layers) for encoding and decoding using images of other layers. The non-base layers may use images of base layers, or may use images of other non-base layers.

Typically, the non-base layer is configured from data (differential data) of a differential image between own image and an image of another layer so that redundancy is reduced. For example, when one image is divided into two hierarchies of a base layer and a non-base layer (also referred to as enhancement layer), an image having lower quality than the original image can be obtained based on data of only the base layer. On the other hand, the original image (that is, a high-quality image) can be obtained when data of the base layer and data of the non-base layer are synthesized.

By hierarchizing images in this way, images having various types of quality can be easily obtained depending on situations. For example, in a case of a terminal having low processing capability such as a mobile phone, image compression information of only base layers is transmitted, and a dynamic image having low spatiotemporal resolution or having low image quality is reproduced, for example. In a case of a terminal having high processing capability such as a television and a personal computer, image compression information of enhancement layers is transmitted in addition to the base layers, and a dynamic image having high spatiotemporal resolution or having high image quality is reproduced, for example. Image compression information according to the capability of the terminal or network can be transmitted from a server without executing transcode processing.

When the hierarchical image as illustrated in the example in FIG. 47 is encoded/decoded, the images of the respective layers are encoded/decoded. In this case, the method described in any of the embodiments may be applied to the encoding/decoding of the layers. In doing so, a decrease in image quality of the images of the layers due to encoding can be suppressed. That is, the decrease in image quality due to encoding can be suppressed, similarly, in the case of the hierarchical image.

### <Scalable Parameter>

In such hierarchical image encoding/hierarchical image decoding (scalable encoding/scalable decoding), the parameter having a scalability function is arbitrary. For example, the spatial resolution may be used as the parameter (spatial scalability). In the case of the spatial scalability, the resolution of the image is different for each layer.

Alternatively, as the parameter having scalability, the temporal resolution may be employed (temporal scalability). In the case of the temporal scalability, the frame rate is different for each layer.

Further, as the parameter having scalability, a signal to noise ratio (SNR) may be applied, for example. In the case of the SNR scalability, the SN ratio is different for each layer.

Obviously, the parameter having scalability may be a parameter other than the aforementioned parameters. For example, there is bit depth scalability, with which a 10-bit image can be obtained by adding an enhancement layer to a base layer that is made of an 8-bit image.

Further, there is a chroma scalability, with which a component image in the 4:2:2 format can be obtained by adding an enhancement layer to a base layer that is made of a component image in the 4:2:0 format.

### <Hierarchical Image Encoding Device>

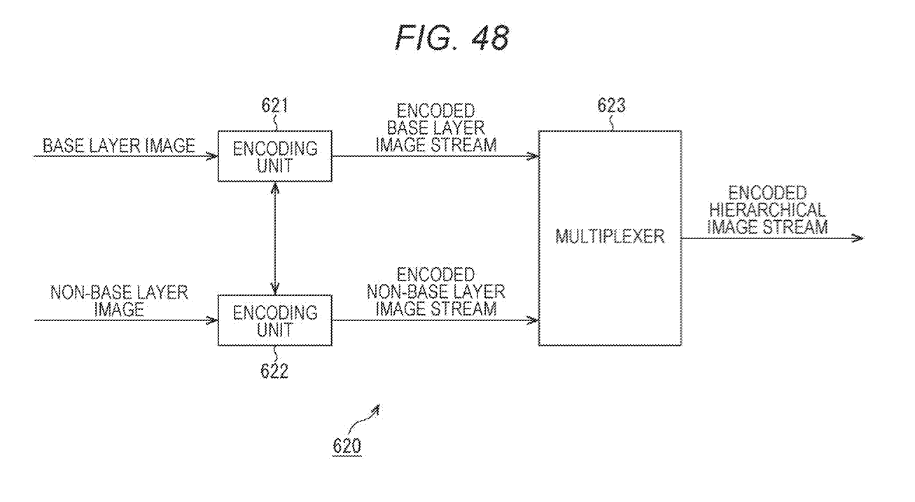

FIG. 48 is a diagram illustrating a hierarchical image encoding device that performs the above-described hierarchical image encoding. As illustrated in FIG. 48, a hierarchical image encoding device 620 includes an encoding unit 621, an encoding unit 622, and a multiplexer 623.

The encoding unit 621 encodes base layer images to generate an encoded base layer image stream. The encoding unit 622 encodes non-base layer images to generate an encoded non-base layer image stream. The multiplexer 623 multiplexes the encoded base layer image stream generated by the encoding unit 621 and the encoded non-base layer image stream generated by the encoding unit 622 to generate an encoded hierarchical image stream.

For example, the image encoding device (for example, the image encoding device 100, 200, 300, or 401) described in each of the embodiments may just be employed as the encoding units 621 and 622 of the hierarchical image encoding device 620. In doing so, the various methods described in the above embodiments can be applied even in the encoding of the hierarchical image. That is, the hierarchical image encoding device 620 can suppress a decrease in image quality of the hierarchical image due to encoding.

### <Hierarchical Image Decoding Device>

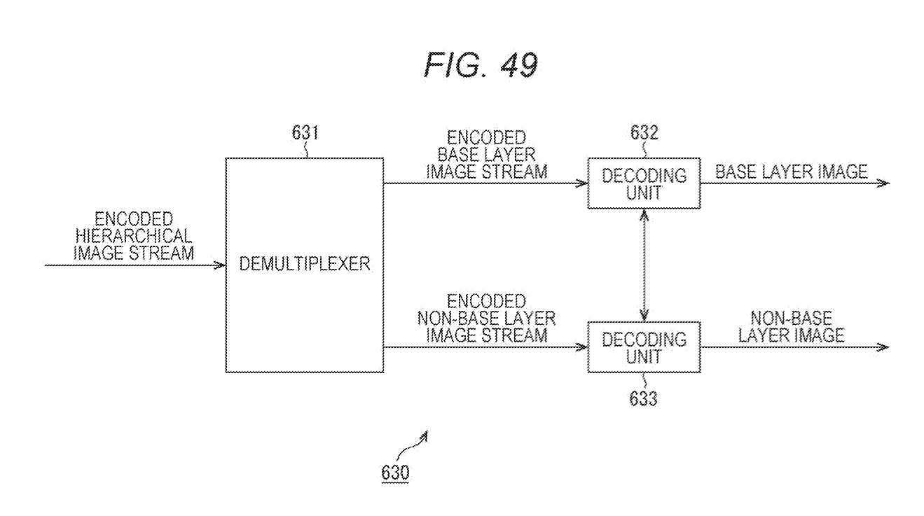

FIG. 49 is a diagram illustrating a hierarchical image decoding device that performs the above-described hierarchical image decoding. As illustrated in FIG. 49, a hierarchical image decoding device 630 includes a demultiplexer 631, a decoding unit 632, and a decoding unit 633.

The demultiplexer 631 demultiplexes the encoded hierarchical image stream in which the encoded base layer image stream and the encoded non-base layer image stream are multiplexed to extract the encoded base layer image stream and the encoded non-base layer image stream. The decoding unit 632 decodes the encoded base layer image stream extracted by the demultiplexer 631 to obtain the base layer image. The decoding unit 633 decodes the encoded non-base layer image stream extracted by the demultiplexer 631 to obtain the non-base layer image.

For example, the image decoding device corresponding to the above-described image encoding device may just be applied as the decoding unit 632 and the decoding unit 633 of the hierarchical image decoding device 630. In doing so, the various methods described in the first to fifth embodiments can be applied even in decoding of the encoded data of the hierarchical image. That is, the hierarchical image decoding device 630 can correctly decode the encoded data of the hierarchical image encoded by the various methods described in the above embodiments. Therefore, the hierarchical image decoding device 630 can suppress a decrease in image quality of the hierarchical image due to encoding.

### 7. SEVENTH EMBODIMENT

### Computer

The series of processing described above can be executed either by hardware or by software. When the series of processing described above is executed by software, programs that configure the software are installed in a computer. Here, the computer includes a computer embedded in dedicated hardware and a general-purpose computer capable of executing various functions by installing various programs therein.

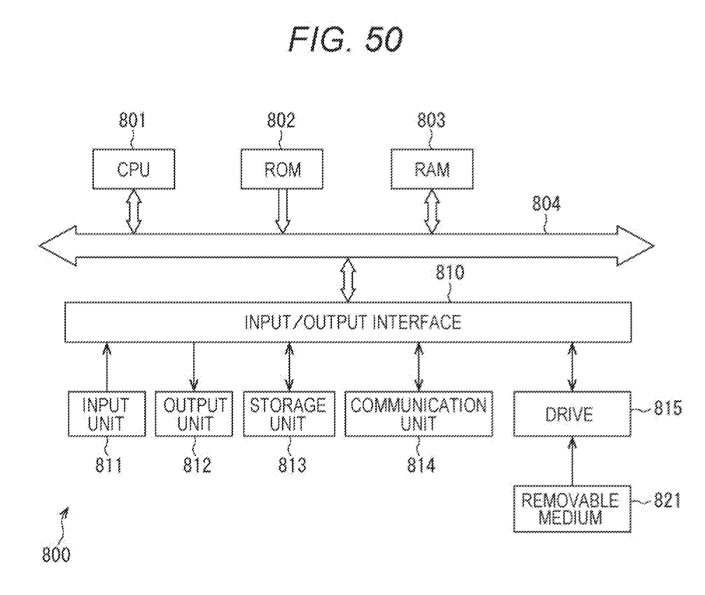

FIG. 50 is a block diagram illustrating a configuration example of the hardware of the computer that executes the above-described series of processing according to the programs.

In a computer 800 illustrated in FIG. 50, a central processing unit (CPU) 801, a read only memory (ROM) 802, and a random access memory (RAM) 803 are connected to one another via a bus 804.

An input/output interface 810 is also connected to the bus 804. An input unit 811, an output unit 812, a storage unit 813, a communication unit 814, and a drive 815 are connected to the input/output interface 810.

The input unit 811 includes a keyboard, a mouse, a microphone, a touch panel, an input terminal, and the like. The output unit 812 includes a display, a speaker, an output terminal, and the like. The storage unit 813 includes a hard disk, a RAM disk, a non-volatile memory, or the like. The communication unit 814 includes a network interface or the like. The drive 815 drives a removable medium 821 such as a magnetic disk, an optical disk, a magneto optical disk, or a semiconductor memory.

In the computer 800 configured as described above, the CPU 801 loads programs stored in the storage unit 813 onto the RAM 803 through the input/output interface 810 and the bus 804 and executes the programs, so that the above-described series of processing are performed. The RAM 803 further appropriately stores data necessary for the CPU 801 to perform various types of processing.

The programs to be executed by the computer (CPU 801) may be recorded on the removable medium 821 as a package medium or the like and applied therefrom, for example. In that case, the program can be installed to the storage unit 813 through the input/output interface 810 by mounting the removable medium 821 to the drive 815.

Alternatively, the programs can be provided through a wired or wireless transmission medium such as a local area network, the Internet, or digital satellite broadcasting. In that case, the programs can be received by the communication unit 814 and installed to the storage unit 813

Alternatively, the programs can be installed to the ROM 802 or the storage unit 813 in advance.

Note that the programs to be executed by the computer may be programs for carrying out processing in chronological order along the sequence described in this specification, or programs for carrying out processing in parallel or at necessary timing such as in response to a call.

In this specification, steps that describe programs to be recorded in a recording medium include not only processing to be performed in chronological order along the sequence described herein but also processing to be performed in parallel or independently of one another even if not necessarily performed in the chronological order.

Furthermore, in this specification, a system refers to a set of a plurality of configuration components (devices, modules (parts), etc.), and all of the components may be or may not be within one housing. Thus, both of a plurality of devices accommodated in individual housings and connected through a network, and one device having a housing in which a plurality of modules are accommodated are systems.

Further, a configuration described as one device (or one processing unit) may be divided into two or more devices (or processing units). Conversely, a configuration described as two or more devices (or processing units) may be combined into one device (or processing unit). Further, it is of course possible to add configurations other than those described above to the configuration of any of the devices (or processing units). Furthermore, some configurations of a device (or processing unit) may be incorporated into the configuration of another device (or processing unit) as long as the configuration and the function of the system as a whole are substantially the same.

While favorable embodiments of the present disclosure have been described with reference to the accompanying drawings, the technical scope of the present disclosure is not limited to these examples. It is apparent that a person ordinary skilled in the art of the present disclosure can conceive various variations and modifications within the technical idea described in the claims, and it is naturally appreciated that these variations and modification belong to the technical scope of the present disclosure.

For example, according to the present technology, a cloud computing configuration in which one function is shared and processed by a plurality of devices in cooperation through a network can be used.

Further, the steps described in the flowcharts above can be executed by one device and can also be shared and executed by a plurality of devices.

Further, when a plurality of processing are contained in one step, the processing contained in the step can be executed by one device and can also be shared and executed by a plurality of devices.

The image encoding device and the image decoding device according to the embodiment described above may be applied to various electronic devices such as a transmitter and a receiver for satellite broadcasting, cable broadcasting such as cable TV, distribution on the Internet, distribution to terminals through cellular communication, a recording device that records images in a medium such as an optical disk, a magnetic disk, or a flash memory, and a reproducing device that reproduces images from such storage medium. Four application examples will be described below.

### 8. EIGHTH EMBODIMENT

### First Application Example

### Television Receiver

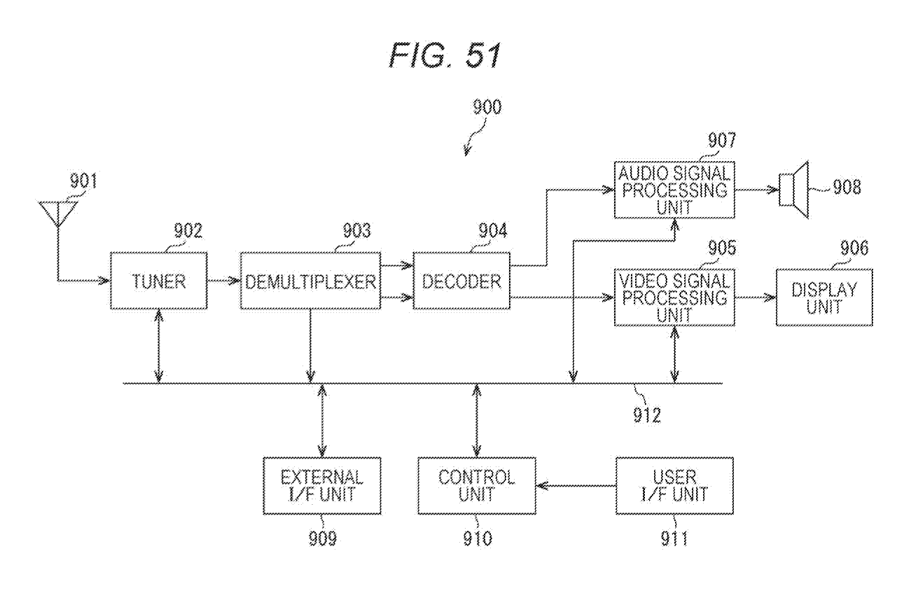

FIG. 51 illustrates an example of a schematic configuration of a television device to which the above-described embodiment is applied. A television device 900 includes an antenna 901, a tuner 902, a demultiplexer 903, a decoder 904, a video signal processing unit 905, a display unit 906, an audio signal processing unit 907, a speaker 908, an external interface (I/F) unit 909, a control unit 910, a user interface (I/F) unit 911, and a bus 912.

The tuner 902 extracts a signal of a desired channel from broadcast signals received through the antenna 901, and demodulates the extracted signal. The tuner 902 then outputs an encoded bit stream obtained by demodulation to the demultiplexer 903. That is, the tuner 902 serves as a transmission unit in the television device 900 for receiving an encoded stream in which an image is encoded.

The demultiplexer 903 separates a video stream and an audio stream of a TV program to be viewed from the encoded bit stream, and outputs the separated streams to the decoder 904. Further, the demultiplexer 903 extracts auxiliary data such as an electronic program guide (EPG) from the encoded bit stream, and supplies the extracted auxiliary data to the control unit 910. Note that the demultiplexer 903 may perform descrambling in a case where the encoded bit stream is scrambled.

The decoder 904 decodes the video stream and the audio stream input from the demultiplexer 903. The decoder 904 then outputs video data generated by decoding processing to the video signal processing unit 905. Further, the decoder 904 outputs the audio data generated by decoding processing to the audio signal processing unit 907.

The video signal processing unit 905 reproduces the video data input from the decoder 904, and causes the display unit 906 to display a video. The video signal processing unit 905 may cause the display unit 906 to display an application screen supplied through a network. Further, the video signal processing unit 905 may perform additional processing such as noise removal for the video data according to the setting. Furthermore, the video signal processing unit 905 may generate an image of a graphical user interface (GUI) such as a menu, a button, a cursor or the like, and superimpose the generated image on an output image.

The display unit 906 is driven by a drive signal supplied from the video signal processing unit 905, and displays a video or an image on a video screen of a display device (for example, a liquid crystal display, a plasma display, an organic electroluminance display (OELD) (organic EL display), or the like).

The audio signal processing unit 907 performs reproduction processing such as D/A conversion and amplification for the audio data input from the decoder 904, and outputs an audio from the speaker 908. Further, the audio signal processing unit 907 may perform additional processing such as noise removal for the audio data.

The external interface unit 909 is an interface for connecting the television device 900 and an external device or a network. For example, a video stream or an audio stream received through the external interface unit 909 may be decoded by the decoder 904. That is, the external interface unit 909 also serves as a transmission unit in the television device 900 for receiving an encoded stream in which an image is encoded.

The control unit 910 includes a processor such as a CPU, and a memory such as a RAM and a ROM. The memory stores the programs to be executed by the CPU, program data, EPG data, data acquired through a network, and the like. The programs stored in the memory are read and executed by the CPU at the time of startup of the television device 900, for example. The CPU controls the operation of the television device 900 according to an operation signal input from the user interface unit 911, for example, by executing the programs.

The user interface unit 911 is connected with the control unit 910. The user interface unit 911 includes a button and a switch used by a user to operate the television device 900, and a receiving unit for a remote control signal. The user interface unit 911 detects an operation of the user through these configuration elements, generates an operation signal, and outputs the generated operation signal to the control unit 910.

The bus 912 interconnects the tuner 902, the demultiplexer 903, the decoder 904, the video signal processing unit 905, the audio signal processing unit 907, the external interface unit 909, and the control unit 910.

In the television device 900 configured as described above, for example, the video signal processing unit 905 may have the function of the image encoding device (for example, the image encoding device 100, 200, 300, or 401) described in each of the embodiments. That is, the video signal processing unit 905 can encode the image data supplied from the decoder 904 by any of the methods described in the embodiments. The video signal processing unit 905 supplies the encoded data obtained by the encoding to the external interface unit 909, and can output the encoded data from the external interface unit 909 to an outside of the television device 900. Therefore, the television device 900 can suppress a decrease in the image quality of an image to be processed due to encoding.

### Second Application Example

### Mobile Phone

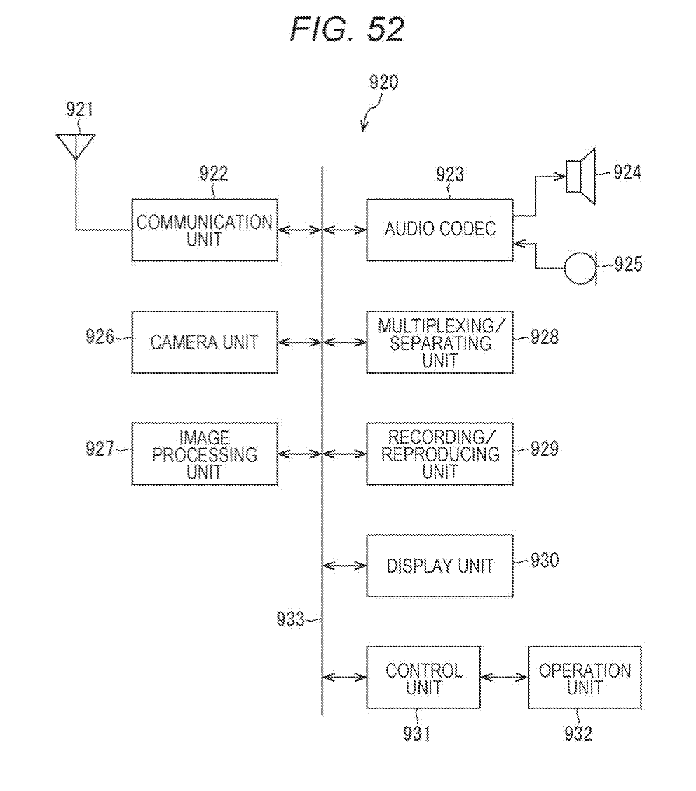

FIG. 52 illustrates an example of a schematic configuration of a mobile phone to which the above-described embodiment is applied. A mobile phone 920 includes an antenna 921, a communication unit 922, an audio codec 923, a speaker 924, a microphone 925, a camera unit 926, an image processing unit 927, a multiplexing/separating unit 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 interconnects the communication unit 922, the audio codec 923, the camera unit 926, the image processing unit 927, the multiplexing/separating unit 928, the recording/reproducing unit 929, the display unit 930, and the control unit 931.

The mobile phone 920 performs operations such as transmission/reception of an audio signal, transmission/reception of emails or image data, capturing of an image, recording of data, and the like, in various operation modes including an audio conversation mode, a data communication mode, a capturing mode, and a videophone mode.

In the audio conversation mode, an analogue audio signal generated by the microphone 925 is supplied to the audio codec 923. The audio codec 923 converts the analogue audio signal into audio data, and A/D converts and compresses the converted audio data. Then, the audio codec 923 outputs the compressed audio data to the communication unit 922. The communication unit 922 encodes and modulates the audio data, and generates a transmission signal. Then, the communication unit 922 transmits the generated transmission signal to abase station (not illustrated) through the antenna 921. Further, the communication unit 922 amplifies a wireless signal received through the antenna 921 and converts the frequency of the wireless signal to acquire a received signal. Then, the communication unit 922 demodulates and decodes the received signal and generates the received signal to generate the audio data, and outputs the generated audio data to the audio codec 923. The audio codec 923 extends and D/A converts the audio data, and generates an analogue audio signal. Then, the audio codec 923 supplies the generated audio signal to the speaker 924 and causes the audio to be output.

Further, in the data communication mode, the control unit 931 generates text data that makes up an email according to an operation of a user through the operation unit 932, for example. Further, the control unit 931 causes the text to be displayed on the display unit 930. Further, the control unit 931 generates email data according to a transmission instruction of the user through the operation unit 932, and outputs the generated email data to the communication unit 922. Then, the communication unit 922 encodes and modulates the email data to generate a transmission signal. Then, the communication unit 922 transmits the generated transmission signal to a base station (not illustrated) through the antenna 921. Further, the communication unit 922 amplifies the wireless signal received through the antenna 921 and converts the frequency of the wireless signal to acquire a received signal. Then, the communication unit 922 demodulates and decodes the received signal, restores the email data, and outputs the restored email data to the control unit 931. The control unit 931 causes the display unit 930 to display the content of the email, and also supplies the email data to the recording/reproducing unit 929 and causes the email data to be stored in a storage medium thereof.

The recording/reproducing unit 929 includes an arbitrary readable and writable storage medium. For example, the storage medium may be a built-in storage medium such as an RAM, a flash memory or the like, or an externally mounted storage medium such as a hard disk, a magnetic disk, a magneto-optical disk, an optical disk, a universal serial bus (USB) memory, or a memory card.

Further, in the image capturing mode, the camera unit 926 captures an image of a subject to generate image data, and outputs the generated image data to the image processing unit 927, for example. The image processing unit 927 encodes the image data input from the camera unit 926, supplies the encoded stream to the recording/reproducing unit 929, and causes the encoded stream to be stored in the storage medium thereof.

Further, in the image display mode, the recording/reproducing unit 929 reads the encoded stream recorded in the storage medium, and outputs the encoded stream to the image processing unit 927. The image processing unit 927 decodes the encoded stream input from the recording/reproducing unit 929, supplies the image data to the display unit 930, and causes the image to be displayed.

Further, in the videophone mode, the multiplexing/separating unit 928 multiplexes a video stream encoded by the image processing unit 927 and an audio stream input from the audio codec 923, and outputs the multiplexed stream to the communication unit 922, for example. The communication unit 922 encodes and modulates the stream, and generates a transmission signal. Then, the communication unit 922 transmits the generated transmission signal to a base station (not illustrated) through the antenna 921. Further, the communication unit 922 amplifies a wireless signal received through the antenna 921 and converts the frequency of the wireless signal to acquire a received signal. These transmission signal and received signal may include an encoded bit stream. The communication unit 922 then demodulates and decodes the received signal, restores the stream, and outputs the restored stream to the multiplexing/separating unit 928. The multiplexing/separating unit 928 separates the video stream and the audio stream from the input stream, and outputs the video stream to the image processing unit 927 and the audio stream to the audio codec 923. The image processing unit 927 decodes the video stream to generate video data. The video data is supplied to the display unit 930, and a series of images is displayed by the display unit 930. The audio codec 923 extends and D/A converts the audio stream to generate an analogue audio signal. The audio codec 923 then supplies the generated audio signal to the speaker 924 and causes the audio to be output.

In the mobile phone 920 configured as described above, the image processing unit 927 may have a function of the image encoding device (the image encoding device 100, 200, 300, or 401, for example) described in each of the embodiments. That is, the image processing unit 927 can encode the image data by any of the methods described in the embodiments. Therefore, the mobile phone 920 can suppress a decrease in the image quality of an image to be processed due to encoding.

### Third Application Example

### Recording/reproducing Device

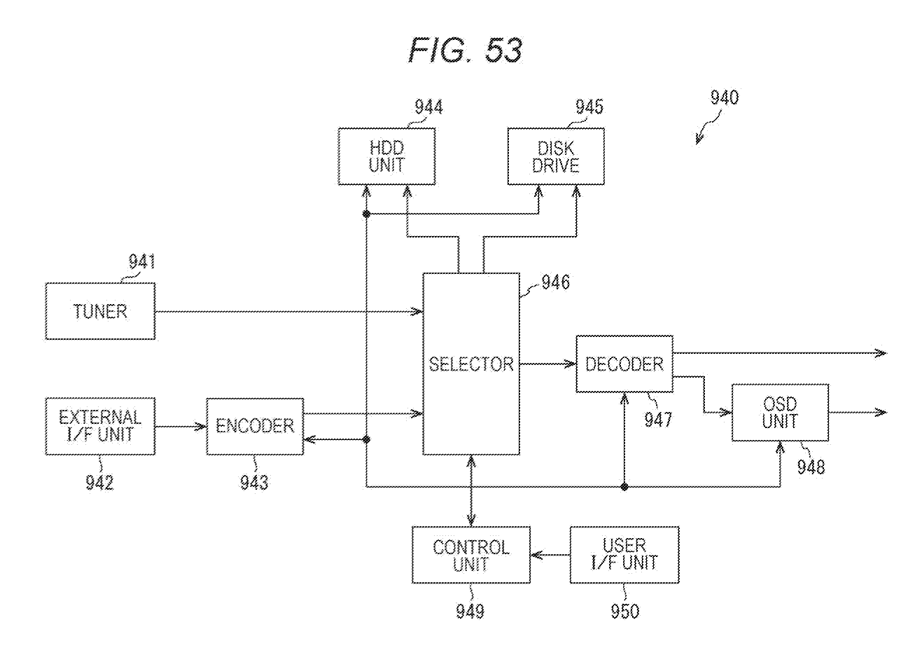

FIG. 53 illustrates an example of a schematic configuration of a recording/reproducing device to which the above-described embodiment is applied. A recording/reproducing device 940 encodes audio data and video data of a received broadcast program and records the audio data and the video data in a recording medium. Further, the recording/reproducing device 940 may encode audio data and video data acquired from another device, and record the audio data and the video data in the recording medium, for example. Further, the recording/reproducing device 940 reproduces data recorded in the recording medium on a monitor or through a speaker according to an instruction of a user, for example. At this time, the recording/reproducing device 940 decodes the audio data and the video data.

The recording/reproducing device 940 includes a tuner 941, an external interface (I/F) unit 942, an encoder 943, a hard disk drive (HDD) 944, a disk drive 945, a selector 946, a decoder 947, an on-screen display (OSD) 948, a control unit 949, and a user interface (I/F) unit 950.

The tuner 941 extracts a signal of a desired channel from broadcast signals received through an antenna (not illustrated), and demodulates the extracted signal. The tuner 941 then outputs an encoded bit stream obtained by demodulation to the selector 946. That is, the tuner 941 serves as a transmission unit in the recording/reproducing device 940.

The external interface unit 942 is an interface for connecting the recording/reproducing device 940 and an external device or a network. For example, the external interface unit 942 may be an Institute of Electrical and Electronic Engineers (IEEE) 1394 interface, a network interface, an USB interface, a flash memory interface, or the like. For example, video data and audio data received through the external interface unit 942 are input to the encoder 943. That is, the external interface unit 942 serves as a transmission unit in the recording/reproducing device 940.

In a case where the video data and the audio data input from the external interface unit 942 are not encoded, the encoder 943 encodes the video data and the audio data. The encoder 943 then outputs the encoded bit stream to the selector 946.

The HDD 944 records an encoded bit stream that is compressed content data of a video or audio, various programs, and other pieces of data to an internal hard disk. Further, the HDD 944 reads these pieces of data from the hard disk at the time of reproducing the video and the audio.

The disk drive 945 records and reads data to/from a mounted recording medium. A recording medium mounted on the disk drive 945 may be a digital versatile disc (DVD) (a DVD-video, a DVD-random access memory (DVD-RAM), a DVD-readable (DVD-R), a DVD-rewritable (DVD-RW), a DVD+recordable (DVD+R), or a DVD+rewritable (DVD+RW)), a Blu-ray (registered trademark) disc, or the like.

The selector 946 selects an encoded bit stream input from the tuner 941 or the encoder 943, and outputs the selected encoded bit stream to the HDD 944 or the disk drive 945 at the time of recording a video or audio. Further, the selector 946 outputs an encoded bit stream input from the HDD 944 or the disk drive 945 to the decoder 947 at the time of reproducing a video or audio.

The decoder 947 decodes the encoded bit stream to generate video data and audio data. The decoder 947 then outputs the generated video data to the OSD 948. Further, the decoder 947 outputs the generated audio data to an external speaker.

The OSD 948 reproduces the video data input from the decoder 947, and displays a video. Further, the OSD 948 may superimpose an image of a GUI, such as a menu, a button, or a cursor on a displayed video.

The control unit 949 includes a processor such as a CPU and a memory such as an RAM or an ROM. The memory stores a program to be executed by the CPU, program data, and the like. The program stored in the memory is read and executed by the CPU at the time of startup of the recording/reproducing device 940, for example. The CPU controls the operation of the recording/reproducing device 940 according to an operation signal input from the user interface unit 950, for example, by executing the program.

The user interface unit 950 is connected with the control unit 949. The user interface unit 950 includes a button and a switch used by a user to operate the recording/reproducing device 940, a receiving unit for a remote control signal, and the like. The user interface unit 950 detects the operation of the user through these configuration elements to generate an operation signal, and outputs the generated operation signal to the control unit 949.

In the recording/reproducing device 940 configured as described above, the encoder 943 may have a function of the image encoding device (for example, the image encoding device 100, 200, 300, or 401) described in each of the embodiments. That is, the encoder 943 can encode the image data by any of the methods described in the embodiments. Therefore, the recording/reproducing device 940 can suppress a decrease in the image quality of an image to be processed due to encoding.

### Fourth Application Example

### Capturing Device

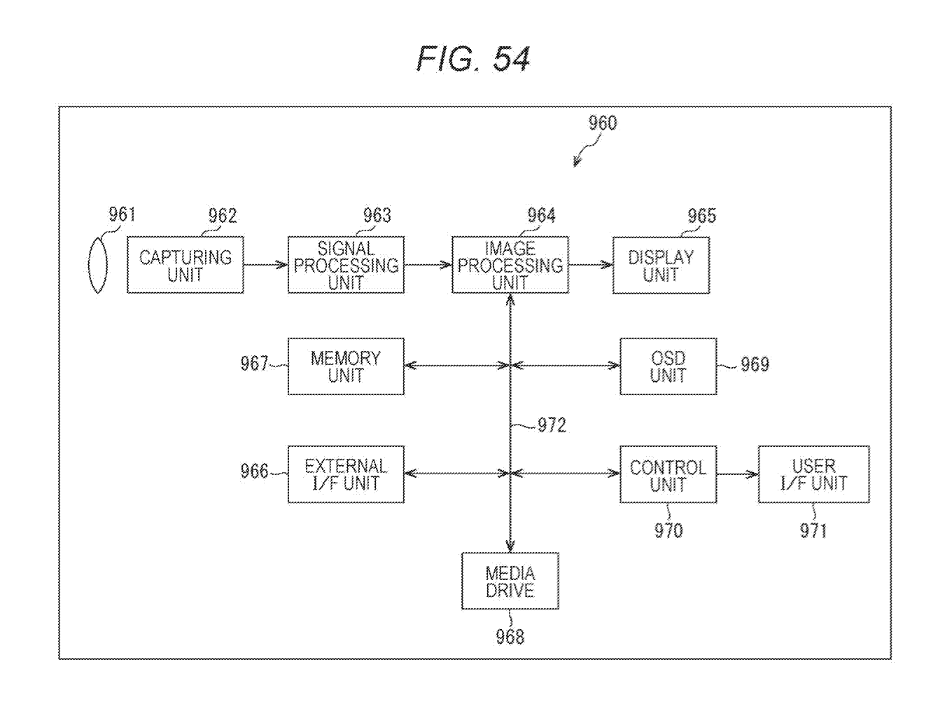

FIG. 54 illustrates an example of a schematic configuration of a capturing device to which the above-described embodiment is applied. A capturing device 960 captures a subject to generate an image, encodes the image data, and records the image data in a recording medium.

The capturing device 960 includes an optical block 961, a capturing unit 962, a signal processing unit 963, an image processing unit 964, a display unit 965, an external interface (I/F) unit 966, a memory unit 967, a media drive 968, an OSD 969, a control unit 970, a user interface (I/F) unit 971, and a bus 972.

The optical block 961 is connected to the capturing unit 962. The capturing unit 962 is connected to the signal processing unit 963. The display unit 965 is connected to the image processing unit 964. The user interface unit 971 is connected to the control unit 970. The bus 972 interconnects the image processing unit 964, the external interface unit 966, the memory unit 967, the media drive 968, the OSD 969, and the control unit 970.

The optical block 961 includes a focus lens, an aperture stop mechanism, and the like. The optical block 961 forms an optical image of the subject on a capturing surface of the capturing unit 962. The capturing unit 962 includes an image sensor such as a charge coupled device (CCD) or a complementary metal oxide semiconductor (CMOS), and converts by photoelectric conversion the optical image formed on the image capturing surface into an image signal as an electrical signal. The capturing unit 962 then outputs the image signal to the signal processing unit 963.

The signal processing unit 963 performs various types of camera signal processing, such as knee correction, gamma correction, color correction and the like, for the image signal input from the capturing unit 962. The signal processing unit 963 outputs the image data after the camera signal processing to the image processing unit 964.

The image processing unit 964 encodes the image data input from the signal processing unit 963 to generate encoded data. The image processing unit 964 then outputs the generated encoded data to the external interface unit 966 or the media drive 968. Further, the image processing unit 964 decodes encoded data input from the external interface unit 966 or the media drive 968 to generate image data. The image processing unit 964 then outputs the generated image data to the display unit 965. The image processing unit 964 may output the image data input from the signal processing unit 963 to the display unit 965, and cause the image to be displayed. Further, the image processing unit 964 may superimpose data for display acquired from the OSD 969 on an image to be output to the display unit 965.

The OSD 969 generates an image of a GUI, such as a menu, a button, a cursor or the like, and outputs the generated image to the image processing unit 964.

The external interface unit 966 is configured as a USB input/output terminal, for example. The external interface unit 966 connects the capturing device 960 and a printer at the time of printing an image, for example. Further, a drive is connected to the external interface unit 966 as necessary. A removable medium, such as a magnetic disk or an optical disk is mounted on the drive, and a program read from the removable medium may be installed in the capturing device 960. Further, the external interface unit 966 may be configured as a network interface to be connected to a network such as a LAN or the Internet. That is, the external interface unit 966 serves as a transmission unit in the capturing device 960.

A recording medium to be mounted on the media drive 968 may be an arbitrary readable and writable removable medium, such as a magnetic disk, a magneto-optical disk, an optical disk, or a semiconductor memory. Further, the recording medium may be fixedly mounted on the media drive 968 to configure a non-transportable storage unit such as a built-in hard disk drive or a solid state drive (SSD), for example.

The control unit 970 includes a processor such as a CPU and a memory such as an RAM or an ROM. The memory stores a program to be executed by the CPU, program data, and the like. The program stored in the memory is read and executed by the CPU at the time of startup of the capturing device 960, for example. The CPU controls the operation of the capturing device 960 according to an operation signal input from the user interface unit 971 by executing the program.

The user interface unit 971 is connected with the control unit 970. The user interface unit 971 includes a button, a switch and the like used by a user to operate the capturing device 960, for example. The user interface unit 971 detects an operation by the user through these configuration elements to generate an operation signal, and outputs the generated operation signal to the control unit 970.

In the capturing device 960 configured as described above, the image processing unit 964 has the image encoding device (for example, the image encoding device 100, 200, 300, or 401) described in each of the embodiments. That is, the image processing unit 964 can encode the image data by any of the methods described in the embodiments. Therefore, the capturing device 960 can suppress a decrease in the image quality of an image to be processed due to encoding.

Note that the present technology can be applied to HTTP streaming such as MPEG DASH, which is used by selecting appropriate encoded data in units of segment from a plurality of encoded data having mutually different resolutions prepared in advance. That is, information regarding encoding and decoding can be shared among such a plurality of encoded data.

### 10. TENTH EMBODIMENT

### Other Examples of Embodiments

The examples of the device and the system to which the present technology is applied have been described. However, the present technology is not limited thereto. The present technology can be carried out as any kind of configurations mounted on a device that configures the device and the system, for example, a processor as a system large scale integration (LSI), a module including a plurality of processors, a unit including a plurality of modules, and a set having another function added to the unit (that is, a configuration of a part of the device).

### <Video Set>

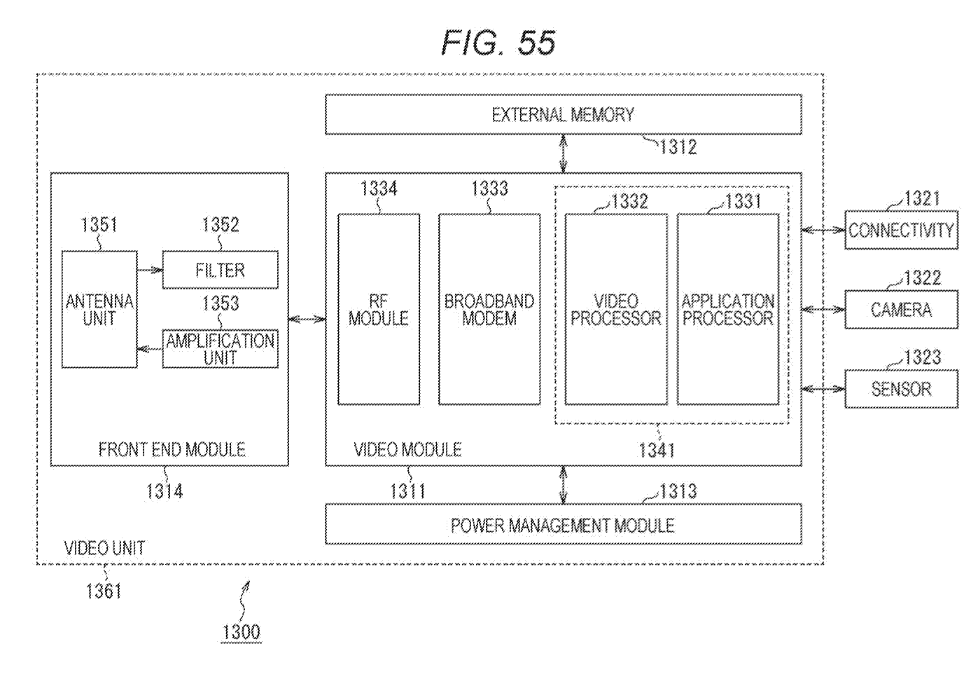

An example of carrying out the present technology as a set will be described with reference to FIG. 55. FIG. 55 illustrates an example of a schematic structure of a video set to which the present technology is applied.

In recent years, electronic devices have various functions, and when a part of the configuration is sold or provided in development and manufacture, there is not only a case where a configuration having one function is carried out, but also a case where a plurality of configurations having related functions is combined, and is carried out as one set having a plurality of functions.

A video set 1300 illustrated in FIG. 55 has such a multifunctional configuration, and is a combination of a device having a function related to encoding and decoding (either one or both of them) of an image with a device having another function related to the aforementioned function.

As illustrated in FIG. 55, the video set 1300 includes a module group including a video module 1311, an external memory 1312, a power management module 1313, a front end module 1314, and the like, and devices having related functions including a connectivity 1321, a camera 1322, and a sensor 1323.

The module is a component having some partial functions that are relevant to each other. While a specific physical configuration is arbitrary, a plurality of electronic circuit elements, each of which has its own function, such as processors, resistors, and capacitors, and other devices are disposed on a wiring board and integrated. Further, another module or processor can be combined with the above module to form a new module.

In the case of the example of FIG. 55, the video module 1311 is a combination of configurations having functions related to image processing, and includes an application processor, a video processor, a broadband modem 1333, and an RF module 1334.

A processor is formed by integrating a configuration having a predetermined function on a semiconductor chip through system on chip (SoC), and is also referred to as, for example, a system large scale integration (LSI). The configuration having the predetermined function may be a logic circuit (hardware configuration), or a CPU, a ROM, and a RAM, and a program (software configuration) executed using the aforementioned configurations. Alternatively, the configuration may be a combination of both of the hardware configurations and the software configuration. For example, the processor may have a logic circuit, and a CPU, a ROM, a RAM, and the like, and achieve a part of the functions by the logic circuit (hardware structure), and achieve the other functions by the program (software structure) executed in the CPU.

The application processor 1331 in FIG. 55 is a processor that executes an application for image processing. Not only does the application processor 1331 execute the application to perform calculation processing but also controls the configurations inside and outside the video module 1311 such as the video processor 1332, to achieve the predetermined function.

The video processor 1332 is a processor having a function regarding encoding/decoding of an image (one or both of them).

The broadband modem 1333 converts data (digital signal) transmitted by wired or wireless (or both) broadband communication performed through a broadband line such as the Internet or a public telephone network into an analog signal by digital modulation, and converts the analog signal received by the broadband communication into data (digital signal) by demodulating of the analog signal. The broadband modem 1333 processes arbitrary information including image data processed by the video processor 1332, a stream in which the image data is encoded, an application program, and setting data.

The RF module 1334 is a module that performs frequency conversion, modulation/demodulation, amplification, filtering, and the like, for a radio frequency (RF) signal that is transmitted/received through an antenna. For example, the RF module 1334 converts the frequency of a base band signal generated by the broadband modem 1333 to generate the RF signal. Further, the RF module 1334 converts the frequency of the RF signal received through the front end module 1314 to generate the base band signal.

As illustrated by the dotted line 1341 in FIG. 55, the application processor 1331 and the video processor 1332 may be integrated into one processor.

The external memory 1312 is a module provided outside the video module 1311 and having a storage device used by the video module 1311. The storage device of the external memory 1312 may be achieved by any physical configuration. However, the storage device is often used for storage of high-capacity data such as the image data in the unit of frame, and thus the storage device is desirably achieved by a relatively inexpensive semiconductor memory having a high capacity, such as a dynamic random access memory (DRAM).

The power management module 1313 manages and controls power supply to the video module 1311 (the respective configurations in the video module 1311).

The front end module 1314 is a module that provides the RF module 1334 with a front end function (a circuit of a transmission/reception end of the antenna side). As illustrated in FIG. 55, the front end module 1314 has, for example, an antenna unit 1351, a filter 1352, and an amplification unit 1353.

The antenna unit 1351 has an antenna that transmits/receives a wireless signal and a peripheral configuration thereof. The antenna unit 1351 transmits the signal supplied from the amplification unit 1353 as a wireless signal and supplies the received wireless signal to the filter 1352 as an electric signal (RF signal). The filter 1352 filters the RF signal received through the antenna unit 1351 and supplies the processed RF signal to the RF module 1334. The amplification unit 1353 amplifies the RF signal supplied from the RF module 1334 and supplies the signal to the antenna unit 1351.

The connectivity 1321 is a module having a function related to connection with an outside. A physical configuration of the connectivity 1321 is arbitrary. For example, the connectivity 1321 has a configuration having a communication function other than the communication specification supported by the broadband modem 1333, an external input/output terminal, and the like.

For example, the connectivity 1321 may have a module having a communication function conforming to a wireless communication specification such as Bluetooth (registered trademark), IEEE802.11 (for example, wireless fidelity (Wi-Fi, registered trademark)), near field communication (NFC), or infrared data association (IrDA), an antenna that transmits/receives the signal conforming to the specification, and the like. Alternatively, the connectivity 1321 may have a module having a communication function conforming to a wired communication specification such as universal serial bus (USB) or high-definition multimedia interface (HDMI (registered trademark)), and a terminal conforming to the specification. Further, alternatively, the connectivity 1321 may have another data (signal) transmission function such as an analog input/output terminal.

Note that the connectivity 1321 may include a device of a transmission destination of the data (signal). For example, the connectivity 1321 may have a drive (including not only a drive of a removable medium but also a hard disk, a solid state drive (SSD), or a network attached storage (NAS)) that reads/writes data to/from a recording medium such as a magnetic disk, an optical disk, a magneto-optical disk, or a semiconductor memory. Further, the connectivity 1321 may have a device (a monitor, a speaker, or the like) that outputs an image or an audio.

The camera 1322 is a module that captures a subject and obtains image data of the subject. The image data obtained by the capturing with the camera 1322 is supplied to the video processor 1332, for example, and is encoded therein.

The sensor 1323 is a module having an arbitrary sensor function, such as an audio sensor, an ultrasonic wave sensor, an optical sensor, an illuminance sensor, an infrared-ray sensor, an image sensor, a rotation sensor, an angle sensor, an angular velocity sensor, a speed sensor, an acceleration sensor, an inclination sensor, a magnetic identification sensor, a shock sensor, or a temperature sensor. The data detected by the sensor 1323 is supplied to the application processor 1331 and used by the application or the like.

The configuration described as the module may be achieved as a processor or on the contrary, the configuration described as the processor may be achieved as a module.

In the video set 1300 having the above configuration, the present technology can be applied to the video processor 1332 as described below. Therefore, the video set 1300 can be carried out as a set to which the present technology is applied.

### <Configuration Example of Video Processor>

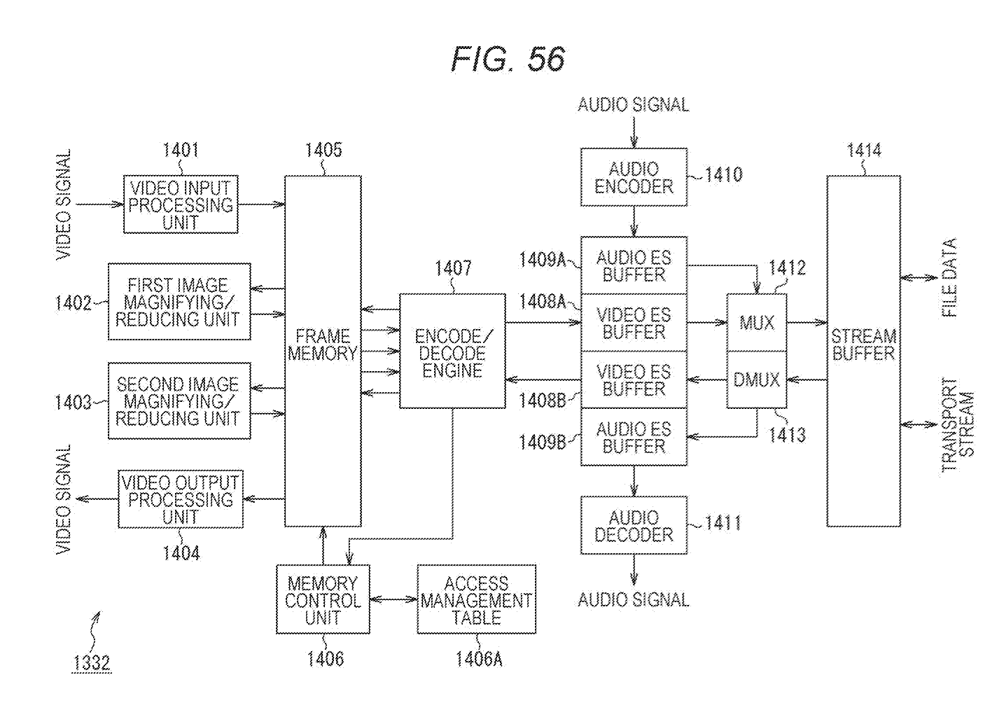

FIG. 56 illustrates an example of a schematic configuration of the video processor 1332 (FIG. 55) to which the present technology is applied.

In the case of the example of FIG. 56, the video processor 1332 has a function to receive an input of a video signal and an audio signal and encode the video signal and the audio signal in a predetermined method, and a function to decode the encoded video data and audio data and reproduce and output the video signal and the audio signal.

As illustrated in FIG. 56, the video processor 1332 includes a video input processing unit 1401, a first image magnifying/reducing unit 1402, a second image magnifying/reducing unit 1403, a video output processing unit 1404, a frame memory 1405, and a memory control unit 1406. Further, the video processor 1332 includes an encode/decode engine 1407, video elementary stream (ES) buffers 1408A and 1408B, and audio ES buffers 1409A and 1409B. Further, the video processor 1332 further includes an audio encoder 1410, an audio decoder 1411, a multiplexer (MUX) 1412, a demultiplexer (DMUX) 1413, and a stream buffer 1414.

The video input processing unit 1401 acquires the video signal input from the connectivity 1321 (FIG. 55), for example, and converts the signal into digital image data. The first image magnifying/reducing unit 1402 performs format conversion and magnifying/reducing processing for the image data. The second image magnifying/reducing unit 1403 performs format conversion and magnifying/reducing processing for the image data according to a format of the destination to which the data is output through the video output processing unit 1404, and performs format conversion and magnifying/reducing processing for the image data, similarly to the first image magnifying/reducing unit 1402. The video output processing unit 1404 performs format conversion and conversion for the image data into an analog signal, and outputs the signal as a reproduced video signal to the connectivity 1321.

The frame memory 1405 is a memory for image data shared by the video input processing unit 1401, the first image magnifying/reducing unit 1402, the second image magnifying/reducing unit 1403, the video output processing unit 1404, and the encode/decode engine 1407. The frame memory 1405 is achieved as a semiconductor memory such as a DRAM.

The memory control unit 1406 controls an access of writing/reading to/from the frame memory 1405 according to an access schedule for the frame memory 1405 written in an access management table 1406A upon receipt of a synchronization signal from the encode/decode engine 1407. The access management table 1406A is updated by the memory control unit 1406 in response to the processing executed by the encode/decode engine 1407, the first image magnifying/reducing unit 1402, the second image magnifying/reducing unit 1403, or the like.

The encode/decode engine 1407 performs encoding processing for the image data, and decoding processing for the video stream that is the data obtained by encoding the image data. For example, the encode/decode engine 1407 encodes the image data read from the frame memory 1405, and sequentially writes the data in the video ES buffer 1408A as the video stream. Further, the encode/decode engine 1407 sequentially reads and decodes the video stream from the video ES buffer 1408B, and sequentially writes the stream to the frame memory 1405 as the image data. The encode/decode engine 1407 uses the frame memory 1405 as a work region in the encoding and decoding. The encode/decode engine 1407 outputs a synchronization signal to the memory control unit 1406 at timing when the processing for each macroblock is started, for example.

The video ES buffer 1408A buffers the video stream generated by the encode/decode engine 1407, and supplies the stream to the multiplexer (MUX) 1412. The video ES buffer 1408B buffers the video stream supplied from the demultiplexer (DMUX) 1413 and supplies the stream to the encode/decode engine 1407.

The audio ES buffer 1409A buffers the audio stream generated by the audio encoder 1410 and supplies the stream to the multiplexer (MUX) 1412. The audio ES buffer 1409B buffers the audio stream supplied from the demultiplexer (DMUX) 1413 and supplies the stream to the audio decoder 1411.

The audio encoder 1410 converts the audio signal input from the connectivity 1321, or the like into a digital signal, and encodes the signal in a predetermined method such as the MPEG audio method or the audio code number 3 (AC3) method. The audio encoder 1410 sequentially writes the audio stream that is the data obtained by encoding the audio signal to the audio ES buffer 1409A. The audio decoder 1411 decodes the audio stream supplied from the audio ES buffer 1409B, converts the stream into an analog signal, and then supplies the signal as the reproduced audio signal to the connectivity 1321.

The multiplexer (MUX) 1412 multiplexes the video stream and the audio stream. A method for this multiplexing (that is, a format of a bit stream generated by the multiplexing) is arbitrary. In the multiplexing, the multiplexer (MUX) 1412 may add predetermined header information or the like to the bit stream. That is, the multiplexer (MUX) 1412 can convert the format of the stream by the multiplexing. For example, the multiplexer (MUX) 1412 multiplexes the video stream and the audio stream to convert the streams into a transport stream that is a bit stream in a transfer format. Further, for example, the multiplexer (MUX) 1412 multiplexes the video stream and the audio stream to convert the streams into data (file data) in a recording file format.

The demultiplexer (DMUX) 1413 demultiplexes the bit stream in which the video stream and the audio stream are multiplexed, by a method corresponding to the multiplexing by the multiplexer (MUX) 1412. That is, the demultiplexer (DMUX) 1413 extracts the video stream and the audio stream from the bit streams read from the stream buffer 1414 (separates the video stream and the video stream from each other). That is, the demultiplexer (DMUX) 1413 can convert the format of the stream by demultiplexing (inverted conversion of the conversion by the multiplexer (MUX) 1412). For example, the demultiplexer (DMUX) 1413 acquires the transport stream supplied from the connectivity 1321 or the broadband modem 1333 through the stream buffer 1414, and demultiplexes the stream, thereby to convert the transport stream into the video stream and the audio stream. Further, for example, the demultiplexer (DMUX) 1413 acquires the file data read from the recording media by the connectivity 1321 through the stream buffer 1414, and demultiplexes the stream, thereby to convert the file data into the video stream and the audio stream.

The stream buffer 1414 buffers the bit stream. For example, the stream buffer 1414 buffers the transport stream supplied from the multiplexer (MUX) 1412, and supplies the stream to the connectivity 1321 and the broadband modem 1333 at predetermined timing or based on a request from an outside.

Further, for example, the stream buffer 1414 buffers the file data supplied from the multiplexer (MUX) 1412, supplies the file data to the connectivity 1321 and the like at predetermined timing or based on a request from the outside, and records the file data to various recording media.

Further, the stream buffer 1414 buffers the transport stream acquired through the connectivity 1321 and the broadband modem 1333, and supplies the transport stream to the demultiplexer (DMUX) 1413 at predetermined timing or based on a request from the outside.

Further, the stream buffer 1414 buffers the file data read from the various recording media in the connectivity 1321 and supplies the file data to the demultiplexer (DMUX) 1413 at predetermined timing or based on a request from the outside.

Next, an example of an operation of the video processor 1332 with such a configuration will be described. For example, the video signal input from the connectivity 1321 or the like to the video processor 1332 is converted into the digital image data in a predetermined method such as a 4:2:2 Y/Cb/Cr method in the video input processing unit 1401, and the digital image data is sequentially written to the frame memory 1405. The digital image data is read by the first image magnifying/reducing unit 1402 or the second image magnifying/reducing unit 1403, the format conversion into a predetermined method such as a 4:2:0 Y/Cb/Cr method and the magnifying/reproducing processing is performed for the digital image data, and the image data is written to the frame memory 1405 again. The image data is encoded by the encode/decode engine 1407 and is written to the video ES buffer 1408A as the video stream.

Further, the audio signal input from the connectivity 1321 or the like to the video processor 1332 is encoded by the audio encoder 1410, and is written to the audio ES buffer 1409A as the audio stream.

The video stream of the video ES buffer 1408A and the audio stream of the audio ES buffer 1409A are read and multiplexed by the multiplexer (MUX) 1412 and converted into the transport stream or the file data, for example. The transport stream generated by the multiplexer (MUX) 1412 is buffered by the stream buffer 1414, and is then output to an external network through the connectivity 1321 or the broadband modem 1333. Further, the file data generated by the multiplexer (MUX) 1412 is buffered by the stream buffer 1414, is then output to the connectivity 1321 or the like, and is recorded in various recoding media.

The transport stream input to the video processor 1332 from the external network through the connectivity 1321 or the broadband modem 1333 is buffered by the stream buffer 1414 and is then demultiplexed by the demultiplexer (DMUX) 1413. Further, for example, the file data read from the various recording media in the connectivity 1321 and input to the video processor 1332 is buffered by the stream buffer 1414, and is then demultiplexed by the demultiplexer (DMUX) 1413. That is, the file data or the transport stream input to the video processor 1332 is separated into the video stream and the audio stream by the demultiplexer (DMUX) 1413.

The audio stream is supplied to the audio decoder 1411 through the audio ES buffer 1409B and decoded, so that the audio signal is reproduced. Further, the video stream is written to the video ES buffer 1408B, is then sequentially read by the encode/decode engine 1407 and decoded, and is written to the frame memory 1405. The decoded image data is magnified or reduced by the second image magnifying/reducing unit 1403 and is written to the frame memory 1405. The decoded image data is read by the video output processing unit 1404, the format conversion into a predetermined format such as the 4:2:2 Y/Cb/Cr method is performed for the image data, and the image data is further converted into an analog signal, so that the video signal is reproduced and output.

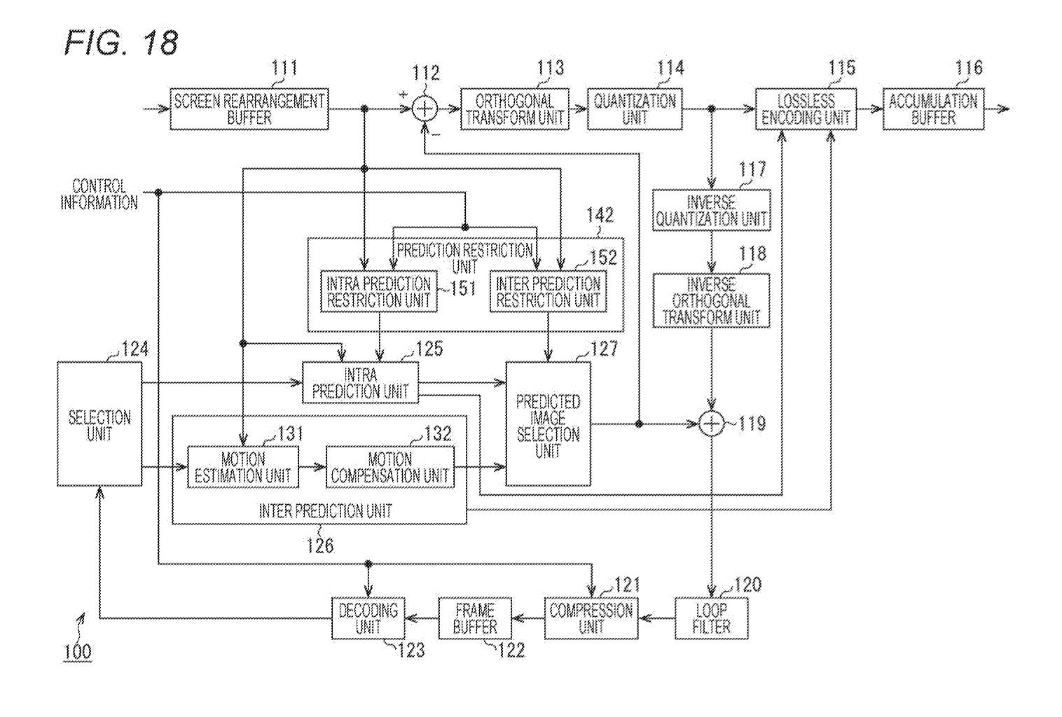

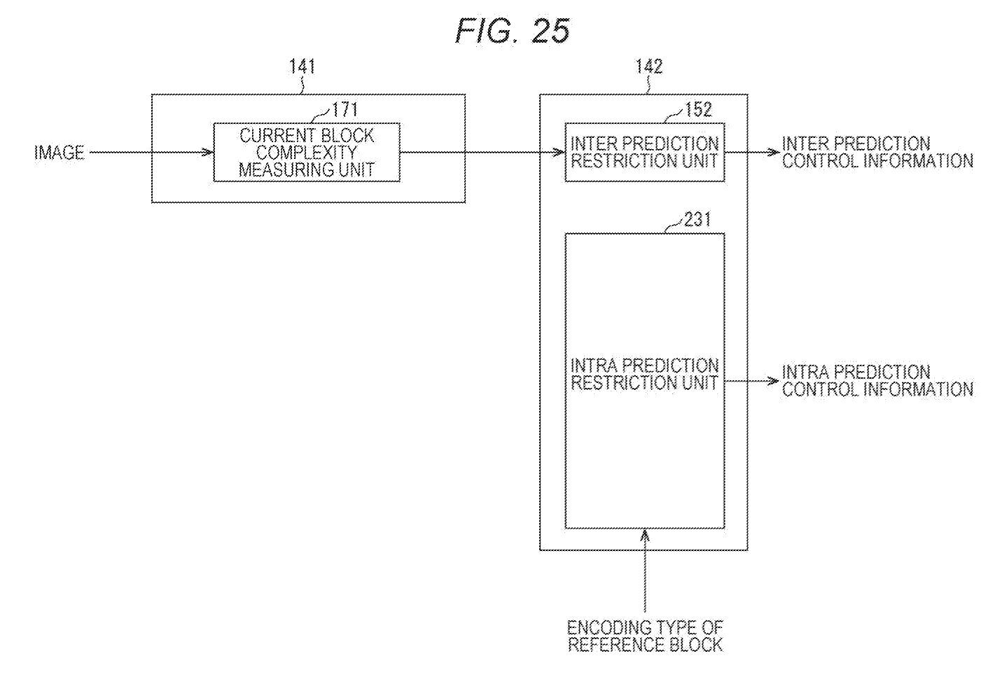

When the present technology is applied to the video processor 1332 configured as described above, the present technology according to any of the above embodiments may just be applied to the encode/decode engine 1407. That is, for example, the encode/decode engine 1407 may just have the function of the image encoding device according to any of the above embodiments. In doing so, the video processor 1332 can provide an effect similar to the effect described with reference to FIGS. 1 to 43.

Note that, in the encode/decode engine 1407, the present technology (that is, the functions of the image encoding device and the image decoding device according to any of the above embodiments) may be achieved by hardware such as a logic circuit, software such as a built-in program, or both of the hardware and the software.

### <Another Configuration Example of Video Processor>

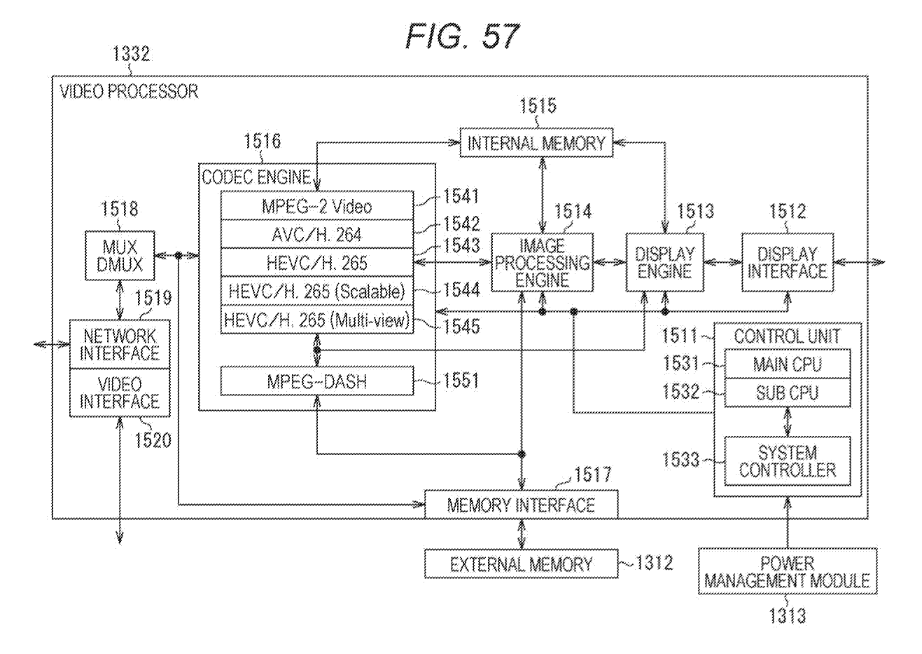

FIG. 57 illustrates another example of a schematic configuration of the video processor 1332 to which the present technology is applied. In the case of the example of FIG. 57, the video processor 1332 has a function to encode/decode video data in a predetermined method.

To be more specific, as illustrated in FIG. 57, the video processor 1332 includes a control unit 1511, a display interface 1512, a display engine 1513, an image processing engine 1514, and an internal memory 1515. The video processor 1332 includes a codec engine 1516, a memory interface 1517, a multiplexer/demultiplexer (MUX/DMUX) 1518, a network interface 1519, and a video interface 1520.

The control unit 1511 controls operations of the processing units in the video processor 1332, such as the display interface 1512, the display engine 1513, the image processing engine 1514, and the codec engine 1516.

As illustrated in FIG. 57, the control unit 1511 includes, for example, a main CPU 1531, a sub CPU 1532, and a system controller 1533. The main CPU 1531 executes the programs for controlling operations of the processing units in the video processor 1332, and the like. The main CPU 1531 generates control signals according to the programs and the like and supplies the signals to the processing units (that is, controls the operations of the processing units). The sub CPU 1532 plays an auxiliary role of the main CPU 1531. For example, the sub CPU 1532 executes child processing and a subroutine of the programs executed by the main CPU 1531. The system controller 1533 controls the operations of the main CPU 1531 and the sub CPU 1532, such as specifying the programs executed by the main CPU 1531 and the sub CPU 1532.

The display interface 1512 outputs the image data to the connectivity 1321 under the control of the control unit 1511. For example, the display interface 1512 converts the digital image data into the analog signal, and outputs the analog signal as the reproduced video signal or the digital image data as is to a monitor device or the like of the connectivity 1321.

Under the control of the control unit 1511, the display engine 1513 performs various types of conversion processing such as format conversion, size conversion, and color range conversion, for the image data, to accord with the hardware specification of the monitor device or the like where the image is displayed.

The image processing engine 1514 performs predetermined image processing such as filtering for image quality improvement, for the image data, under the control of the control unit 1511.

The internal memory 1515 is a memory provided in the video processor 1332 and is shared by the display engine 1513, the image processing engine 1514, and the codec engine 1516. The internal memory 1515 is used to transfer data among the display engine 1513, the image processing engine 1514, and the codec engine 1516. For example, the internal memory 1515 stores the data supplied from the display engine 1513, the image processing engine 1514, or the codec engine 1516, and supplies the data to the display engine 1513, the image processing engine 1514, or the codec engine 1516, as necessary (or upon a request). The internal memory 1515 may be achieved by any storage device. However, the internal memory 1515 is often used to store a small capacity of data such as the image data or parameters in the unit of block, and thus the internal memory 1515 is desirably achieved by a semiconductor memory that has a relatively smaller capacity (than the external memory 1312) and having a high response speed, such as a static random access memory (SRAM).

The codec engine 1516 performs processing regarding encoding and decoding of the image data. The method of encoding/decoding supported by the codec engine 1516 is arbitrary and the number of methods may be one or more than one. For example, the codec engine 1516 may have a codec function of a plurality of encoding/decoding methods, and may encode the image data or decode the encoded data by a method selected from the methods.

In the example illustrated in FIG. 57, the codec engine 1516 has MPEG-2 Video 1541, AVC/H.264 1542, HEVC/H.265 1543, HEVC/H.265 (scalable) 1544, HEVC/H.265 (multi-view) 1545, and MPEG-DASH 1551 as function blocks of processing regarding codec.

MPEG-2 Video 1541 is a function block that encodes or decodes the image data in the MPEG-2 method. AVC/H.264 1542 is a function block that encodes or decodes the image data in the AVC method. HEVC/H.265 1543 is a function block that encodes or decodes the image data in the HEVC method. HEVC/H.265 (scalable) 1544 is a function block that scalably encodes or scalably decodes the image data in the HEVC method. HEVC/H.265 (multi-view) 1545 is a function block that encodes or decodes the image data with multiple viewpoints in the HEVC method.

MPEG-DASH 1551 is a function block that transmits/receives the image data in the MPEG-dynamic adaptive streaming over HTTP (MPEG-DASH) method. MPEG-DASH is a technology of streaming the video using hypertext transfer protocol (HTTP), and one of characteristics is to select and transmit appropriate encoded data, of encoded data having mutually different resolutions and prepared in advance, in the unit of segment. MPEG-DASH 1551 generates the stream conforming to the specification and controls the transmission of the stream, and uses the aforementioned MPEG-2 Video 1541 to HEVC/H.265 (multi-view) 1545 in the encoding and decoding of the image data.

The memory interface 1517 is an interface for the external memory 1312. The data supplied from the image processing engine 1514 or the codec engine 1516 is supplied to the external memory 1312 through the memory interface 1517. The data read from the external memory 1312 is supplied to the video processor 1332 (the image processing engine 1514 or the codec engine 1516) through the memory interface 1517.

The multiplexer/demultiplexer (MUX/DMUX) 1518 multiplexes or demultiplexes various data related to an image, such as the bit stream of the encoded data, the image data, and the video signals. The method of the multiplexing/demultiplexing is arbitrary. For example, in the multiplexing, in addition to collecting a plurality of data, the multiplexer/demultiplexer (MUX/DMUX) 1518 can add predetermined header information, or the like to the collected data. Further, in the demultiplexing, in addition to dividing the data into a plurality of data, the multiplexer/demultiplexer (MUX/DMUX) 1518 can add predetermined header information to each of the divided data. That is, the multiplexer/demultiplexer (MUX/DMUX) 1518 can convert the format of the data by the multiplexing/demultiplexing. For example, the multiplexer/demultiplexer (MUX/DMUX) 1518 can convert the transform stream, which is the bit stream in the transfer format, or the data (file data) in the recording file format, by multiplexing the bit stream. Needless to say, the inverse conversion is also possible by the demultiplexing.

The network interface 1519 is an interface for the broadband modem 1333, the connectivity 1321, and the like. The video interface 1520 is an interface for the connectivity 1321, the camera 1322, and the like.

Next, an example of an operation of the video processor 1332 will be described. For example, upon receipt of the transport stream from the external network through the connectivity 1321 or the broadband modem 1333, the transport stream is supplied to the multiplexer/demultiplexer (MUX/DMUX) 1518 through the network interface 1519, is demultiplexed, and is decoded by the codec engine 1516. Predetermined image processing is applied by the image processing engine 1514 to the image data obtained by the decoding by the codec engine 1516, predetermined conversion is performed by the display engine 1513, the data is supplied to the connectivity 1321 or the like through the display interface 1512, and the image is displayed on the monitor. Further, for example, the image data obtained by the decoding of the codec engine 1516 is encoded again by the codec engine 1516, is multiplexed by the multiplexer/demultiplexer (MUX/DMUX) 1518 and converted into the file data, and the data is output to the connectivity 1321 or the like through the video interface 1520 and recorded in various recording media.

Further, for example, the file data of the encoded data obtained by encoding the image data and read from the recording medium (not illustrated) by the connectivity 1321 or the like is supplied to the multiplexer/demultiplexer (MUX/DMUX) 1518 through the video interface 1520 and is demultiplexed, and is decoded by the codec engine 1516. Predetermined image processing is applied to the image data obtained by the decoding by the codec engine 1516 by the image processing engine 1514, predetermined conversion is performed by the display engine 1513, the data is then supplied to the connectivity 1321 or the like through the display interface 1512, and the image is displayed on the monitor. Further, for example, the image data obtained by the decoding by the codec engine 1516 is encoded again by the codec engine 1516, is multiplexed by the multiplexer/demultiplexer (MUX/DMUX) 1518 and is converted into the transport stream, and the transport stream is supplied to the connectivity 1321, the broadband modem 1333, or the like through the network interface 1519, and is transmitted to another device (not illustrated).

Transfer of the image data or other data among the processing units in the video processor 1332 is performed using the internal memory 1515 or the external memory 1312. The power management module 1313 controls power supply to the control unit 1511.

In a case of applying the present technology to the video processor 1332 configured as described above, the present technology according to any of the above embodiments may just be applied to the codec engine 1516. That is, for example, the codec engine 1516 may have the function block that achieves the image encoding device according to any of the above embodiments. Thus, the video processor 1332 can provide an effect similar to the effect described with reference to FIGS. 1 to 43.

In the codec engine 1516, the present technology (that is, the functions of the image encoding device and the image decoding device according to any of the above embodiments) may be achieved by hardware such as a logic circuit or software such as a built-in program, or both of the hardware and the software.

Two examples of the configuration of the video processor 1332 have been described. However, the configuration of the video processor 1332 is arbitrary and may be a configuration other than the above two examples. The video processor 1332 may be configured as one semiconductor chip or as a plurality of semiconductor chips. For example, a three-dimensional multilayer LSI in which a plurality of semiconductor layers are stacked may be used. Alternatively, a plurality of LSIs may be used.

### <Application Examples to Devices>

The video set 1300 can be incorporated into various devices that process the image data. For example, the video set 1300 can be incorporated in the television device 900 (FIG. 51), the mobile phone 920 (FIG. 52), the recording/reproducing device 940 (FIG. 53), the capturing device 960 (FIG. 54), or the like. By incorporating the video set 1300, the device can have an effect similar to the effect described with reference to FIGS. 1 to 43.

Even if a configuration is a part of the configurations of the video set 1300, the configuration can be regarded as the configuration to which the present technology is applied as long as the configuration includes the video processor 1332. For example, only the video processor 1332 can be carried out as the video processor to which the present technology is applied. Further, the processor or the video module 1311, which is illustrated by a dotted line 1341, can be carried out as the processor or the module to which the present technology is applied. Further, for example, the video module 1311, the external memory 1312, the power management module 1313, and the front end module 1314 can be combined and carried out as a video unit 1361 to which the present technology is applied. In any configuration, an effect similar to the effect described with reference to FIGS. 1 to 43 can be obtained.

That is, any configuration as long as the configuration includes the video processor 1332 can be incorporated into various devices that process the image data, similarly to the case of the video set 1300. For example, the video processor 1332, the processor illustrated by the dotted line 1341, the video module 1311, or the video unit 1361 can be incorporated into the television device 900 (FIG. 51), the mobile phone 920 (FIG. 52), the recording/reproducing device 940 (FIG. 53), or the capturing device 960 (FIG. 54). Then, by incorporating any of configurations to which the present technology is applied, the device can have an effect similar to the effect described with reference to FIGS. 1 to 43, similarly to the case of the video set 1300.

In this specification, the example in which various pieces of information are multiplexed into the encoded stream and transmitted from the encoding side to the decoding side has been described. However, the technique of transmitting the information is not limited to this example. For example, these pieces of information may be transmitted or recorded as separate data associated with an encoded bit stream without being multiplexed into the encoded bit stream. Here, “association” refers to an image included in the bit stream (may be a part of the image such as a slice or a block) and the information corresponding to the image being linked at the decoding. That is, the information may be transmitted on a transmission path separated from the image (or bit stream). Alternatively, the information may be recorded in a recording medium separated from the image (or bit stream) (or in another recording area of the same recording medium). Further, the information and the image (or bit stream) may be associated with each other in an arbitrary unit, such as in a plurality of frames, one frame, or a part of a frame.

The present technology can have any of the configurations below.

(1) An image encoding device including:

a control unit configured to restrict a mode of generation of a predicted image, based on prediction of image quality of reference image data to be referred to when generating the predicted image;

a prediction unit configured to generate the predicted image according to a mode not restricted by the control unit; and

an encoding unit configured to encode image data using the predicted image generated by the prediction unit.

(2) The image encoding device according to any of (1) and (3) to (19), wherein the control unit restricts an inter prediction mode according to complexity of a current block that is an object to be processed.
(3) The image encoding device according to any of (1), (2) and (4) to (19), wherein the control unit restricts a direction of intra prediction according to complexity of a peripheral block of a current block that is an object to be processed.
(4) The image encoding device according to any of (1) to (3) and (5) to (19), wherein the control unit restricts a direction of intra prediction according to a shape of a block of encoding of when a peripheral block of a current block that is an object to be processed is stored in a frame memory.
(5) The image encoding device according to any of (1) to (4) and (6) to (19), wherein the control unit restricts the intra prediction from a direction of a side of the current block, the side being configured from a plurality of blocks.
(6) The image encoding device according to any of (1) to (5) and (7) to (19), wherein the control unit restricts a direction of intra angular prediction according to complexity of a peripheral block of a current block that is an object to be processed.
(7) The image encoding device according to any of (1) to (6) and (8) to (19), wherein the control unit restricts a direction of intra prediction according to setting of encoding of when a peripheral block of a current block that is an object to be processed is stored in a frame memory.
(8) The image encoding device according to any of (1) to (7) and (9) to (19), wherein the control unit restricts a direction of intra prediction according to complexity of a peripheral block of a current block that is an object to be processed, and an encoding type of the peripheral block.
(9) The image encoding device according to any of (1) to (8) and (10) to (19), wherein the control unit does not restrict the direction of intra prediction regardless of the complexity of the peripheral block when the encoding type is the intra prediction.
(10) The image encoding device according to any of (1) to (9) and (11) to (19), wherein the control unit restricts the direction of intra prediction regardless of the complexity of the peripheral block when the encoding type is inter prediction.
(11) The image encoding device according to any of (1) to (10) and (12) to (19), wherein the control unit restricts a direction of intra prediction according to setting of encoding of when a peripheral block of a current block that is an object to be processed is stored in a frame memory, and an encoding type of the peripheral block.
(12) The image encoding device according to any of (1) to (11) and (13) to (19), wherein the control unit does not restrict the direction of intra prediction regardless of complexity of the peripheral block when the encoding type is intra prediction.
(13) The image encoding device according to any of (1) to (12) and (14) to (19), wherein the control unit restricts a value of constrained_intra_pred_flag according to setting of encoding of when a peripheral block of a current block that is an object to be processed is stored in a frame memory.
(14) The image encoding device according to any of (1) to (13) and (15) to (19), wherein the control unit restricts a value of strong_intra_smoothing_enabled_flag according to setting of encoding of when a peripheral block of a current block that is an object to be processed is stored in a frame memory.
(15) The image encoding device according to any of (1) to (14) and (16) to (19), wherein the control unit restricts a direction of intra prediction according to whether performing encoding when an image decoding device stores a decoded block in a frame memory.
(16) The image encoding device according to any of (1) to (15) and (17) to (19), wherein the control unit restricts the direction of intra prediction when the image decoding device performs the encoding.
(17) The image encoding device according to any of (1) to (16), (18) and (19), wherein the control unit restricts the direction of intra prediction when the image decoding device performs the encoding, and a peripheral block of a current block that is an object to be processed is inter prediction.
(18) The image encoding device according to any of (1) to (17) and (19), wherein the control unit restricts a value of constrained_intra_pred_flag when the image decoding device performs the encoding.
(19) The image encoding device according to any of (1) to (18), wherein the control unit restricts a value of strong_intra_smoothing_enabled_flag when the image decoding device performs the encoding.
(20) An image encoding method including:

restricting a mode of generation of a predicted image, based on prediction of image quality of reference image data to be referred to when generating the predicted image;

generating the predicted image in a mode that is not restricted; and

encoding image data using the generated predicted image.

### REFERENCE SIGNS LIST

100 Image encoding device
141 Deterioration prediction unit
142 Prediction restriction unit
151 Intra prediction restriction unit
152 Inter prediction restriction unit
171 Current block complexity measuring unit
172 Peripheral block complexity measuring unit
200 Image encoding device
211 Intra prediction buffer
300 Image encoding device
400 Image processing system
401 Image encoding device (without compression function)
403 Image decoding device (with compression function)
405 Image decoding device (without compression function)

1. An image encoding device comprising:
a control unit configured to restrict a mode of generation of a predicted image, based on prediction of image quality of reference image data to be referred to when generating the predicted image;
a prediction unit configured to generate the predicted image according to a mode not restricted by the control unit; and
an encoding unit configured to encode image data using the predicted image generated by the prediction unit.

2. The image encoding device according to claim 1, wherein the control unit restricts an inter prediction mode according to complexity of a current block that is an object to be processed.

3. The image encoding device according to claim 1, wherein the control unit restricts a direction of intra prediction according to complexity of a peripheral block of a current block that is an object to be processed.

4. The image encoding device according to claim 1, wherein the control unit restricts a direction of intra prediction according to a shape of a block of encoding of when a peripheral block of a current block that is an object to be processed is stored in a frame memory.

5. The image encoding device according to claim 4, wherein the control unit restricts the intra prediction from a direction of a side of the current block, the side being configured from a plurality of blocks.

6. The image encoding device according to claim 1, wherein the control unit restricts a direction of intra angular prediction according to complexity of a peripheral block of a current block that is an object to be processed.

7. The image encoding device according to claim 1, wherein the control unit restricts a direction of intra prediction according to setting of encoding of when a peripheral block of a current block that is an object to be processed is stored in a frame memory.

8. The image encoding device according to claim 1, wherein the control unit restricts a direction of intra prediction according to complexity of a peripheral block of a current block that is an object to be processed, and an encoding type of the peripheral block.

9. The image encoding device according to claim 8, wherein the control unit does not restrict the direction of intra prediction regardless of the complexity of the peripheral block when the encoding type is the intra prediction.

10. The image encoding device according to claim 8, wherein the control unit restricts the direction of intra prediction regardless of the complexity of the peripheral block when the encoding type is inter prediction.

11. The image encoding device according to claim 1, wherein the control unit restricts a direction of intra prediction according to setting of encoding of when a peripheral block of a current block that is an object to be processed is stored in a frame memory, and an encoding type of the peripheral block.

12. The image encoding device according to claim 11, wherein the control unit does not restrict the direction of intra prediction regardless of complexity of the peripheral block when the encoding type is intra prediction.

13. The image encoding device according to claim 1, wherein the control unit restricts a value of constrained_intra_pred_flag according to setting of encoding of when a peripheral block of a current block that is an object to be processed is stored in a frame memory.

14. The image encoding device according to claim 1, wherein the control unit restricts a value of strong_intra_smoothing_enabled_flag according to setting of encoding of when a peripheral block of a current block that is an object to be processed is stored in a frame memory.

15. The image encoding device according to claim 1, wherein the control unit restricts a direction of intra prediction according to whether performing encoding when an image decoding device stores a decoded block in a frame memory.

16. The image encoding device according to claim 15, wherein the control unit restricts the direction of intra prediction when the image decoding device performs the encoding.

17. The image encoding device according to claim 15, wherein the control unit restricts the direction of intra prediction when the image decoding device performs the encoding, and a peripheral block of a current block that is an object to be processed is inter prediction.

18. The image encoding device according to claim 15, wherein the control unit restricts a value of constrained_intra_pred_flag when the image decoding device performs the encoding.

19. The image encoding device according to claim 15, wherein the control unit restricts a value of strong_intra_smoothing_enabled_flag when the image decoding device performs the encoding.

20. An image encoding method comprising:
restricting a mode of generation of a predicted image, based on prediction of image quality of reference image data to be referred to when generating the predicted image;
generating the predicted image in a mode that is not restricted; and
encoding image data using the generated predicted image.
